(19) United States
(12) Patent Application Publication
(10) Pub. No.: US 2026/0323600 A1
(43) Pub. Date: Oct. 15, 2026

(54) RESOURCE CONFIGURATION METHOD AND RELATED APPARATUS

(71) Applicant: HUAWEI TECHNOLOGIES CO., LTD., Shenzhen (CN)

(72) Inventors: Yunfei Qiao, Hangzhou (CN); Jian Wang, Hangzhou (CN); Rong Li, Boulogne Billancourt (FR)

(73) Assignee: HUAWEI TECHNOLOGIES CO., LTD., Shenzhen (CN)

(21) Appl. No.: 19/461,429

(22) Filed: Jan. 27, 2026

Related U.S. Application Data
(63) Continuation of application No. PCT/CN2023/110266, filed on Jul. 31, 2023.

(51) Int. Cl. H04W 72/044; H04L 41/16

(52) U.S. Cl. CPC H04W 72/044; H04L 41/16

(57) ABSTRACT

Providing a resource configuration method and a related apparatus. The method includes: A first apparatus receives one or more pieces of first configuration information from a second apparatus. Each piece of first configuration information is used to configure a first transmission resource and a second transmission resource. A part or all of the first transmission resource is used by the first apparatus to report a local parameter of a first model to the second apparatus. The second transmission resource is used by the first apparatus to receive a global parameter of a second model from the second apparatus. The first model is a model that is in the first apparatus and that is used to perform a task corresponding to the first configuration information. The second model is a model that is in the second apparatus and that is used to perform the task corresponding to the first configuration information.

### CROSS-REFERENCE TO RELATED APPLICATIONS

This application is a continuation of International Application No. PCT/CN2023/110266, filed on Jul. 31, 2023, the disclosure of which is hereby incorporated by reference in its entirety.

### TECHNICAL FIELD

This application relates to the field of communication technologies, and in particular, to a resource configuration method and a related apparatus.

### BACKGROUND

Federated learning (FL) is a typical distributed learning method. On a premise of ensuring user data privacy and security, each distributed node is prompted to collaborate with a central node to efficiently complete a model learning task. The distributed node collects a local dataset, and performs local model training to obtain a local parameter. Then, the distributed node sends the local parameter to the central node. The central node has no dataset. The central node collects local parameters reported by multiple distributed nodes, performs aggregation processing on the local parameters reported by the multiple distributed nodes to obtain a global parameter, and delivers the global parameter to each distributed node. In this way, model training and learning are implemented.

Each distributed node sends the local parameter to the central node through an uplink sending resource. The central node sends the global parameter to each distributed node, and the distributed node receives, through a downlink receiving resource, the global parameter sent by the central node. Therefore, how to configure the uplink sending resource and the downlink receiving resource is a problem worth considering.

### SUMMARY

This application provides a resource configuration method and a related apparatus, so that a first apparatus receives one or more pieces of first configuration information from a second apparatus. In this way, the second apparatus configures a first transmission resource and a second transmission resource for the first apparatus, so that the first apparatus reports a local parameter through the first transmission resource, and receives a global parameter through the second transmission resource.

A first aspect of this application provides a resource configuration method. The method may be performed by a first apparatus. The first apparatus may be a terminal device or a network device, a component (for example, a processor, a chip, or a chip system) in the terminal device or the network device, a logical module or software that can implement all or a part of functions of the terminal device, or a logical module or software that can implement all or a part of functions of the network device. The method includes: The first apparatus receives one or more pieces of first configuration information from a second apparatus. Each piece of first configuration information is used to configure a first transmission resource and a second transmission resource. A part or all of the first transmission resource is used by the first apparatus to report a local parameter of a first model to the second apparatus. The second transmission resource is used by the first apparatus to receive a global parameter of a second model from the second apparatus. The first model is a model that is in the first apparatus and that is used to perform a task corresponding to the first configuration information. The second model is a model that is in the second apparatus and that is used to perform the task corresponding to the first configuration information. The first apparatus determines transmission resources configured based on the one or more pieces of first configuration information. In this way, the second apparatus configures the first transmission resource and the second transmission resource for the first apparatus, so that the first apparatus reports the local parameter through the first transmission resource, and receives the global parameter through the second transmission resource.

A second aspect of this application provides a resource configuration method. The method may be performed by a second apparatus. The second apparatus may be a terminal device or a network device, a component (for example, a processor, a chip, or a chip system) in the terminal device or the network device, a logical module or software that can implement all or a part of functions of the terminal device, or a logical module or software that can implement all or a part of functions of the network device. The method includes: The second apparatus determines one or more pieces of first configuration information. Each piece of first configuration information is used to configure a first transmission resource and a second transmission resource. A part or all of the first transmission resource is used by a first apparatus to report a local parameter of a first model to the second apparatus. The second transmission resource is used by the first apparatus to receive a global parameter of a second model from the second apparatus. The first model is a model that is in the first apparatus and that is used to perform a task corresponding to the first configuration information. The second model is a model that is in the second apparatus and that is used to perform the task corresponding to the first configuration information. The second apparatus sends the one or more pieces of first configuration information to the first apparatus. In this way, the second apparatus configures the first transmission resource and the second transmission resource for the first apparatus, so that the first apparatus reports the local parameter through the first transmission resource, and receives the global parameter through the second transmission resource.

According to the first aspect or the second aspect, in an embodiment, each piece of first configuration information includes at least one of the following: a frequency domain position, a time domain position, or a time domain periodicity that is occupied by the second transmission resource; a data transmission format of the global parameter; a switching condition of the data transmission format of the global parameter; whether a hybrid automatic repeat request (HARQ) is supported for transmission of the global parameter; a start condition for enabling the HARQ for the transmission of the global parameter; a frequency domain position, a time domain position, or a time domain periodicity that is occupied by the first transmission resource; a data transmission format of the local parameter; a switching condition of the data transmission format of the local parameter; whether the HARQ is supported for transmission of the local parameter; a start condition for enabling the HARQ for the transmission of the local parameter; an offset of the first transmission resource relative to the second transmission resource in time domain and/or frequency domain; or activation duration. The activation duration indicates that the first apparatus completes receiving of the global parameter and reporting of the local parameter within the activation duration. In this embodiment, content included in each piece of first configuration information is shown. In this way, the first transmission resource and the second transmission resource are configured. In addition to the time domain positions and the frequency positions of the first transmission resource and the second transmission resource, each piece of first configuration information further includes the data transmission format of the global parameter, configuration information related to HARQ feedback, the data transmission format of the local parameter, and configuration information related to HARQ feedback. In this way, better transmission of the global parameter and the local parameter is implemented, and transmission efficiency is improved.

According to the first aspect or the second aspect, in an embodiment, the switching condition of the data transmission format of the global parameter includes: a quantity of rounds of training performed by the second apparatus on the second model is greater than or equal to a first threshold, or inference precision of a second model obtained by the second apparatus by performing an i^{th} round of training on the second model based on an i^{th} round of local parameter that is of the first model and that is reported by the first apparatus is greater than or equal to a second threshold, where i is an integer greater than or equal to 1. In this embodiment, the switching condition of the data transmission format of the global parameter is shown, so that the first apparatus determines the data transmission format of the global parameter, and parses the global parameter. Further, this helps properly set the switching condition of the data transmission format of the global parameter with reference to a model training requirement, and improve model training efficiency and precision.

According to the first aspect or the second aspect, in an embodiment, the switching condition of the data transmission format of the local parameter includes: a quantity of rounds of training performed by the first apparatus on the first model is greater than or equal to a third threshold, or inference precision of a first model obtained by the first apparatus by performing an i^{th} round of training on the first model based on an i^{th} round of global parameter that is of the second model and that is sent by the second apparatus to the first apparatus is greater than or equal to a fourth threshold, where i is an integer greater than or equal to 1. In this embodiment, the switching condition of the data transmission format of the local parameter is shown, so that the first apparatus sends the local parameter in the corresponding data transmission format. This helps improve data transmission efficiency. Further, this helps properly set the switching condition of the data transmission format of the local parameter with reference to the model training requirement, and improve model training efficiency and precision.

According to the first aspect or the second aspect, in an embodiment, the start condition for enabling the HARQ for the transmission of the global parameter includes: the quantity of rounds of training performed by the second apparatus on the second model is greater than or equal to the first threshold; or the inference precision of the second model obtained by the second apparatus by performing the i^{th} round of training on the second model based on the i^{th} round of local parameter that is of the first model and that is reported by the first apparatus is greater than or equal to the second threshold, where i is an integer greater than or equal to 1; or a correlation coefficient between the i^{th} round of global parameter and an (i+1)^{th} round of global parameter is greater than or equal to a fifth threshold, the i^{th} round of global parameter is a global parameter obtained by the second apparatus by performing the i^{th} round of training on the second model, and the (i+1)^{th} round of global parameter is a global parameter obtained by the second apparatus by performing an (i+1)^{th} round of training on the second model. In this embodiment, some embodiments of the starting condition for enabling the HARQ for transmission of the global parameter are shown, so that the first apparatus determines, with reference to an actual situation, whether to feed back the HARQ for the global parameter. This helps improve data transmission reliability, and improve model training precision or accuracy.

According to the first aspect or the second aspect, in an embodiment, the start condition for enabling the HARQ for the transmission of the local parameter includes: the quantity of rounds of training performed by the first apparatus on the first model is greater than or equal to the third threshold; or the inference precision of the first model obtained by the first apparatus by performing the i^{th} round of training on the first model based on the i^{th} round of global parameter that is of the second model and that is reported by the second apparatus is greater than or equal to the third threshold, where i is an integer greater than or equal to 1; or a correlation coefficient between the i^{th} round of local parameter and an (i+1)^{th} round of local parameter is greater than or equal to a sixth threshold, the i^{th} round of local parameter is a local parameter obtained by the first apparatus by performing the i^{th} round of training on the first model, and the (i+1)^{th} round of local parameter is a local parameter obtained by the first apparatus by performing an (i+1)^{th} round of training on the first model. In this embodiment, some embodiments of the starting condition for enabling the HARQ for transmission of the local parameter are shown, so that the first apparatus determines, with reference to an actual situation, whether to feed back the HARQ for the local parameter. This helps improve data transmission reliability, and improve model training precision or accuracy.

According to the first aspect, in an embodiment, the first transmission resource includes one or more sub-resources. The method further includes: The first apparatus receives one or more pieces of second configuration information from the second apparatus. Each piece of second configuration information is used to configure a configuration manner in which the first transmission resource is configured as the one or more sub-resources. In this embodiment, the configuration manner in which the first transmission resource is configured as the one or more sub-resources is further configured, so that the first transmission resource is configured as the one or more sub-resources. This helps the second apparatus group apparatuses that participate in model training corresponding to a same task, and configure apparatuses in a same group to use a same sub-resource. This helps improve model training precision, and configure proper sub-resources with reference to capabilities or features of the apparatuses, to improve resource scheduling flexibility. Further, the one or more pieces of second configuration information may be understood as a hierarchical configuration mode: any one of the one or more pieces of first configuration information. That is, the second apparatus may indicate, for the first transmission resource configured based on any piece of the first configuration information, one piece of second configuration information in the one or more pieces of second configuration information, so that the first apparatus determines, based on the configuration manner indicated by the second configuration information, the configuration manner in which the first transmission resource is configured as the one or more sub-resources.

According to the second aspect, in an embodiment, the first transmission resource includes one or more sub-resources. The method further includes: The second apparatus sends one or more pieces of second configuration information to the first apparatus. Each piece of second configuration information is used to configure a configuration manner in which the first transmission resource is configured as the one or more sub-resources. In this way, the first transmission resource is configured as the one or more sub-resources. This helps the second apparatus group apparatuses that participate in model training corresponding to a same task, and configure apparatuses in a same group to use a same sub-resource. This helps improve model training precision, and configure proper sub-resources with reference to capabilities or features of the apparatuses, to improve resource scheduling flexibility. Further, the one or more pieces of second configuration information may be understood as a hierarchical configuration mode: any one of the one or more pieces of first configuration information. That is, the second apparatus may indicate, for the first transmission resource configured based on any piece of the first configuration information, one piece of second configuration information in the one or more pieces of second configuration information, so that the first apparatus determines, based on the configuration manner indicated by the second configuration information, the configuration manner in which the first transmission resource is configured as the one or more sub-resources.

According to the first aspect or the second aspect, in an embodiment, each piece of second configuration information includes at least one of the following: an identity of the configuration manner; first indication information, where the first indication information indicates a time-frequency position of each of the one or more sub-resources; one or more pieces of first group configuration information, where the one or more pieces of first group configuration information correspond to the one or more sub-resources, and each piece of first group configuration information includes a condition that is satisfied by an apparatus using a sub-resource corresponding to the first group configuration information; or one or more first duty cycles, where the one or more first duty cycles correspond to the one or more sub-resources, and each first duty cycle indicates that an apparatus using a sub-resource corresponding to the first duty cycle reports a local parameter of the first model once when the apparatus using the sub-resource corresponding to the first duty cycle receives a global parameter of the second model from the second apparatus for N times, where N is an integer greater than or equal to 1. In this embodiment, content included in each piece of second configuration information is shown, so that the configuration manner is configured. Further, each piece of second configuration information may further indicate the time-frequency position of each sub-resource, the one or more pieces of first group configuration information, and the one or more first duty cycles, so that apparatuses in different groups may determine, based on the second configuration information, sub-resources and first duty cycles that are used by the apparatuses. In this way, the second apparatus configures proper sub-resources and duty cycles for apparatuses in different groups with reference to capabilities or features of the apparatuses in the different groups. This helps improve model training precision and efficiency.

According to the first aspect or the second aspect, in an embodiment, the first transmission resource and the second transmission resource that are configured based on each piece of first configuration information constitute a transmission resource pair. Each piece of second configuration information further includes an index of a transmission resource pair associated with the second configuration information. In this embodiment, the second configuration information may further include the index of the transmission resource pair associated with the second configuration information, to indicate that the first transmission resource in the transmission resource pair is configured in the sub-resource configuration manner indicated by the second configuration information.

According to the first aspect or the second aspect, in an embodiment, a condition that is satisfied by the apparatus of the sub-resource corresponding to each piece of first group configuration information includes at least one of the following: a first environment parameter condition, a first dataset parameter condition, a first service parameter condition, or a first traffic feature condition. The first environment parameter condition means that a similarity between a reference environment parameter and an environment parameter of the apparatus using the sub-resource corresponding to the first group configuration information is greater than or equal to a seventh threshold. The first dataset parameter condition means that a similarity between a reference dataset parameter and a dataset parameter of the apparatus using the sub-resource corresponding to the first group configuration information is greater than or equal to an eighth threshold. The first service parameter condition means that a similarity between a reference service parameter and a service parameter of the apparatus using the sub-resource corresponding to the first group configuration information is greater than or equal to a ninth threshold. The first traffic feature condition means that a similarity between a reference traffic feature and a traffic feature of the apparatus using the sub-resource corresponding to the first group configuration information is greater than or equal to a tenth threshold. In this embodiment, the condition that is satisfied by the apparatus of the sub-resource corresponding to each piece of first group configuration information is shown. It can be learned that environment parameters, dataset parameters, service parameters, and/or traffic features of apparatuses that use a same sub-resource may be similar, and importance degrees of local parameters reported by these apparatuses are also similar. This helps the second apparatus aggregate, based on corresponding weights, the local parameters reported by these apparatuses. This helps improve model training precision.

According to the first aspect, in an embodiment, a first transmission resource in an M^{th} piece of first configuration information in the one or more pieces of first configuration information includes one or more sub-resources, and M is an integer greater than or equal to 1. The method further includes: The first apparatus receives one or more pieces of third configuration information from the second apparatus. The one or more pieces of third configuration information correspond to the one or more sub-resources, and each of the one or more pieces of third configuration information includes configuration information of a sub-resource corresponding to the third configuration information. In this embodiment, for the one or more sub-resources included in the first transmission resource in the M^{th} piece of first configuration information, the first apparatus may receive configuration information that is configured by the second apparatus and that is corresponding to each of the one or more sub-resources. In this way, the first transmission resource is configured as one or more sub-resources. This helps the second apparatus group apparatuses that participate in model training corresponding to a same task, and configure apparatuses in a same group to use a same sub-resource. This helps improve model training precision, and configure proper sub-resources with reference to capabilities or features of the apparatuses, to improve resource scheduling flexibility.

According to the second aspect, in an embodiment, a first transmission resource in an M^{th} piece of first configuration information in the one or more pieces of first configuration information includes one or more sub-resources, and M is an integer greater than or equal to 1. The method further includes: The second apparatus sends one or more pieces of third configuration information to the first apparatus. The one or more pieces of third configuration information correspond to the one or more sub-resources, and each of the one or more pieces of third configuration information includes configuration information of a sub-resource corresponding to the third configuration information. In this embodiment, for the one or more sub-resources included in the first transmission resource in the M^{th} piece of first configuration information, the second apparatus may configure configuration information corresponding to each of the one or more sub-resources for the first apparatus. In this way, the first transmission resource is configured as one or more sub-resources. This helps the second apparatus group apparatuses that participate in model training corresponding to a same task, and configure apparatuses in a same group to use a same sub-resource. This helps improve model training precision, and configure proper sub-resources with reference to capabilities or features of the apparatuses, to improve resource scheduling flexibility.

According to the first aspect or the second aspect, in an embodiment, each piece of third configuration information includes at least one of the following: second indication information, where the second indication information indicates a time-frequency position of the sub-resource corresponding to the third configuration information; second group configuration information, where the second allocation configuration information includes a condition that is satisfied by an apparatus using the sub-resource corresponding to the third configuration information; or a second duty cycle, where the second duty cycle indicates that an apparatus using the sub-resource corresponding to the third configuration information reports a local parameter of the first model once when the apparatus using the sub-resource corresponding to the third configuration information receives a global parameter of the second model from the second apparatus for P times, where P is an integer greater than or equal to 1. In this embodiment, content included in each piece of third configuration information is shown, so that the sub-resources are configured. Further, each piece of third configuration information may further indicate the time-frequency position of the corresponding sub-resource, the second group configuration information, and the second duty cycle, so that the apparatus using the sub-resource may determine, based on the third configuration information, the time-frequency position of the sub-resource and the second duty cycle. In this way, the second apparatus configures proper sub-resources and duty cycles for apparatuses in different groups with reference to capabilities or features of the apparatuses in the different groups. This helps improve model training precision and efficiency.

According to the first aspect or the second aspect, in an embodiment, the first transmission resource and a second transmission resource that are configured based on the M^{th} piece of first configuration information constitute a transmission resource pair. Each piece of third configuration information further includes an index of the transmission resource pair.

According to the first aspect, in an embodiment, the method further includes: The first apparatus receives one or more pieces of fourth configuration information from the second apparatus. Each piece of fourth configuration information indicates a compute resource. The one or more pieces of fourth configuration information correspond to the one or more first transmission resources and the one or more second transmission resources that are configured based on the one or more pieces of first configuration information. In this embodiment, the first apparatus may further receive the compute resource indicated by the second apparatus. Each compute resource corresponds to the first transmission resources and the second transmission resources that are configured based on the one or more pieces of first configuration information, so that the first apparatus performs model training through the compute resource corresponding to the first configuration information. In this way, the second apparatus flexibly schedules the compute resource of the first apparatus. This helps improve model training precision.

According to the second aspect, in an embodiment, the method further includes: The second apparatus sends one or more pieces of fourth configuration information to the first apparatus. Each of the one or more pieces of fourth configuration information indicates a compute resource. The one or more pieces of fourth configuration information correspond to the one or more first transmission resources and the one or more second transmission resources that are configured based on the one or more pieces of first configuration information. In this way, the second apparatus indicates the compute resource to the first apparatus, so that the first apparatus performs model training through the compute resource corresponding to the first configuration information. In this way, the second apparatus flexibly schedules the compute resource of the first apparatus. This helps improve model training precision.

According to the first aspect, in an embodiment, the method further includes: The first apparatus receives a first media access control control element (MAC CE) from the second apparatus. The first MAC CE indicates a configuration manner configured based on one of the one or more pieces of second configuration information. In this embodiment, the first apparatus may indicate the second configuration information through the first MAC CE. In this way, the first apparatus determines the configuration manner in which the first transmission resource is configured as the one or more sub-resources. The first apparatus may determine a sub-resource used by the first apparatus, and report the local parameter through the sub-resource. This helps improve model training precision and resource scheduling flexibility.

According to the second aspect, in an embodiment, the method further includes: The second apparatus sends a first MAC CE to the first apparatus. The one or more pieces of fourth configuration information correspond to the one or more first transmission resources and the one or more second transmission resources that are configured based on the one or more pieces of first configuration information. In this way, the first apparatus determines the configuration manner in which the first transmission resource is configured as the one or more sub-resources. The first apparatus may determine a sub-resource used by the first apparatus, and report the local parameter through the sub-resource. This helps improve model training precision and resource scheduling flexibility.

According to the first aspect or the second aspect, in an embodiment, the first transmission resource and the second transmission resource that are configured based on each piece of first configuration information constitute the transmission resource pair. The first MAC CE further indicates a first transmission resource pair. The first transmission resource pair is a transmission resource pair configured based on one of the one or more pieces of first configuration information. In this embodiment, the first MAC CE further indicates the first transmission resource pair, so that the first apparatus determines that the configuration manner indicated by the first MAC CE is a configuration manner in which the first transmission resource in the first transmission resource pair is configured as one or more sub-resources. When performing model training of a task corresponding to the first transmission resource pair, the first apparatus sends the local parameter through a corresponding sub-resource in the first transmission resource in the first transmission resource pair.

According to the first aspect or the second aspect, in an embodiment, the first MAC CE further includes a federated learning radio network temporary identifier (FL-RNTI) used to configure a task corresponding to the first transmission resource pair. In this embodiment, the task of the first transmission resource pair is identified by the FL-RNTI, to identify the first transmission resource pair.

According to the first aspect, in an embodiment, the method further includes: The first apparatus receives a second MAC CE from the second apparatus. The second MAC CE indicates a first sub-resource, and the first sub-resource is one of the one or more sub-resources. In this embodiment, the first apparatus may receive the first sub-resource indicated by the second apparatus. In this way, the first apparatus reports the local parameter through the first sub-resource.

According to the second aspect, in an embodiment, the method further includes: The second apparatus sends a second MAC CE to the first apparatus. The second MAC CE indicates a first sub-resource, and the first sub-resource is one of the one or more sub-resources. In this way, the first apparatus reports the local parameter through the first sub-resource.

According to the first aspect or the second aspect, in an embodiment, the first transmission resource and the second transmission resource that are configured based on the M^{th} piece of first configuration information constitute the transmission resource pair. The second MAC CE further indicates the transmission resource pair.

According to the first aspect or the second aspect, in an embodiment, the second MAC CE further includes an FL-RNTI of a task corresponding to the transmission resource pair. In this way, the transmission resource pair is indicated by the FL-RNTI.

According to the first aspect, in an embodiment, the first transmission resource and the second transmission resource that are configured based on each piece of first configuration information constitute the transmission resource pair. The method further includes: The first apparatus receives first downlink control information (DCI) from the second apparatus. The first DCI includes at least one of the following: an index of a first transmission resource pair, an identity of a first configuration manner, an identifier of a first sub-resource, an identifier of a first compute resource, a HARQ indicator, a data transmission format indicator, a quantization indicator, or an uplink transmit power coefficient used on a first transmission resource or the first sub-resource in the first transmission resource pair. The first transmission resource pair is a transmission resource pair configured based on one of the one or more pieces of first configuration information. The first configuration manner is a configuration manner configured based on one of the one or more pieces of second configuration information. The first sub-resource is a sub-resource configured based on one of the one or more pieces of third configuration information. The first compute resource is a compute resource configured based on one of the one or more pieces of fourth configuration information. The HARQ indicator indicates whether a local parameter transmitted on the first transmission resource included in the first transmission resource pair supports the HARQ and whether a global parameter transmitted on a second transmission resource included in the first transmission resource pair supports the HARQ. The quantization indicator indicates quantization precision of the local parameter transmitted on the first transmission resource included in the first transmission resource pair and quantization precision of the global parameter transmitted on the second transmission resource included in the first transmission resource pair. In this embodiment, content included in the first DCI is shown, to indicate the transmission resource pair, the configuration manner, and/or the sub-resource. In this way, the first apparatus is indicated to perform model training of a corresponding task. Further, the first DCI further includes indicators such as an indicator of the compute resource, the HARQ indicator, the data transmission format indicator, the quantization indicator, and the uplink transmit power coefficient. This helps improve model parameter transmission efficiency and model training precision.

According to the second aspect, in an embodiment, the first transmission resource and the second transmission resource that are configured based on each piece of first configuration information constitute the transmission resource pair. The method further includes: The second apparatus sends first DCI to the first apparatus. The first DCI includes at least one of the following: an index of a first transmission resource pair, an identity of a first configuration manner, an identifier of a first sub-resource, an identifier of a first compute resource, a HARQ indicator, a data transmission format indicator, a quantization indicator, or an uplink transmit power coefficient used on a first transmission resource or the first sub-resource in the first transmission resource pair. The first transmission resource pair is a transmission resource pair configured based on one of the one or more pieces of first configuration information. The first configuration manner is a configuration manner configured based on one of the one or more pieces of second configuration information. The first sub-resource is a sub-resource configured based on one of the one or more pieces of third configuration information. The first compute resource is a compute resource configured based on one of the one or more pieces of fourth configuration information. The HARQ indicator indicates whether a local parameter transmitted on the first transmission resource included in the first transmission resource pair supports the HARQ and whether a global parameter transmitted on a second transmission resource included in the first transmission resource pair supports the HARQ. The quantization indicator indicates quantization precision of the local parameter transmitted on the first transmission resource included in the first transmission resource pair and quantization precision of the global parameter transmitted on the second transmission resource included in the first transmission resource pair. In this embodiment, content included in the first DCI is shown, to indicate the transmission resource pair, the configuration manner, and/or the sub-resource. In this way, the first apparatus is indicated to perform model training of a corresponding task. Further, the first DCI further includes indicators such as an indicator of the compute resource, the HARQ indicator, the data transmission format indicator, the quantization indicator, and the uplink transmit power coefficient. This helps improve model parameter transmission efficiency and model training precision.

According to the first aspect or the second aspect, in an embodiment, the first DCI is generated through scrambling with a common RNTI.

According to the first aspect or the second aspect, in an embodiment, the first DCI is generated through scrambling with an FL-RNTI. The FN-RNTI identifies a task corresponding to the first transmission resource pair. In this way, the first transmission resource pair is identified by the FL-RNTI. Therefore, the first DCI may not include an index of the first transmission resource pair.

According to the first aspect, in an embodiment, the first transmission resource and the second transmission resource that are configured based on each piece of first configuration information constitute the transmission resource pair. The method further includes: The first apparatus receives a third MAC CE from the second apparatus. The third MAC CE is used to activate or deactivate one or more transmission resource pairs configured based on X of the one or more pieces of first configuration information, and X is an integer greater than or equal to 1. In this embodiment, the second apparatus activates or deactivates, through the third MAC CE, the one or more transmission resource pairs configured based on the X pieces of first configuration information. In this way, the second apparatus flexibly activates or deactivates the transmission resource pair.

According to the second aspect, in an embodiment, the first transmission resource and the second transmission resource that are configured based on each piece of first configuration information constitute the transmission resource pair. The method further includes: The second apparatus sends a third MAC CE to the first apparatus. The third MAC CE is used to activate or deactivate one or more transmission resource pairs configured based on X of the one or more pieces of first configuration information, and X is an integer greater than or equal to 1. In this embodiment, the second apparatus activates or deactivates, through the third MAC CE, the one or more transmission resource pairs configured based on the X pieces of first configuration information. In this way, the second apparatus flexibly activates or deactivates the transmission resource pair.

According to the first aspect or the second aspect, in an embodiment, the second MAC CE further includes activation time or deactivation time. The activation time is activation time of the one or more transmission resource pairs configured based on the X pieces of first configuration information. The deactivation time is deactivation time of the one or more transmission resource pairs configured based on the X pieces of first configuration information. In this way, the activation time or the deactivation time is indicated. The second apparatus may flexibly indicate the activation time or the deactivation time of the transmission resource pair.

According to the first aspect, in an embodiment, the method further includes: The first apparatus receives second DCI from the second apparatus. The second DCI indicates one of the one or more transmission resource pairs corresponding to the X pieces of first configuration information. In this embodiment, the second apparatus may select one transmission resource pair from the X activated transmission resource pairs, and indicate the transmission resource pair through the second DCI. In this way, the first apparatus is indicated to perform model training of a task corresponding to the transmission resource pair.

According to the second aspect, in an embodiment, the method further includes: The second apparatus sends second DCI to the first apparatus. The second DCI indicates one of the one or more transmission resource pairs corresponding to the X pieces of first configuration information. In this embodiment, the second apparatus may select one transmission resource pair from the X activated transmission resource pairs, and indicate the transmission resource pair through the second DCI. In this way, the first apparatus is indicated to perform model training of a task corresponding to the transmission resource pair.

According to the first aspect, in an embodiment, the first transmission resource and the second transmission resource that are configured based on each piece of first configuration information constitute the transmission resource pair. The method further includes: The first apparatus receives a fourth MAC CE from the second apparatus. The fourth MAC CE includes a first bit sequence. A bit in the first bit sequence corresponds to the one or more transmission resource pairs configured based on the one or more pieces of first configuration information. The bit in the first bit sequence indicates whether to activate the transmission resource pair corresponding to the bit. In this embodiment, the second apparatus indicates the activated transmission resource pair through the first bit sequence in the fourth MAC CE. In this way, the second apparatus flexibly activates or deactivates the transmission resource pair.

According to the second aspect, in an embodiment, the first transmission resource and the second transmission resource that are configured based on each piece of first configuration information constitute the transmission resource pair. The method further includes: The second apparatus sends a fourth MAC CE to the first apparatus. The fourth MAC CE includes a first bit sequence. A bit in the first bit sequence corresponds to the one or more transmission resource pairs configured based on the one or more pieces of first configuration information. The bit in the first bit sequence indicates whether to activate the transmission resource pair corresponding to the bit. In this embodiment, the second apparatus indicates the activated transmission resource pair through the first bit sequence in the fourth MAC CE. In this way, the second apparatus flexibly activates or deactivates the transmission resource pair.

According to the first aspect, in an embodiment, the method further includes: The first apparatus receives third DCI from the second apparatus. The third DCI indicates one of one or more transmission resource pairs activated by the fourth MAC CE. In this embodiment, the second apparatus may select one transmission resource pair from the transmission resource pair activated by the fourth MAC CE, and indicate the transmission resource pair through the third DCI. In this way, the first apparatus is indicated to perform model training of a task corresponding to the transmission resource pair.

According to the second aspect, in an embodiment, the method further includes: The second apparatus sends third DCI to the first apparatus. The third DCI indicates one of one or more transmission resource pairs activated by the fourth MAC CE. In this embodiment, the second apparatus may select one transmission resource pair from the transmission resource pair activated by the fourth MAC CE, and indicate the transmission resource pair through the third DCI. In this way, the first apparatus is indicated to perform model training of a task corresponding to the transmission resource pair.

According to the first aspect, in an embodiment, the first transmission resource and the second transmission resource that are configured based on each piece of first configuration information constitute the transmission resource pair. The method further includes: The first apparatus receives a fifth MAC CE from the second apparatus. The fifth MAC CE indicates one or more of the one or more transmission resource pairs configured based on the one or more pieces of first configuration information and a transmission cycle corresponding to each of the one or more transmission resource pairs. The transmission cycle corresponding to each of the one or more transmission resource pairs is an updated transmission cycle corresponding to each of the one or more transmission resource pairs indicated by the second apparatus to the first apparatus. In this embodiment, the first apparatus may receive the fifth MAC CE, to determine, based on the fifth MAC CE, the updated transmission cycle corresponding to each of the transmission resource pairs indicated by the fifth MAC CE. A configuration of the transmission resource pair is modified.

According to the second aspect, in an embodiment, the first transmission resource and the second transmission resource that are configured based on each piece of first configuration information constitute the transmission resource pair. The method further includes: The second apparatus sends a fifth MAC CE to the first apparatus. The fifth MAC CE indicates one or more of the one or more transmission resource pairs configured based on the one or more pieces of first configuration information and a transmission cycle corresponding to each of the one or more transmission resource pairs. The transmission cycle corresponding to each of the one or more transmission resource pairs is an updated transmission cycle corresponding to each of the one or more transmission resource pairs indicated by the second apparatus to the first apparatus. In this embodiment, the second apparatus may send the fifth MAC CE to the first apparatus, to determine, based on the fifth MAC CE, the updated transmission cycle corresponding to each of the transmission resource pairs indicated by the fifth MAC CE. A configuration of the transmission resource pair is modified.

According to a third aspect of this application, a first apparatus is provided and includes:
a transceiver module, configured to receive one or more pieces of first configuration information from a second apparatus, where each piece of first configuration information is used to configure a first transmission resource and a second transmission resource, a part or all of the first transmission resource is used by the first apparatus to report a local parameter of a first model to the second apparatus, the second transmission resource is used by the first apparatus to receive a global parameter of a second model from the second apparatus, the first model is a model that is in the first apparatus and that is used to perform a task corresponding to the first configuration information, and the second model is a model that is in the second apparatus and that is used to perform the task corresponding to the first configuration information; and
a processing module, configured to determine transmission resources configured based on the one or more pieces of first configuration information.

According to a fourth aspect of this application, a second apparatus is provided and includes:
a processing module, configured to determine one or more pieces of first configuration information, where each piece of first configuration information is used to configure a first transmission resource and a second transmission resource, a part or all of the first transmission resource is used by a first apparatus to report a local parameter of a first model to the second apparatus, the second transmission resource is used by the first apparatus to receive a global parameter of a second model from the second apparatus, the first model is a model that is in the first apparatus and that is used to perform a task corresponding to the first configuration information, and the second model is a model that is in the second apparatus and that is used to perform the task corresponding to the first configuration information; and
a transceiver module, configured to send the one or more pieces of first configuration information to the first apparatus.

According to the third aspect or the fourth aspect, in an embodiment, each piece of first configuration information includes at least one of the following: a frequency domain position, a time domain position, or a time domain periodicity that is occupied by the second transmission resource; a data transmission format of the global parameter; a switching condition of the data transmission format of the global parameter; whether a HARQ is supported for transmission of the global parameter; a start condition for enabling the HARQ for the transmission of the global parameter; a frequency domain position, a time domain position, or a time domain periodicity that is occupied by the first transmission resource; a data transmission format of the local parameter; a switching condition of the data transmission format of the local parameter; whether the HARQ is supported for transmission of the local parameter; a start condition for enabling the HARQ for the transmission of the local parameter; an offset of the first transmission resource relative to the second transmission resource in time domain and/or frequency domain; or activation duration. The activation duration indicates that the first apparatus completes receiving of the global parameter and reporting of the local parameter within the activation duration.

According to the third aspect or the fourth aspect, in an embodiment, the switching condition of the data transmission format of the global parameter includes: a quantity of rounds of training performed by the second apparatus on the second model is greater than or equal to a first threshold, or inference precision of a second model obtained by the second apparatus by performing an i^{th} round of training on the second model based on an i^{th} round of local parameter that is of the first model and that is reported by the first apparatus is greater than or equal to a second threshold, where i is an integer greater than or equal to 1.

According to the third aspect or the fourth aspect, in an embodiment, the switching condition of the data transmission format of the local parameter includes: a quantity of rounds of training performed by the first apparatus on the first model is greater than or equal to a third threshold, or inference precision of a first model obtained by the first apparatus by performing an i^{th} round of training on the first model based on an i^{th} round of global parameter that is of the second model and that is sent by the second apparatus to the first apparatus is greater than or equal to a fourth threshold, where i is an integer greater than or equal to 1.

According to the third aspect or the fourth aspect, in an embodiment, the start condition for enabling the HARQ for the transmission of the global parameter includes: the quantity of rounds of training performed by the second apparatus on the second model is greater than or equal to the first threshold; or the inference precision of the second model obtained by the second apparatus by performing the i^{t}h round of training on the second model based on the i^{th} round of local parameter that is of the first model and that is reported by the first apparatus is greater than or equal to the second threshold, where i is an integer greater than or equal to 1; or a correlation coefficient between the i^{th} round of global parameter and an (i+1)^{th} round of global parameter is greater than or equal to a fifth threshold, the i^{th} round of global parameter is a global parameter obtained by the second apparatus by performing the i^{th} round of training on the second model, and the (i+1)^{th} round of global parameter is a global parameter obtained by the second apparatus by performing an (i+1)^{th} round of training on the second model.

According to the third aspect or the fourth aspect, in an embodiment, the start condition for enabling the HARQ for the transmission of the local parameter includes: the quantity of rounds of training performed by the first apparatus on the first model is greater than or equal to the third threshold; or the inference precision of the first model obtained by the first apparatus by performing the i^{th} round of training on the first model based on the i^{th} round of global parameter that is of the second model and that is reported by the second apparatus is greater than or equal to the third threshold, where i is an integer greater than or equal to 1; or a correlation coefficient between the i^{th} round of local parameter and an (i+1)^{th} round of local parameter is greater than or equal to a sixth threshold, the i^{th} round of local parameter is a local parameter obtained by the first apparatus by performing the i^{th} round of training on the first model, and the (i+1)^{th} round of local parameter is a local parameter obtained by the first apparatus by performing an (i+1)^{th} round of training on the first model.

According to the third aspect, in an embodiment, the first transmission resource includes one or more sub-resources. The transceiver module is further configured to receive one or more pieces of second configuration information from the second apparatus. Each piece of second configuration information is used to configure a configuration manner in which the first transmission resource is configured as the one or more sub-resources.

According to the fourth aspect, in an embodiment, the first transmission resource includes one or more sub-resources. The method further includes: The second apparatus sends one or more pieces of second configuration information to the first apparatus. Each piece of second configuration information is used to configure a configuration manner in which the first transmission resource is configured as the one or more sub-resources.

According to the third aspect or the fourth aspect, in an embodiment, each piece of second configuration information includes at least one of the following: an identity of the configuration manner; first indication information, where the first indication information indicates a time-frequency position of each of the one or more sub-resources; one or more pieces of first group configuration information, where the one or more pieces of first group configuration information correspond to the one or more sub-resources, and each piece of first group configuration information includes a condition that is satisfied by an apparatus using a sub-resource corresponding to the first group configuration information; or one or more first duty cycles, where the one or more first duty cycles correspond to the one or more sub-resources, and each first duty cycle indicates that an apparatus using a sub-resource corresponding to the first duty cycle reports a local parameter of the first model once when the apparatus using the sub-resource corresponding to the first duty cycle receives a global parameter of the second model from the second apparatus for N times, where Nis an integer greater than or equal to 1.

According to the third aspect or the fourth aspect, in an embodiment, the first transmission resource and the second transmission resource that are configured based on each piece of first configuration information constitute a transmission resource pair. Each piece of second configuration information further includes an index of a transmission resource pair associated with the second configuration information.

According to the third aspect or the fourth aspect, in an embodiment, a condition that is satisfied by the apparatus of the sub-resource corresponding to each piece of first group configuration information includes at least one of the following: a first environment parameter condition, a first dataset parameter condition, a first service parameter condition, or a first traffic feature condition. The first environment parameter condition means that a similarity between a reference environment parameter and an environment parameter of the apparatus using the sub-resource corresponding to the first group configuration information is greater than or equal to a seventh threshold. The first dataset parameter condition means that a similarity between a reference dataset parameter and a dataset parameter of the apparatus using the sub-resource corresponding to the first group configuration information is greater than or equal to an eighth threshold. The first service parameter condition means that a similarity between a reference service parameter and a service parameter of the apparatus using the sub-resource corresponding to the first group configuration information is greater than or equal to a ninth threshold. The first traffic feature condition means that a similarity between a reference traffic feature and a traffic feature of the apparatus using the sub-resource corresponding to the first group configuration information is greater than or equal to a tenth threshold.

According to the third aspect, in an embodiment, a first transmission resource in an M^{th} piece of first configuration information in the one or more pieces of first configuration information includes one or more sub-resources, and M is an integer greater than or equal to 1. The transceiver module is further configured to receive one or more pieces of third configuration information from the second apparatus. The one or more pieces of third configuration information correspond to the one or more sub-resources, and each of the one or more pieces of third configuration information includes configuration information of a sub-resource corresponding to the third configuration information.

According to the fourth aspect, in an embodiment, a first transmission resource in an M^{th} piece of first configuration information in the one or more pieces of first configuration information includes one or more sub-resources, and M is an integer greater than or equal to 1. The transceiver module is further configured to send one or more pieces of third configuration information to the first apparatus. The one or more pieces of third configuration information correspond to the one or more sub-resources, and each of the one or more pieces of third configuration information includes configuration information of a sub-resource corresponding to the third configuration information.

According to the third aspect or the fourth aspect, in an embodiment, each piece of third configuration information includes at least one of the following: second indication information, where the second indication information indicates a time-frequency position of the sub-resource corresponding to the third configuration information; second group configuration information, where the second allocation configuration information includes a condition that is satisfied by an apparatus using the sub-resource corresponding to the third configuration information; or a second duty cycle, where the second duty cycle indicates that an apparatus using a sub-resource corresponding to the third configuration information reports a local parameter of the first model once when the apparatus using the sub-resource corresponding to the third configuration information receives a global parameter of the second model from the second apparatus for P times, where P is an integer greater than or equal to 1.

According to the third aspect or the fourth aspect, in an embodiment, the first transmission resource and a second transmission resource that are configured based on the M^{th} piece of first configuration information constitute a transmission resource pair. Each piece of third configuration information further includes an index of the transmission resource pair.

According to the third aspect, in an embodiment, the transceiver module is further configured to receive one or more pieces of fourth configuration information from the second apparatus. Each piece of fourth configuration information indicates a compute resource. The one or more pieces of fourth configuration information correspond to the one or more first transmission resources and the one or more second transmission resources that are configured based on the one or more pieces of first configuration information.

According to the fourth aspect, in an embodiment, the transceiver module is further configured to send one or more pieces of fourth configuration information to the first apparatus. Each of the one or more pieces of fourth configuration information indicates a compute resource. The one or more pieces of fourth configuration information correspond to the one or more first transmission resources and the one or more second transmission resources that are configured based on the one or more pieces of first configuration information.

According to the third aspect, in an embodiment, the transceiver module is further configured to receive a first MAC CE from the second apparatus. The first MAC CE indicates a configuration manner configured based on one of the one or more pieces of second configuration information.

According to the fourth aspect, in an embodiment, the transceiver module is further configured to send a first MAC CE to the first apparatus. The one or more pieces of fourth configuration information correspond to the one or more first transmission resources and the one or more second transmission resources that are configured based on the one or more pieces of first configuration information.

According to the third aspect or the fourth aspect, in an embodiment, the first transmission resource and the second transmission resource that are configured based on each piece of first configuration information constitute the transmission resource pair. The first MAC CE further indicates a first transmission resource pair. The first transmission resource pair is a transmission resource pair configured based on one of the one or more pieces of first configuration information.

According to the third aspect or the fourth aspect, in an embodiment, the first MAC CE further includes an FL-RNTI used to configure a task corresponding to the first transmission resource pair.

According to the third aspect, in an embodiment, the transceiver module is further configured to receive a second MAC CE from the second apparatus. The second MAC CE indicates a first sub-resource, and the first sub-resource is one of the one or more sub-resources.

According to the fourth aspect, in an embodiment, the transceiver module is further configured to send a second MAC CE to the first apparatus. The second MAC CE indicates a first sub-resource, and the first sub-resource is one of the one or more sub-resources.

According to the third aspect or the fourth aspect, in an embodiment, the first transmission resource and the second transmission resource that are configured based on the M^{th} piece of first configuration information constitute the transmission resource pair. The second MAC CE further indicates the transmission resource pair.

According to the third aspect or the fourth aspect, in an embodiment, the second MAC CE further includes an FL-RNTI of a task corresponding to the transmission resource pair.

According to the third aspect, in an embodiment, the first transmission resource and the second transmission resource that are configured based on each piece of first configuration information constitute the transmission resource pair. The transceiver module is further configured to receive first DCI from the second apparatus. The first DCI includes at least one of the following: an index of a first transmission resource pair, an identity of a first configuration manner, an identifier of a first sub-resource, an identifier of a first compute resource, a HARQ indicator, a data transmission format indicator, a quantization indicator, or an uplink transmit power coefficient used on a first transmission resource or the first sub-resource in the first transmission resource pair. The first transmission resource pair is a transmission resource pair configured based on one of the one or more pieces of first configuration information. The first configuration manner is a configuration manner configured based on one of the one or more pieces of second configuration information. The first sub-resource is a sub-resource configured based on one of the one or more pieces of third configuration information. The first compute resource is a compute resource configured based on one of the one or more pieces of fourth configuration information. The HARQ indicator indicates whether a local parameter transmitted on the first transmission resource included in the first transmission resource pair supports the HARQ and whether a global parameter transmitted on a second transmission resource included in the first transmission resource pair supports the HARQ. The quantization indicator indicates quantization precision of the local parameter transmitted on the first transmission resource included in the first transmission resource pair and quantization precision of the global parameter transmitted on the second transmission resource included in the first transmission resource pair.

According to the fourth aspect, in an embodiment, the first transmission resource and the second transmission resource that are configured based on each piece of first configuration information constitute the transmission resource pair. The transceiver module is further configured to send first DCI to the first apparatus. The first DCI includes at least one of the following: an index of a first transmission resource pair, an identity of a first configuration manner, an identifier of a first sub-resource, an identifier of a first compute resource, a HARQ indicator, a data transmission format indicator, a quantization indicator, or an uplink transmit power coefficient used on a first transmission resource or the first sub-resource in the first transmission resource pair. The first transmission resource pair is a transmission resource pair configured based on one of the one or more pieces of first configuration information. The first configuration manner is a configuration manner configured based on one of the one or more pieces of second configuration information. The first sub-resource is a sub-resource configured based on one of the one or more pieces of third configuration information. The first compute resource is a compute resource configured based on one of the one or more pieces of fourth configuration information. The HARQ indicator indicates whether a local parameter transmitted on the first transmission resource included in the first transmission resource pair supports the HARQ and whether a global parameter transmitted on a second transmission resource included in the first transmission resource pair supports the HARQ. The quantization indicator indicates quantization precision of the local parameter transmitted on the first transmission resource included in the first transmission resource pair and quantization precision of the global parameter transmitted on the second transmission resource included in the first transmission resource pair.

According to the third aspect or the fourth aspect, in an embodiment, the first DCI is generated through scrambling with a common RNTI.

According to the third aspect or the fourth aspect, in an embodiment, the first DCI is generated through scrambling with an FL-RNTI. The FN-RNTI identifies a task corresponding to the first transmission resource pair.

According to the third aspect, in an embodiment, the first transmission resource and the second transmission resource that are configured based on each piece of first configuration information constitute the transmission resource pair. The transceiver module is further configured to receive a third MAC CE from the second apparatus. The third MAC CE is used to activate or deactivate one or more transmission resource pairs configured based on X of the one or more pieces of first configuration information, and X is an integer greater than or equal to 1.

According to the fourth aspect, in an embodiment, the first transmission resource and the second transmission resource that are configured based on each piece of first configuration information constitute the transmission resource pair. The transceiver module is further configured to send a third MAC CE to the first apparatus. The third MAC CE is used to activate or deactivate one or more transmission resource pairs configured based on X of the one or more pieces of first configuration information, and X is an integer greater than or equal to 1.

According to the third aspect or the fourth aspect, in an embodiment, the second MAC CE further includes activation time or deactivation time. The activation time is activation time of the one or more transmission resource pairs configured based on the X pieces of first configuration information. The deactivation time is deactivation time of the one or more transmission resource pairs configured based on the X pieces of first configuration information.

According to the third aspect, in an embodiment, the transceiver module is further configured to receive second DCI from the second apparatus. The second DCI indicates one of the one or more transmission resource pairs corresponding to the X pieces of first configuration information.

According to the fourth aspect, in an embodiment, the transceiver module is further configured to send second DCI to the first apparatus. The second DCI indicates one of the one or more transmission resource pairs corresponding to the X pieces of first configuration information.

According to the third aspect, in an embodiment, the first transmission resource and the second transmission resource that are configured based on each piece of first configuration information constitute the transmission resource pair. The transceiver module is further configured to receive a fourth MAC CE from the second apparatus. The fourth MAC CE includes a first bit sequence. A bit in the first bit sequence corresponds to the one or more transmission resource pairs configured based on the one or more pieces of first configuration information. The bit in the first bit sequence indicates whether to activate the transmission resource pair corresponding to the bit.

According to the fourth aspect, in an embodiment, the first transmission resource and the second transmission resource that are configured based on each piece of first configuration information constitute the transmission resource pair. The transceiver module is further configured to send a fourth MAC CE to the first apparatus. The fourth MAC CE includes a first bit sequence. A bit in the first bit sequence corresponds to the one or more transmission resource pairs configured based on the one or more pieces of first configuration information. The bit in the first bit sequence indicates whether to activate the transmission resource pair corresponding to the bit.

According to the third aspect, in an embodiment, the transceiver module is further configured to receive third DCI from the second apparatus. The third DCI indicates one of one or more transmission resource pairs activated by the fourth MAC CE.

According to the fourth aspect, in an embodiment, the transceiver module is further configured to send third DCI to the first apparatus. The third DCI indicates one of one or more transmission resource pairs activated by the fourth MAC CE.

According to the third aspect, in an embodiment, the first transmission resource and the second transmission resource that are configured based on each piece of first configuration information constitute the transmission resource pair. The transceiver module is further configured to receive a fifth MAC CE from the second apparatus. The fifth MAC CE indicates one or more of the one or more transmission resource pairs configured based on the one or more pieces of first configuration information and a transmission cycle corresponding to each of the one or more transmission resource pairs. The transmission cycle corresponding to each of the one or more transmission resource pairs is an updated transmission cycle corresponding to each of the one or more transmission resource pairs indicated by the second apparatus to the first apparatus.

According to the fourth aspect, in an embodiment, the first transmission resource and the second transmission resource that are configured based on each piece of first configuration information constitute the transmission resource pair. The transceiver module is further configured to send a fifth MAC CE to the first apparatus. The fifth MAC CE indicates one or more of the one or more transmission resource pairs configured based on the one or more pieces of first configuration information and a transmission cycle corresponding to each of the one or more transmission resource pairs. The transmission cycle corresponding to each of the one or more transmission resource pairs is an updated transmission cycle corresponding to each of the one or more transmission resource pairs indicated by the second apparatus to the first apparatus.

For the third aspect, the first apparatus may be a terminal device or a network device, a component (for example, a processor, a chip, or a chip system) in the terminal device or the network device, a logical module or software that can implement all or a part of functions of the terminal device, or a logical module or software that can implement all or a part of functions of the network device. The transceiver module may be a transceiver or an input/output interface. The processing module may be a processor.

In an embodiment, the first apparatus is a chip, a chip system, or a circuit disposed in the terminal device. When the first apparatus is a chip, a chip system, or a circuit disposed in the terminal device, the transceiver module may be an input/output interface, an interface circuit, an output circuit, an input circuit, a pin, a related circuit, or the like on the chip, the chip system, or the circuit. The processing module may be a processor, a processing circuit, a logic circuit, or the like.

In another embodiment, the first apparatus is a chip, a chip system, or a circuit disposed in the network device. When the first apparatus is a chip, a chip system, or a circuit disposed in the network device, the transceiver module may be an input/output interface, an interface circuit, an output circuit, an input circuit, a pin, a related circuit, or the like on the chip, the chip system, or the circuit. The processing module may be a processor, a processing circuit, a logic circuit, or the like.

For the fourth aspect, the second apparatus may be a terminal device or a network device, a component (for example, a processor, a chip, or a chip system) in the terminal device or the network device, a logical module or software that can implement all or a part of functions of the terminal device, or a logical module or software that can implement all or a part of functions of the network device. The transceiver module may be a transceiver or an input/output interface. The processing module may be a processor.

In an embodiment, the second apparatus is a chip, a chip system, or a circuit disposed in the terminal device. When the second apparatus is a chip, a chip system, or a circuit disposed in the terminal device, the transceiver module may be an input/output interface, an interface circuit, an output circuit, an input circuit, a pin, a related circuit, or the like on the chip, the chip system, or the circuit. The processing module may be a processor, a processing circuit, a logic circuit, or the like.

In another embodiment, the second apparatus is a chip, a chip system, or a circuit disposed in the network device. When the second apparatus is a chip, a chip system, or a circuit disposed in the network device, the transceiver module may be an input/output interface, an interface circuit, an output circuit, an input circuit, a pin, a related circuit, or the like on the chip, the chip system, or the circuit. The processing module may be a processor, a processing circuit, a logic circuit, or the like.

According to a fifth aspect of this application, a first apparatus is provided. The first apparatus includes a processor and a memory. The memory stores a computer program or computer instructions. The processor is configured to invoke and run the computer program or the computer instructions stored in the memory, to cause the processor to implement any one of the embodiments of the first aspect.

In an embodiment, the first apparatus further includes a transceiver. The processor is configured to control the transceiver to receive or send a signal.

According to a sixth aspect of this application, a second apparatus is provided. The second apparatus includes a processor and a memory. The memory stores a computer program or computer instructions. The processor is configured to invoke and run the computer program or the computer instructions stored in the memory, to cause the processor to implement any one of the embodiments of the second aspect.

In an embodiment, the second apparatus further includes a transceiver. The processor is configured to control the transceiver to receive or send a signal.

According to a seventh aspect of this application, a first apparatus is provided and includes a processor and an interface circuit. The processor is configured to: communicate with another apparatus through the interface circuit, and perform the method according to the first aspect. There are one or more processors.

According to an eighth aspect of this application, a second apparatus is provided and includes a processor and an interface circuit. The processor is configured to: communicate with another apparatus through the interface circuit, and perform the method according to the second aspect. There are one or more processors.

According to a ninth aspect of this application, a first apparatus is provided and includes a processor, configured to: be connected to a memory, and invoke a program stored in the memory, to perform the method according to the first aspect. The memory may be located inside or outside the first apparatus. In addition, there are one or more processors.

According to a tenth aspect of this application, a second apparatus is provided and includes a processor, configured to: be connected to a memory, and invoke a program stored in the memory, to perform the method according to the second aspect. The memory may be located inside or outside the second apparatus. In addition, there are one or more processors.

In an embodiment, the first apparatus in the third aspect, the fifth aspect, the seventh aspect, or the ninth aspect may be a chip or a chip system.

In an embodiment, the second apparatus in the fourth aspect, the sixth aspect, the eighth aspect, or the tenth aspect may be a chip or a chip system.

According to an eleventh aspect of this application, a computer program product including computer instructions is provided. When the computer program product runs on a computer, the computer is caused to perform any embodiment of either the first aspect or the second aspect.

According to a twelfth aspect of this application, a computer-readable storage medium is provided and includes computer instructions. When the instructions are run on a computer, the computer is caused to perform any embodiment of either the first aspect or the second aspect.

According to a thirteenth aspect of this application, a chip apparatus is provided and includes a processor, configured to invoke a computer program or computer instructions in a memory, to cause the processor to perform any embodiment of either the first aspect or the second aspect.

In an embodiment, the processor is coupled to the memory through an interface.

According to a fourteenth aspect of this application, a communication system is provided. The communication system includes the first apparatus shown in the third aspect and the second apparatus shown in the fourth aspect.

It can be learned from the foregoing technical solutions that the first apparatus receives the one or more pieces of first configuration information from the second apparatus. Each piece of first configuration information includes the first transmission resource and the second transmission resource. The part or all of the first transmission resource is used by the first apparatus to report the local parameter of the first model to the second apparatus. The second transmission resource is used by the first apparatus to receive the global parameter of the second model from the second apparatus. The first model is the model that is in the first apparatus and that is used to perform a task corresponding to the first configuration information. The second model is the model that is in the second apparatus and that is used to perform the task corresponding to the first configuration information. The first apparatus determines transmission resources configured based on the one or more pieces of first configuration information. In this way, the second apparatus configures the first transmission resource and the second transmission resource for the first apparatus, so that the first apparatus reports the local parameter through the first transmission resource, and receives the global parameter through the second transmission resource.

### BRIEF DESCRIPTION OF DRAWINGS

FIG. 1 is a diagram of a communication system according to an embodiment of this application;

FIG. 2 is another diagram of a communication system according to an embodiment of this application;

FIG. 3 is a diagram of an application scenario of a resource configuration method according to an embodiment of this application;

FIG. 4 is a diagram of an embodiment of a resource configuration method according to an embodiment of this application;

FIG. 5 is a diagram of first transmission resources and second transmission resources according to an embodiment of this application;

FIG. 6 is a diagram of sub-resources included in a first transmission resource and second transmission resources according to an embodiment of this application;

FIG. 7 is a diagram of a common resource configuration according to an embodiment of this application;

FIG. 8 is a diagram of compute resources according to an embodiment of this application;

FIG. 9 is a diagram of another embodiment of a resource configuration method according to an embodiment of this application;

FIG. 10 is a diagram of another embodiment of a resource configuration method according to an embodiment of this application;

FIG. 11 is a diagram of another embodiment of a resource configuration method according to an embodiment of this application;

FIG. 12 is a diagram of another embodiment of a resource configuration method according to an embodiment of this application;

FIG. 13 is a diagram of another embodiment of a resource configuration method according to an embodiment of this application;

FIG. 14 is a diagram of a structure of a first apparatus according to an embodiment of this application;

FIG. 15 is a diagram of a structure of a second apparatus according to an embodiment of this application;

FIG. 16 is a diagram of a structure of an apparatus according to an embodiment of this application;

FIG. 17 is a diagram of a structure of a terminal device according to an embodiment of this application; and

FIG. 18 is a diagram of a structure of a network device according to an embodiment of this application.

### DESCRIPTION OF EMBODIMENTS

Embodiments of this application provide a resource configuration method and a related apparatus, so that a first apparatus receives one or more pieces of first configuration information from a second apparatus. In this way, the second apparatus configures a first transmission resource and a second transmission resource for the first apparatus, so that the first apparatus reports a local parameter through the first transmission resource, and receives a global parameter through the second transmission resource.

The following clearly describes technical solutions in embodiments of this application with reference to the accompanying drawings in embodiments of this application. It is clear that the described embodiments are merely some but not all of embodiments of this application. All other embodiments obtained by persons skilled in the art based on embodiments of this application without creative efforts shall fall within the protection scope of this application.

Reference to “an embodiment”, “some embodiments”, or the like described in this application indicates that one or more embodiments of this application include a feature, structure, or characteristic described with reference to the embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “contain”, “have”, and their variants all mean “include but are not limited to”, unless otherwise specifically emphasized in another manner.

In the descriptions of this application, unless otherwise specified, “/” means “or”. For example, A/B may represent A or B. A term “and/or” in this specification describes only an association relationship between associated objects and indicates that there may be three relationships. For example, A and/or B may represent the following three cases: Only A exists, both A and B exist, and only B exists. In addition, “at least one” means one or more, and “a plurality of” means two or more. “At least one of the following items (pieces)” or a similar expression thereof indicates any combination of these items, including a single item (piece) or any combination of a plurality of items (pieces). For example, at least one of a, b, or c may represent a, b, c, a and b, a and c, b and c, or a, b, and c, where a, b, and c may be singular or plural.

It may be understood that, in this application, an “indication” may include a direct indication, an indirect indication, an explicit indication, and an implicit indication. When a piece of indication information is described as indicating A, it may be understood as that the indication information carries A, directly indicates A, or indirectly indicates A.

In this application, information indicated by the indication information is referred to as to-be-indicated information. In an embodiment, the to-be-indicated information is indicated in a plurality of manners. For example, the to-be-indicated information, for example, the to-be-indicated information itself or an index of the to-be-indicated information, may be directly indicated, or the to-be-indicated information may be indirectly indicated by indicating other information. There is an association relationship between the other information and the to-be-indicated information. Alternatively, only a part of the to-be-indicated information may be indicated, and the other part of the to-be-indicated information is known or pre-agreed on. For example, information may alternatively be indicated by using an arrangement sequence of a plurality of pieces of information that is pre-agreed on (for example, stipulated in a protocol), to reduce indication overheads to some extent.

The to-be-indicated information may be sent as a whole, or may be divided into a plurality of pieces of sub-information for separate sending. In addition, sending periodicities and/or sending occasions of these pieces of sub-information may be the same or may be different. A sending method is not limited in this application. The sending periodicities and/or the sending occasions of these pieces of sub-information may be predefined, for example, predefined according to a protocol, or may be configured by a transmit end device by sending configuration information to a receive end device.

It may be understood that “sending” and “receiving” in this application indicate a signal transmission direction. For example, “sending information to XX” may be understood as that a destination end of the information is XX, and may include direct sending through an air interface, or include indirect sending through an air interface by another unit or module. “Receiving information from YY” may be understood as that a source end of the information is YY, and may include direct receiving from YY through an air interface, or may include indirect receiving from YY through an air interface from another unit or module. “Sending” may alternatively be understood as “outputting” of a chip interface, and “receiving” may alternatively be understood as “inputting” of a chip interface.

In other words, sending and receiving may be performed between devices, for example, between a network device and a terminal device; or may be performed inside a device, for example, sending or receiving between components, modules, chips, software modules, or hardware modules inside the device through a bus, a cable, or an interface.

It may be understood that processing, such as encoding and modulation, may be performed on the information between the source end and the destination end of the sent information, but the destination end may understand valid information from the source end. Similar descriptions in this application may be understood similarly, and details are not described again.

The technical solutions of this application may be applied to a cellular communication system related to the 3rd generation partnership project (3GPP), for example, a 4th generation (4G) communication system, a 5th generation (5G) communication system, or a communication system after the 5th generation communication system, for example, a 6th generation communication system. For example, the 4th generation communication system may include a long term evolution (LTE) communication system. The 5th generation communication system may include a new radio (NR) communication system. The technical solutions of this application may also be applied to a wireless fidelity (Wi-Fi) system, a communication system that supports convergence of a plurality of wireless technologies, a device-to-device (D2D) system, a vehicle-to-everything (V2X) communication system, and the like.

A communication system to which the technical solutions of this application are applicable includes a first apparatus and a second apparatus. In an embodiment, the communication system further includes more apparatuses, and the second apparatus and the more apparatuses may perform a technical solution similar to that in this application.

In an embodiment, the first apparatus is a network device or a terminal device; or the first apparatus is a chip, a chip system, or a processor in the network device or the terminal device; or the first apparatus is a logical module or software that implements a part or all of functions of the network device; or the first apparatus is a logical module or software that implements a part or all of functions of the terminal device.

In an embodiment, the second apparatus is a network device or a terminal device; or the first apparatus is a chip, a chip system, or a processor in the network device or the terminal device; or the first apparatus is a logical module or software that implements a part or all of functions of the network device; or the second apparatus is a logical module or software that implements a part or all of functions of the terminal device.

In an embodiment, the network device may be a core network device or an access network device.

The following describes some forms of the first apparatus and the second apparatus. This application is still applicable to another form, and the following embodiments do not constitute a limitation on this application.

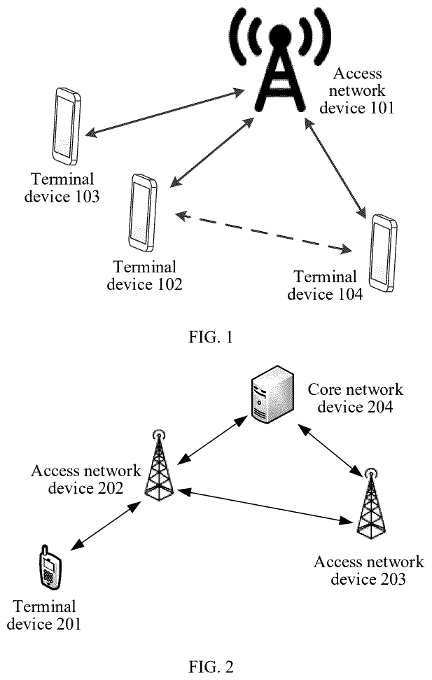

1. The first apparatus is a terminal device or a chip in the terminal device, and the second apparatus is a network device or a chip in the network device. In this embodiment, the first apparatus and the second apparatus may perform the method provided in this application. In an embodiment, the network device is an access network device or a core network device. For example, FIG. 1 is a diagram of a communication system according to an embodiment of this application. As shown in FIG. 1, the first apparatus is a terminal device 102, and the second apparatus is an access network device 101. The method provided in this application is performed between the terminal device 102 and the access network device 101. For another example, FIG. 2 is another diagram of a communication system according to an embodiment of this application. As shown in FIG. 2, the first apparatus is a terminal device 201, and the second apparatus is a core network device 204. The method provided in this application is performed between the terminal device 201 and the core network device 204. Information transmitted between the terminal device 201 and the core network device 204 is forwarded via an access network device 202.

2. The first apparatus is a first terminal device or a chip in the first terminal device, and the second apparatus is a second terminal device or a chip in the second terminal device. In this embodiment, the first apparatus and the second apparatus may perform the method provided in this application. For example, as shown in FIG. 1, the first apparatus is a terminal device 102, and the second apparatus is a terminal device 104. The method provided in this application is performed between the terminal device 102 and the terminal device 104.

3. The first apparatus is a first network device or a chip in the first network device, and the second apparatus is a second network device or a chip in the second network device. In this embodiment, the first apparatus and the second apparatus may perform the method provided in this application. In an embodiment, the first network device is an access network device or a core network device. The second network device is an access network device or a core network device. For example, as shown in FIG. 2, the first apparatus is an access network device 202, and the second apparatus is a core network device 204. The method provided in this application is performed between the access network device 202 and the core network device 204. In an embodiment, the access network device 202 and the core network device 204 may interact with each other through an NT interface. For another example, the first apparatus is the access network device 202, the second apparatus is an access network device 203, and the method provided in this application is performed between the access network device 202 and the access network device 203.

FIG. 1 and FIG. 2 show some communication systems to which this application is applicable. This application is still applicable to another communication system. This is not specifically limited in this application.

The following describes a terminal device and a network device in this application.

The terminal device may be a wireless terminal device that can receive scheduling information and indication information of the network device. The wireless terminal device may be a device that provides voice and/or data connectivity for a user, a handheld device having a wireless connection function, or another processing device connected to a wireless modem.

The terminal device may communicate with one or more core networks or an internet via an access network. The terminal device may be a mobile terminal device, for example, a mobile phone (or referred to as a “cellular” phone or a mobile phone), a computer, or a data card. For example, the terminal device may be a portable, pocket-sized, handheld, computer built-in, or vehicle-mounted mobile apparatus, which exchanges voice and/or data with a radio access network. For example, the terminal device may be a device like a personal communication service (PCS) phone, a cordless phone, a session initiation protocol phone, a wireless local loop (WLL) station, a personal digital assistant (PDA), a tablet (Pad), or a computer having a wireless transceiver function. The wireless terminal device may also be referred to as a system, a subscriber unit (subscriber unit), a subscriber station, a mobile station (MS), a remote station, an access point (AP), a remote terminal device (remote terminal), an access terminal device (access terminal), a user terminal device (user terminal), a user agent, a subscriber station (SS), customer premises equipment (CPE), a terminal, user equipment (UE), a mobile terminal (MT), or the like.

By way of example, and not limitation, in embodiments of this application, the terminal device may alternatively be a wearable device. The wearable device may also be referred to as a wearable intelligent device, an intelligent wearable device, or the like, and is a general term for wearable devices developed by intelligently designing everyday wearing by applying a wearable technology, for example, glasses, gloves, watches, clothing, and shoes. The wearable device is a portable device that can be directly worn on the body or integrated into clothes or an accessory of a user. The wearable device is not only a hardware device, but also implements a powerful function through software support, data exchange, and cloud interaction. In a broad sense, wearable intelligent devices include full-featured and large-sized devices that can implement all or a part of functions without depending on smartphones, for example, smart watches or smart glasses, and include devices that are dedicated to only one type of application function and need to collaboratively work with other devices such as smartphones, for example, various smart bands, smart helmets, or smart jewelry for monitoring physical signs.

The terminal device may alternatively be an uncrewed aerial vehicle, a robot, a terminal device in device-to-device (D2D) communication, a terminal device in vehicle-to-everything (V2X), a virtual reality (VR) terminal device, an augmented reality (AR) terminal device, a wireless terminal device in industrial control, a wireless terminal device in self driving, a wireless terminal device in remote medical, a wireless terminal in a smart grid, a wireless terminal device in transportation safety, a wireless terminal device in a smart city, a wireless terminal device in a smart home, or the like.

In addition, the terminal device may alternatively be a terminal device in an evolved communication system (for example, a 6th generation (6G) communication system) after a 5th generation (5G) communication system, a terminal device in a future evolved public land mobile network (PLMN), or the like. For example, a 6G network may further extend a form and a function of a 5G communication terminal, and a 6G terminal includes but is not limited to a vehicle, a cellular network terminal (integrating a function of a satellite terminal), an uncrewed aerial vehicle, or an internet of things (IoT) device.

In embodiments of this application, the terminal device has an artificial intelligence (AI) capability. For example, the terminal device may obtain an AI service provided by a network device or a server. The terminal device further has an AI processing capability.

It should be noted that the terminal device may be a device or an apparatus with a chip, a device or an apparatus integrated with a circuit, or a chip, a module, or a control unit in the device or the apparatus shown above. This is not specifically limited in this application.

The network device may be a device in a wireless network. For example, the network device may be an access network node (or an access network device) that connects the terminal device to the wireless network, and may also be referred to as a base station. Currently, some examples of the access network device are: a base station (gNodeB, gNB) in a 5G communication system, a transmission reception point (TRP), an evolved NodeB (eNB), a radio network controller (RNC), a NodeB (NB), a home base station (for example, a home evolved NodeB or a home NodeB, HNB), a baseband unit (BBU), or a wireless fidelity (Wi-Fi) access point AP. In addition, in a network structure, the network device may include a central unit (CU) node, a distributed unit (DU) node, a CU-control plane (CP), a CU-user plane (UP), a radio unit (RU), or a RAN device including a CU node and a DU node. The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). In different systems, the CU (or the CU-CP and the CU-UP), the DU, or the RU may also have different names, but persons skilled in the art may understand meanings thereof. For example, in an open access network (open RAN, ORAN) system, the CU may also be referred to as an open CU (O-CU), the DU may also be referred to as an open DU (O-DU), the CU-CP may also be referred to as an open CU-CP (O-CU-CP), the CU-UP may also be referred to as an open CU-UP (O-CU-UP), and the RU may also be referred to as an open RU (O-RU). Any one of the CU (or the CU-CP and the CU-UP), the DU, and the RU may be implemented by using a software module, a hardware module, or a combination of a software module and a hardware module.

The network device may be another apparatus that provides a wireless communication function for the terminal device. A technology and a device form that are used by the network device are not limited in embodiments of this application. For ease of description, this is not limited in embodiments of this application.

The network device may further include a core network device. For example, the core network device includes network elements such as a mobility management entity (MME), a home subscriber server (HSS), a serving gateway (S-GW), a policy and charging rules function (PCRF), and a public data network gateway (PDN gateway, P-GW) in a 4th generation (4G) network; and an access and mobility management function (AMF), a user plane function (UPF), or a session management function (SMF) in a 5G network. In addition, the core network device may further include another core network device in the 5G network and a next generation network (for example, a 6G network) of the 5G network.

In embodiments of this application, the network device may alternatively be a network node having an AI capability, and may provide an AI service for the terminal device or another network device. For example, the network device may be an AI node on a network side (an access network or a core network), a compute node, an access network node having the AI capability, or a core network element having the AI capability.

It should be noted that the network device may be the device or apparatus shown above, or may be a component (for example, a chip), a module, or a unit in the device or apparatus shown above. This is not specifically limited in this application.

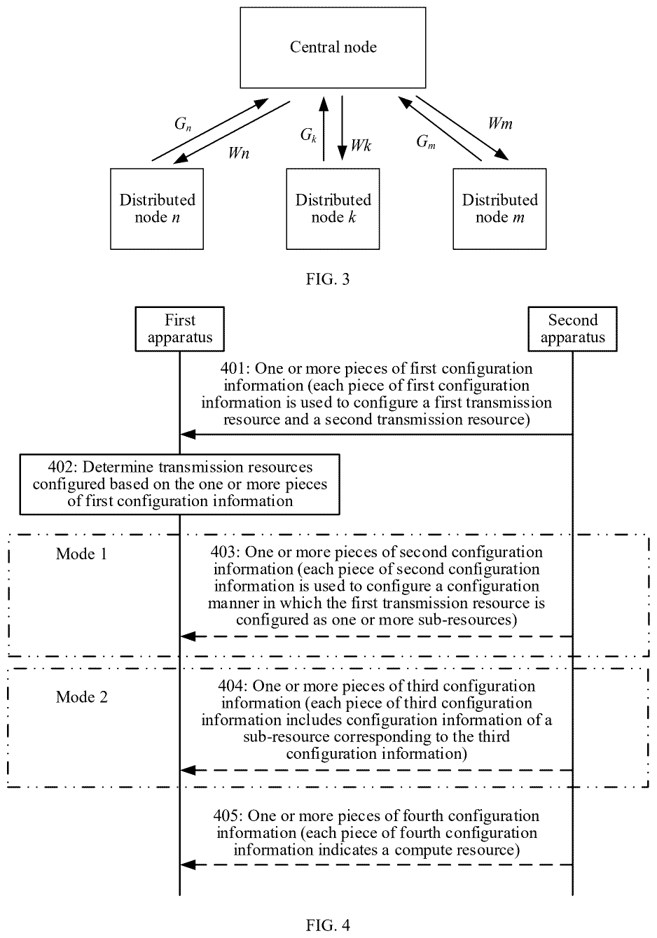

Federated learning is a typical distributed learning method. On a premise of ensuring user data privacy and security, each distributed node is prompted to collaborate with a central node to efficiently complete a model learning task. As shown in FIG. 3, a communication system includes a central node and one or more distributed nodes. For example, as shown in FIG. 3, the communication system includes a distributed node n, a distributed node k, and a distributed node m. Each distributed node collects a local dataset, and performs local model training to obtain a local parameter. Then, the distributed node sends the local parameter to the central node. The central node has no dataset. The central node collects local parameters reported by multiple distributed nodes, performs aggregation processing on the local parameters reported by the multiple distributed nodes to obtain a global parameter, and delivers the global parameter to each distributed node. In this way, model training and learning are implemented.

Each distributed node sends the local parameter to the central node on an uplink resource. The central node sends the global parameter to each distributed node, and the distributed node receives, through a downlink receiving resource, the global parameter sent by the central node. Therefore, how to configure the uplink sending resource and the downlink receiving resource is a problem worth considering.

This application provides a resource configuration method, so that a first apparatus receives one or more pieces of first configuration information from a second apparatus. Each piece of first configuration information includes a first transmission resource and a second transmission resource. In this way, the second apparatus configures the first transmission resource and the second transmission resource for the first apparatus, so that the first apparatus reports a local parameter through the first transmission resource, and receives a global parameter through the second transmission resource.

The following describes the technical solutions in this application with reference to specific embodiments.

FIG. 4 is a diagram of an embodiment of a resource configuration method according to an embodiment of this application. Refer to FIG. 4. The method includes the following operations.

401: A second apparatus sends one or more pieces of first configuration information to a first apparatus. Each piece of first configuration information is used to configure a first transmission resource and a second transmission resource. Correspondingly, the first apparatus receives the one or more pieces of first configuration information from the second apparatus.

A part or all of the first transmission resource is used by the first apparatus to report a local parameter of a first model to the second apparatus. The second transmission resource is used by the first apparatus to receive a global parameter of a second model from the second apparatus. The first model is a model that is in the first apparatus and that is used to perform a task corresponding to the first configuration information. The second model is a model that is in the second apparatus and that is used to perform the task corresponding to the first configuration information.

Each of the one or more pieces of first configuration information corresponds to a task. For the task, the first apparatus trains, by using the first model, the first model corresponding to the task. The first apparatus trains the first model based on local data in the first apparatus, to obtain the local parameter of the first model. The second apparatus trains, by using the second model, the second model corresponding to the task. The second apparatus collects local parameters reported by multiple apparatuses, and performs aggregation processing on the local parameters reported by the multiple apparatuses to obtain the global parameter of the second model. For example, as shown in FIG. 5, each piece of first configuration information is used to configure the first transmission resource used for transmission of the local parameter of the first model and the second transmission resource used for transmission of the global parameter of the second model.

In an embodiment, the first model and the second model may be a same model, or may be two different models. This is not specifically limited in this application. In an embodiment, the first model may be referred to as a local model, and the second model may be referred to as a global model.

In an embodiment, the local parameter of the first model includes a local weight parameter or a local weight gradient of the first model. The global parameter of the second model includes a global weight parameter or a global weight gradient of the second model.

In an embodiment, each of the one or more pieces of first configuration information corresponds to one task, and different first configuration information corresponds to different tasks. For example, the one or more pieces of first configuration information include two pieces of first configuration information, a 1^{st} piece of first configuration information corresponds to an image classification task, and a 2^{nd} piece of first configuration information corresponds to an image restoration task.

In an embodiment, the first transmission resource and the second transmission resource that are configured based on each piece of first configuration information constitute a transmission resource pair. Therefore, a task corresponding to the first configuration information may also be referred to as a task corresponding to the transmission resource pair.

In an embodiment, each piece of first configuration information includes at least one of the following: a frequency domain position, a time domain position, or a time domain periodicity that is occupied by the second transmission resource; a data transmission format of the global parameter; a switching condition of the data transmission format of the global parameter; whether a HARQ is supported for transmission of the global parameter; a start condition for enabling the HARQ for the transmission of the global parameter; a frequency domain position, a time domain position, or a time domain periodicity that is occupied by the first transmission resource; a data transmission format of the local parameter; a switching condition of the data transmission format of the local parameter; whether the HARQ is supported for transmission of the local parameter; a start condition for enabling the HARQ for the transmission of the local parameter; an offset of the first transmission resource relative to the second transmission resource in time domain and/or frequency domain; or activation duration.

The data transmission format of the global parameter includes a regenerative transmission mode of the global parameter and a transparent transmission mode of the global parameter. The regenerative transmission mode of the global parameter means that the second apparatus encodes and modulates the global parameter and sends the global parameter to the first apparatus. The transparent transmission mode of the global parameter means that the second apparatus directly maps the global parameter to a corresponding resource and sends the global parameter to the first apparatus. Compared with the transparent transmission mode, the global parameter sent in the regenerative transmission mode usually has higher precision.

In an embodiment, the switching condition of the data transmission format of the global parameter includes any one of the following items.

1. A quantity of rounds of training performed by the second apparatus on the second model is greater than or equal to a first threshold.

For example, the first threshold is 100. When the quantity of training rounds of the second model is less than 100, the second apparatus may transmit the global parameter of the second model in the transparent transmission mode. When the quantity of training rounds of the second model is greater than or equal to 100, the global parameter of the second model is more important for training of the first model of the first apparatus, and determines precision of the first model. Therefore, the second apparatus may switch from the transparent transmission mode to the regenerative transmission mode, and transmit the global parameter of the second model in the regenerative transmission mode.

In an embodiment, the first threshold is 100 or 1000.

In an embodiment, the first threshold is determined based on a task type corresponding to the first configuration information and/or a type of the first apparatus. For example, the type of the first apparatus includes a mobile phone terminal or a large server. The large server has strong computational power, and the large server may enable the first model to converge after a small quantity of training rounds. When the quantity of training rounds of the second model is greater than the first threshold, the global parameter of the second model is more important for training of the first model. Therefore, a value of the first threshold may be small. The second apparatus may switch from the transparent transmission mode to the regenerative transmission mode in a timely manner, and send the global parameter of the second model to the large server.

2. Inference precision of a second model obtained by the second apparatus by performing an i^{th} round of training on the second model based on an i^{th} round of local parameter that is of the first model and that is reported by the first apparatus is greater than or equal to a second threshold, where i is an integer greater than or equal to 1.

In an embodiment, the second apparatus transmits the global parameter of the second model in the transparent transmission mode. The second apparatus receives the i^{th} round of local parameter of the first model, and the second apparatus performs the i^{th} round of training on the second model based on the i^{th} round of local parameter of the first model to obtain the second model (namely, an updated second model). The second apparatus performs, by using the second model, the task corresponding to the first configuration information, to obtain an execution result of the task. Precision of the execution result of the task may be understood as the inference precision of the second model. Therefore, when the inference precision is greater than or equal to the second threshold, the second apparatus may switch from the transparent transmission mode to the regenerative transmission mode, and transmit the global parameter of the second model in the regenerative transmission mode.

In an embodiment, the second threshold is 0.3 or 0.4.

In an embodiment, the second threshold is determined based on the task type corresponding to the first configuration information and/or the type of the first apparatus. For example, the task type belongs to an industrial control task, and sensitivity of the industrial control task is high. A value of the second threshold may be set to a small value. In this way, the second apparatus can switch from the transparent transmission mode to the regenerative transmission mode in a timely manner, to help improve the precision of the global parameter transmitted by the second apparatus. This helps improve training precision of the first model.

In an embodiment, the first apparatus may send a data transmission switching recommendation to the second apparatus. The data transmission switching recommendation is used to recommend the second apparatus to switch the data transmission format of the global parameter.

Whether the HARQ is supported for the transmission of the global parameter means whether the first apparatus sends a HARQ feedback after receiving the global parameter from the second apparatus. In an embodiment, when the first apparatus successfully receives the global parameter from the second apparatus, the first apparatus sends an acknowledgement (ACK) message. When the first apparatus fails to receive the global parameter from the second apparatus, the first apparatus sends a non-acknowledgement (NACK) message.

In an embodiment, the start condition for enabling the HARQ for the transmission of the global parameter includes any one of the following items.

1. A quantity of rounds of training performed by the second apparatus on a second model is greater than or equal to a first threshold.

For example, the first threshold is 100. When the quantity of training rounds of the second model is less than 100, global parameters of the second model in the training rounds are less important for training of the first model. Therefore, the first apparatus may send no HARQ feedback for a received global parameter. When the quantity of training rounds of the second model is greater than or equal to 100, the global parameter of the second model is more important for training of the first model of the first apparatus, and determines precision of the first model. The first apparatus may send a HARQ feedback for a received global parameter, so that the second apparatus learns whether the first apparatus successfully receives the global parameter. This helps improve training precision of the first model.

For the first threshold, refer to the foregoing related descriptions.

It should be noted that, if a quantity of rounds of training performed by the first apparatus on the first model is aligned with the quantity of rounds of training performed by the second apparatus on the second model, the first apparatus may send the HARQ feedback for the global parameter from the second apparatus when determining that the quantity of training rounds is greater than or equal to the first threshold. If the quantity of rounds of training performed by the first apparatus on the first model is not aligned with the quantity of rounds of training performed by the second apparatus on the second model, the second apparatus may indicate the quantity of training rounds of the second model to the first apparatus, so that the first apparatus sends the HARQ feedback for the global parameter, or the second apparatus may indicate the first apparatus to enable the HARQ feedback for transmission of the global parameter.

2. Inference precision of a second model obtained by the second apparatus by performing an i^{th} round of training on the second model based on an i^{th} round of local parameter that is of the first model and that is reported by the first apparatus is greater than or equal to a second threshold, where i is an integer greater than or equal to 1.

For example, the second apparatus performs the i^{th} round of training on the second model based on the i^{th} round of local parameter of the first model, to obtain the second model. The second apparatus performs, by using the second model, the task corresponding to the first configuration information, to obtain an execution result of the task. Precision of the execution result of the task may be understood as the inference precision of the second model. Therefore, when the inference precision is greater than or equal to the second threshold, the second apparatus may indicate the first apparatus to send a HARQ feedback for a received global parameter. This helps the first apparatus better receive the global parameter, and improves training precision of the first model.

For the second threshold, refer to the foregoing related descriptions.

3. A correlation coefficient between an i^{th} round of global parameter and an (i+1)th round of global parameter is greater than or equal to a fifth threshold.

The i^{th} round of global parameter is a global parameter obtained by the second apparatus by performing the i^{th} round of training on the second model. The (i+1)^{th} round of global parameter is a global parameter obtained by the second apparatus by performing an (i+1)^{th} round of training on the second model.

In an embodiment, the fifth threshold is 0.8 or 0.9. This is not specifically limited in this application.

In an embodiment, if the correlation coefficient between the i^{th} round of global parameter and the (i+1)^{th} round of global parameter is large, it indicates that a similarity between the i^{th} round of global parameter and the (i+1)^{th} round of global parameter is high. This means that improvement of the training precision of the first model is limited, and improvement of a training mode should be considered. For example, the first apparatus may send the HARQ feedback for transmission of the global parameter.

The following describes a calculation manner of the correlation coefficient between the i^{th} round of global parameter and the (i+1)^{th} round of global parameter.

For example, the i^{th} round of global parameter may be quantized and represented as a vector A, and the (i+1)^{th} round of global parameter may be quantized and represented as a vector B. The second apparatus performs a vector point multiplication operation, a matrix multiplication operation, or a cosine similarity operation on the vector A and the vector B, to obtain a correlation coefficient between the vector A and the vector B. The correlation coefficient between the vector A and the vector B may be understood as the correlation coefficient between the i^{th} round of global parameter and the (i+1)^{th} round of global parameter. A larger correlation coefficient between the vector A and the vector B indicates a higher similarity between the i^{th} round of global parameter and the (i+1)^{th} round of global parameter.

In an embodiment, the second apparatus may indicate the first apparatus to send the first model to enable the HARQ feedback for transmission of the global parameter.

The data transmission format of the local parameter includes a regenerative transmission mode of the local parameter and a transparent transmission mode of the local parameter. The regenerative transmission mode of the local parameter means that the first apparatus encodes and modulates the local parameter and sends the local parameter to the second apparatus. The transparent transmission mode of the local parameter means that the first apparatus directly maps the local parameter to a corresponding resource and sends the local parameter to the second apparatus.

In an embodiment, the switching condition of the data transmission format of the local parameter includes any one of the following items.

1. A quantity of rounds of training performed by the first apparatus on the first model is greater than or equal to a third threshold.

This item is similar to the item 1 in the switching condition of the data transmission format of the global parameter. For details, refer to the foregoing related descriptions. A value of the third threshold is similar to the value of the first threshold. For details, refer to the foregoing related descriptions of the value of the first threshold.

2. Inference precision of a first model obtained by the first apparatus by performing an i^{th} round of training on the first model based on the i^{th} round of global parameter that is of the second model and that is sent by the second apparatus to the first apparatus is greater than or equal to a fourth threshold, where i is an integer greater than or equal to 1.

This item is similar to the item 2 in the switching condition of the data transmission format of the global parameter. For details, refer to the foregoing related descriptions. A value of the fourth threshold is similar to the value of the second threshold. For details, refer to the foregoing related descriptions of the value of the second threshold.

Whether the HARQ is enabled for the transmission of the local parameter means whether the second apparatus sends a HARQ feedback after receiving the local parameter from the first apparatus. For example, when the second apparatus successfully receives the local parameter from the first apparatus, the second apparatus feeds back an ACK to the first apparatus. When the second apparatus fails to receive the local parameter from the first apparatus, the second apparatus feeds back a NACK to the first apparatus.

In an embodiment, the second apparatus may indicate the first apparatus to switch the data transmission format of the local parameter.

In an embodiment, the start condition for enabling the HARQ for the transmission of the local parameter includes any one of the following items.

1. A quantity of rounds of training performed by the first apparatus on the first model is greater than or equal to a third threshold.

For example, the third threshold is 100. When the quantity of training rounds of the first model is less than 100, local parameters of the first model in first 100 training rounds are less important for training of the second model. Therefore, the second apparatus may send no HARQ feedback for a received local parameter. When the quantity of training rounds of the first model is greater than or equal to 100, the local parameter of the first model is more important for training of the second model, and determines precision of the second model. The second apparatus may send a HARQ feedback for a received local parameter, so that the first apparatus learns whether the second apparatus successfully receives the local parameter. This helps improve training precision of the second model.

A value of the third threshold is similar to the value of the first threshold. For details, refer to the foregoing related descriptions of the value of the first threshold.

It should be noted that, if the quantity of rounds of training performed by the first apparatus on the first model is aligned with the quantity of rounds of training performed by the second apparatus on the second model, the second apparatus may send the HARQ feedback for the local parameter from the second apparatus when determining that the quantity of training rounds is greater than or equal to the third threshold. If the quantity of rounds of training performed by the first apparatus on the first model is not aligned with the quantity of rounds of training performed by the second apparatus on the second model, the first apparatus may indicate the quantity of training rounds of the first model to the second apparatus, so that the second apparatus sends the HARQ feedback for the local parameter, or the first apparatus may indicate the second apparatus to enable the HARQ feedback for transmission of the local parameter.

2. Inference precision of a first model obtained by the first apparatus by performing an i^{th} round of training on the first model based on the i^{th} round of global parameter that is of the second model and that is reported by the second apparatus is greater than or equal to a fourth threshold, where i is an integer greater than or equal to 1.

For example, the first apparatus performs the i^{th} round of training on the first model based on the i^{th} round of global parameter of the second model, to obtain the first model. The first apparatus performs, by using the first model, the task corresponding to the first configuration information, to obtain an execution result of the task. Precision of the execution result of the task may be understood as the inference precision of the first model. Therefore, when the inference precision is greater than or equal to the fourth threshold, the first apparatus may indicate the second apparatus to send the HARQ feedback for the received local parameter, so that the second apparatus can better receive the global parameter, to improve training precision of the first model.

A value of the fourth threshold is similar to the value of the second threshold. For details, refer to the foregoing related descriptions of the second threshold. Details are not described herein again.

3. A correlation coefficient between an i^{th} round of local parameter and an (i+1)^{th} round of local parameter is greater than or equal to a sixth threshold.

The i^{th} round of local parameter is a local parameter obtained by the first apparatus by performing the i^{th} round of training on the first model. The (i+1)^{th} round of local parameter is a local parameter obtained by the first apparatus by performing an (i+1)^{th} round of training on the first model.

This item is similar to the item 3 in the foregoing start condition for enabling the HARQ for the transmission of the local parameter. For details, refer to the related descriptions of the item 3 in the start condition for enabling the HARQ for the transmission of the local parameter.

In an embodiment, the first apparatus sends a HARQ feedback recommendation to the second apparatus. The HARQ feedback recommendation is used to recommend the second apparatus to enable the HARQ feedback for the transmission of the local parameter.

The activation duration indicates that the first apparatus completes receiving of the global parameter and reporting of the local parameter within the activation duration.

The following shows a format of each piece of first configuration information:

ResourceCommonConfig :: = SEQUENCE {
ResourcePairList :: =
SEQUENCE(SIZE(1 . . . maxResourcePairNum))OF
ResourcePair
}
ResourcePair
SEQUENCE
{
ResourcePair_index
INTEGER (1 . . . maxResourcePairNum)
GlobalTransOccasion
:: = SEQUENCE {
Duration
INTEGER (1 . . . maxNumber_of_ms)
CycleStartOffset
CHOICE {
ms10
INTEGER(0 . .. 9),
ms20
INTEGER(0 . . . 19),
. . .
}
Format
ENUMERATED
{Regenerative
Gradient,
Transparent Gradient}
HARQ_feedback
ENUMERATED {Enable, Disable}
},
}
LocalTransOccasion
:: = SEQUENCE {
Duration
INTEGER (1 . . . maxNumber_of_ms)
CycleStartOffset
CHOICE {
ms10INTEGER(0 . . . 9),
ms20INTEGER(0 . . . 19),
. . .
}
Format
ENUMERATED {Coded Gradient, Transparent Gradient}
HARQ_feedback
ENUMERATED {Enable, Disable}
},
}
}

It can be learned from the first configuration information that the first configuration information includes a transmission resource pair index (ResourcePair_index), and the transmission resource pair index indicates a transmission resource pair configured based on the first configuration information. For example, in a global transmission occasion (GlobalTransOccasion), the first configuration information includes duration, a cycle start offset, a data transmission format, and a HARQ feedback. The duration indicates that the first apparatus completes receiving of the global parameter within the duration. The cycle start offset indicates a transmission cycle of the second transmission resource. For example, a value of the cycle start offset is ms10, indicating that the transmission cycle of the second transmission resource is 10 ms (milliseconds), and a transmission start point is time (namely, a millisecond in the transmission cycle) indicated based on an integer in each transmission cycle. A value of the data transmission format may be a regenerative transmission (Regenerative Gradient) mode or a transparent transmission (Transparent Gradient) mode. A value of the HARQ feedback is enable (Enable) or disable (Disable).

The first configuration information in a local transmission occasion (LocalTransOccasion) includes duration, a cycle start offset, a data transmission format, and a HARQ feedback. The duration indicates that the first apparatus completes sending of the local parameter within the duration. The cycle start offset indicates a transmission cycle of the first transmission resource. For example, a value of the cycle start offset is ms20, indicating that the transmission cycle of the first transmission resource is 20 ms (milliseconds), and a transmission start point is time (namely, a millisecond in the transmission cycle) indicated based on an integer in each transmission cycle. A value of the data transmission format is a regeneration transmission mode or a transparent transmission mode. A value of the HARQ feedback is enable or disable.

It should be noted that the format of the first configuration information is merely an example. Actually, the configuration information of the local parameter may alternatively be described in a relative offset manner. In an embodiment, the second apparatus indicates, to the first apparatus, an offset of a time-frequency resource occupied by the local parameter relative to a time-frequency resource occupied by the global parameter.

402: The first apparatus determines transmission resources configured based on the one or more pieces of first configuration information.

In an embodiment, the first transmission resource and the second transmission resource that are configured based on each piece of first configuration information constitute a transmission resource pair. The first apparatus determines the one or more transmission resource pairs configured based on the one or more pieces of first configuration information.

Operation 401 and operation 402 show a process in which the second apparatus configures the one or more pieces of first configuration information for the first apparatus. During actual application, the second apparatus further configures the one or more pieces of first configuration information for another apparatus. The another apparatus is an apparatus that participates in model training of a task corresponding to the one or more pieces of first configuration information.

Based on operation 401 and operation 402, In an embodiment, the second apparatus may indicate one of the one or more pieces of first configuration information to the first apparatus through indication information. The first apparatus may send the local parameter of the first model to the second apparatus through the first transmission resource configured based on the first configuration information. The first apparatus may receive the global parameter of the second model from the second apparatus through the second transmission resource configured based on the first configuration information. In an embodiment, the indication information is a MAC CE or DCI.

In an embodiment, the first transmission resource configured based on each piece of first configuration information is configured as one or more sub-resources. For this scenario, a network device may configure, for a terminal device, a configuration manner in which the first transmission resource is configured as the one or more sub-resources. Alternatively, the network device may send corresponding configuration information to the terminal device for each sub-resource. This application is still applicable to another configuration mode. This is not specifically limited in this application.

The following describes a configuration mode 1 with reference to operation 403. In an embodiment, the embodiment shown in FIG. 4 further includes operation 403.

403: The second apparatus sends one or more pieces of second configuration information to the first apparatus. Each piece of second configuration information is used to configure the configuration manner in which the first transmission resource is configured as the one or more sub-resources. Correspondingly, the first apparatus receives the one or more pieces of second configuration information from the second apparatus.

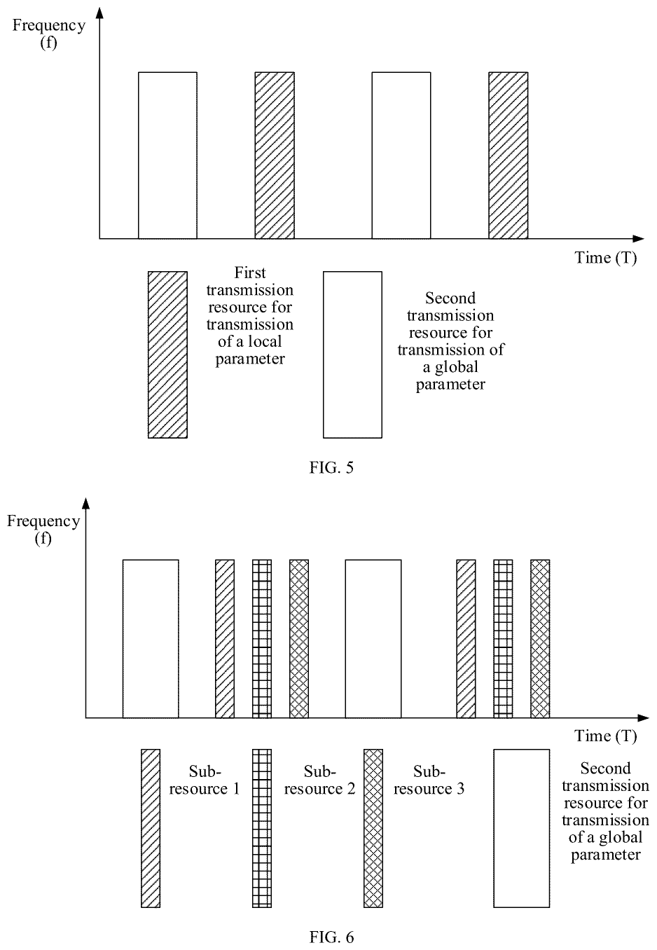

The first transmission resource includes one or more sub-resources. For example, as shown in FIG. 6, the first transmission resource is configured as three sub-resources: a sub-resource 1, a sub-resource 2, and a sub-resource 3.

In an embodiment, each piece of second configuration information is used to configure the configuration manner in which the first transmission resource is configured as the one or more sub-resources. Different second configuration information is used to configure different configuration manners in which the first transmission resource is configured as one or more sub-resources. For example, multiple pieces of second configuration information include two pieces of second configuration information, a 1^{st} piece of second configuration information is used to configure a configuration manner 1, and the configuration manner 1 is that the first transmission resource is configured as three sub-resources. A 2^{nd} piece of second configuration information is used to configure a configuration manner 2, and the configuration manner 2 is that the first transmission resource is configured as two sub-resources.

For any one of the one or more pieces of first configuration information, the network device may indicate one of the one or more pieces of second configuration information. In this way, a first transmission resource configured based on the any piece of first configuration information is configured as one or more sub-resources in a configuration manner in the second configuration information indicated by the network device. Therefore, indication overheads of the network device are reduced.

In an embodiment, each piece of second configuration information includes at least one of the following items.

1. Identity of the configuration manner, where
each configuration manner has a corresponding identifier, and different configuration manners correspond to different identifiers. Each piece of second configuration information may include an identity of a configuration manner configured based on the second configuration information. In this way, the configuration manner in which the first transmission resource is configured as one or more sub-resources is indicated. For example, as shown in FIG. 6, the identity of the configuration manner indicates that the first transmission resource is configured as the sub-resource 1, the sub-resource 2, and the sub-resource 3.

2. First indication information, where the first indication information indicates a time-frequency position of each of one or more sub-resources.

In an embodiment, the time-frequency position that is of each sub-resource and that is indicated by the first indication information is a relative time-frequency position relative to a time-frequency position of the second transmission resource. For example, the one or more sub-resources include a sub-resource 1 and a sub-resource 2. The time-frequency position of the second transmission resource is a resource block (RB) 15 to an RB 18. The first indication information indicates that the sub-resource 1 is located on an RB whose relative number is 2, and the sub-resource 2 is located on an RB whose relative number is 4. That is, the sub-resource 1 is located on an RB 20 after the RB 18, and the sub-resource 2 is located on the RB 20 after the RB 18.

3. One or more pieces of first group configuration information, where the one or more pieces of first group configuration information correspond to one or more sub-resources, and each piece of first group configuration information includes a condition that is satisfied by an apparatus using a sub-resource corresponding to the first group configuration information.

In an embodiment, the one or more pieces of first group configuration information are in one-to-one correspondence with the one or more sub-resources.

For a task corresponding to each piece of first configuration information, the network device may group apparatuses participating in model training of the task into one or more groups, and each group uses a corresponding sub-resource. In an embodiment, the network device groups the apparatuses for model training of the task based on environment parameters, dataset parameters, and/or service parameters of the apparatuses. The environmental parameter is used to represent a position of the apparatus. The dataset parameters include data of the apparatus. The service parameter includes a service type of the apparatus and/or computational power of the apparatus, and the like. Apparatuses with similar environment parameters, similar dataset parameters, and/or similar service parameters may belong to a same group. Sub-resources used by different groups are also different, so that the sub-resources are adapted to apparatuses in the different groups. For example, an apparatus in a group has a strong capability, and a transmission cycle of a sub-resource used by the group may be short. In other words, the apparatus in the group may frequently train the first model to obtain a local parameter, and report the local parameter through the sub-resource. For the network device, the network device collects local parameters of the first model that are reported by apparatuses in different groups, performs weighting processing on the local parameters of the first model reported by the apparatuses in the different groups, and performs aggregation processing to obtain a global parameter of the second model. For example, weighting coefficients of the local parameters of the first model reported by the apparatuses in the different groups are different. For example, the network device groups the apparatuses participating in the model training of the task into two groups, which are a group 1 and a group 2. A local parameter of the first model reported by the group 1 is more important, and a local parameter of the first model reported by the group 2 is less important. Therefore, a weighting coefficient of the local parameter of the first model reported by the group 1 is large, and a weighting coefficient of the local parameter of the first model reported by the group 2 is small. Therefore, each of the one or more pieces of first group configuration information includes the condition that is satisfied by the apparatus using the sub-resource corresponding to the first group configuration information.

In an embodiment, the condition that is satisfied by the apparatus using the sub-resource corresponding to each piece of first group configuration information includes at least one of the following: a first environment parameter condition, a first dataset parameter condition, a first service parameter condition, or a first traffic feature condition.

The first environment parameter condition means that a similarity between a reference environment parameter and an environment parameter of the apparatus using the sub-resource corresponding to the first group configuration information is greater than or equal to a seventh threshold. In an embodiment, the first group configuration information includes the reference environment parameter, or the reference environment parameter is pre-configured in the first apparatus. It should be noted that reference environment parameters included in different first group configuration information may be different. This is not specifically limited in this application. For example, the seventh threshold may be 0.8 or 0.9. In an embodiment, the environmental parameter of the apparatus using the sub-resource corresponding to the first group configuration information may be quantized and represented as a first vector, and the reference environmental parameter may be quantized and represented as a second vector. A correlation coefficient between the first vector and the second vector may be understood as the similarity between the reference environment parameter and the environment parameter of the apparatus using the sub-resource corresponding to the first group configuration information. For a manner of calculating the correlation coefficient between the first vector and the second vector, refer to the related descriptions of the foregoing manner of calculating the correlation coefficient between the vector A and the vector B. When the correlation coefficient between the first vector and the second vector is greater than or equal to the seventh threshold, the apparatus may use the sub-resource corresponding to the first group configuration information.

The first dataset parameter condition means that a similarity between a reference dataset parameter and a dataset parameter of the apparatus using the sub-resource corresponding to the first group configuration information is greater than or equal to an eighth threshold. In an embodiment, the first group configuration information includes the reference dataset parameter, or the reference dataset parameter is pre-configured in the first apparatus. It should be noted that reference dataset parameters included in different first group configuration information may be different. This is not specifically limited in this application. For example, the eighth threshold may be 0.8 or 0.9. In an embodiment, for a manner of calculating the similarity between the reference dataset parameter and the dataset parameter of the apparatus using the sub-resource corresponding to the first group configuration information, refer to the foregoing manner of calculating the similarity between the environment parameter and the reference environment parameter. For details, refer to the foregoing related descriptions.

The first service parameter condition means that a similarity between a reference service parameter and a service parameter of the apparatus using the sub-resource corresponding to the first group configuration information is greater than or equal to a ninth threshold. In an embodiment, the first group configuration information includes the reference service parameter, or the reference service parameter is pre-configured in the first apparatus. It should be noted that reference service parameters included in different first group configuration information may be different. This is not specifically limited in this application. For example, the ninth threshold may be 0.8 or 0.9. In an embodiment, for a manner of calculating the similarity between the reference service parameter and the service parameter of the apparatus using the sub-resource corresponding to the first group configuration information, refer to the foregoing manner of calculating the similarity between the environment parameter and the reference environment parameter. For details, refer to the foregoing related descriptions.

The first traffic feature condition means that a similarity between a reference traffic feature and a traffic feature of the apparatus using the sub-resource corresponding to the first group configuration information is greater than or equal to a tenth threshold. For example, the tenth threshold may be 0.8 or 0.9. In an embodiment, for a manner of calculating the similarity between the reference traffic feature and the traffic feature of the apparatus using the sub-resource corresponding to the first group configuration information, refer to the foregoing manner of calculating the similarity between the environment parameter and the reference environment parameter. For details, refer to the foregoing related descriptions.

In an embodiment, the first group configuration information includes the reference traffic feature, or the reference traffic feature is pre-configured in the first apparatus. It should be noted that reference traffic features included in different first group configuration information may be different. This is not specifically limited in this application.

4. One or more first duty cycles, where the one or more first duty cycles correspond to the one or more sub-resources, and each first duty cycle indicates that an apparatus using a sub-resource corresponding to the first duty cycle reports a local parameter of the first model once when the apparatus using the sub-resource corresponding to the first duty cycle receives a global parameter of second model from the second apparatus for N times, where N is an integer greater than or equal to 1.

In an embodiment, in the one or more first duty cycles, different first duty cycles may be different. For example, the one or more sub-resources include a sub-resource 1 and a sub-resource 2. A duty cycle corresponding to the sub-resource 1 is ½, indicating that an apparatus using the sub-resource 1 reports the local parameter of the first model once when the apparatus using the sub-resource 1 receives the global parameter of the second model from the second apparatus twice. A duty cycle corresponding to the sub-resource 2 is ⅓, indicating that an apparatus using the sub-resource 2 reports the local parameter of the first model once when the apparatus using the sub-resource 2 receives the global parameter of the second model from the second apparatus for three times.

In an embodiment, the first transmission resource and the second transmission resource that are configured based on each piece of first configuration information constitute the transmission resource pair. Each piece of second configuration information further includes an index of a transmission resource pair associated with the second configuration information. In this embodiment, the second configuration information may further include the index of the associated transmission resource pair. This helps indicate a configuration manner in which the first transmission resource is configured as one or more sub-resources when the first apparatus performs a task corresponding to the transmission resource pair. In this way, the network device does not need to further indicate the configuration manner, and indication overheads are reduced.

It should be noted that there is no fixed execution sequence between operation 403 and operations 401 and 402. For example, operation 403 may be performed before operation 401 and operation 402; or operation 401 and operation 402 may be performed before operation 403; or operation 401, operation 402, and operation 403 may be simultaneously performed based on a situation. This is not specifically limited in this application.

It should be noted that operation 403 is an embodiment. During actual application, the second apparatus may configure, for the first apparatus in a personalized manner, a configuration manner in which the first transmission resource configured based on each piece of first configuration information is configured as one or more sub-resources, to implement differentiated configuration. For example, the second apparatus has a weak capability, and the second apparatus may configure a small duty cycle for the first apparatus. In this way, a cycle of reporting the local parameter by the first apparatus is increased.

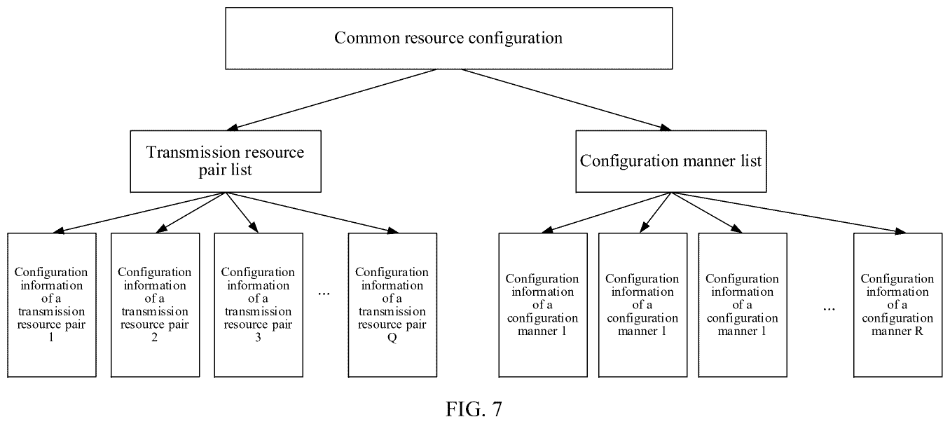

It can be learned that the one or more pieces of first configuration information and the one or more pieces of second configuration information may be understood as a common resource configuration. In a system, the second apparatus may send the resource common configuration to the apparatus that participates in model training of the task corresponding to the one or more pieces of first configuration information. For example, as shown in FIG. 7, a common resource configuration includes a transmission resource pair list and a configuration manner list. The transmission resource pair list includes configuration information of a transmission resource pair 1, configuration information of a transmission resource pair 2, configuration information of a transmission resource pair 3, . . . , and configuration information of a transmission resource pair Q. Q is an integer greater than or equal to 1. The configuration manner list includes configuration information of a configuration manner 1, configuration information of a configuration manner 2, configuration information of a configuration manner 3, . . . , and configuration information of a configuration manner R. R is an integer greater than or equal to 1. For example, the second apparatus may indicate, to the first apparatus, one of the one or more pieces of first configuration information and one of the one or more pieces of second configuration information. A configuration manner indicated by the second configuration information is a configuration manner in which the first transmission resource configured based on the first configuration information is configured as one or more sub-resources. It can be learned that the second apparatus configures the common resource configuration for each apparatus, and no specific configuration information needs to be configured for the apparatus, to reduce configuration overheads. In addition, the second apparatus configures the configuration manner list, to help the second apparatus flexibly schedule and allocate the first transmission resource in each transmission resource pair.

The following describes a configuration mode 2 with reference to operation 404. In an embodiment, the embodiment shown in FIG. 4 further includes operation 404.

404: The second apparatus sends one or more pieces of third configuration information to the first apparatus. Each piece of third configuration information includes configuration information of a sub-resource corresponding to the third configuration information. Correspondingly, the first apparatus receives the one or more pieces of third configuration information from the second apparatus.

A first transmission resource configured based on an M^{th} piece of first configuration information in the one or more pieces of first configuration information includes one or more sub-resources. M is an integer greater than or equal to 1. The one or more pieces of third configuration information correspond to the one or more sub-resources.

In an embodiment, each of the one or more pieces of third configuration information corresponds to one of the one or more sub-resources.

In an embodiment, each piece of third configuration information includes at least one of the following items.

1. Second indication information, where the second indication information indicates a time-frequency position of a sub-resource corresponding to the third configuration information. For example, as shown in FIG. 6, the first transmission resource includes the sub-resource 1, the sub-resource 2, and the sub-resource 3. The third configuration information corresponds to the sub-resource 1. Therefore, the second indication information indicates a time-frequency position of the sub-resource 1. The sub-resource 1 belongs to the first transmission resource configured based on the M^{th} piece of first configuration information. Because a time-frequency position of the first transmission resource is determined, the second indication information may indicate an absolute time-frequency position of the sub-resource 1.

2. Second group configuration information, where the second allocation configuration information includes a condition that is satisfied by an apparatus using the sub-resource corresponding to the third configuration information.

For a task corresponding to the M^{th} piece of first configuration information, the network device may group apparatuses participating in model training of the task into one or more groups. Each group uses a corresponding sub-resource. In an embodiment, the network device groups the apparatuses for the model training corresponding to the task based on environment parameters, dataset parameters, and/or service parameters of the apparatuses. For details about the environment parameter, the dataset parameter, and the service parameter, refer to the foregoing related descriptions. Apparatuses with similar environment parameters, similar dataset parameters, and/or similar service parameters may belong to a same group. Sub-resources used by different groups are also different, to help the network device collect local parameters of the first model that are reported by apparatuses in the different groups. Then, the network device performs weighting processing on the local parameters of the first model that are reported by the apparatuses in the different groups, and performs aggregation processing to obtain a global parameter of the second model. Therefore, the second group configuration information includes the condition that is satisfied by the apparatus using the sub-resource corresponding to the third configuration information.

In an embodiment, the condition that is satisfied by the apparatus using the sub-resource corresponding to the third configuration information includes at least one of the following: a second environment parameter condition, a second dataset parameter condition, a second service parameter condition, or a second traffic feature condition.

The second environment parameter condition is similar to the first environment parameter condition. For details, refer to the foregoing related descriptions of the first environment parameter condition. The second dataset parameter condition is similar to the first dataset parameter condition. For details, refer to the foregoing related descriptions of the first dataset parameter condition. The second service parameter condition is similar to the first service parameter condition. For details, refer to the foregoing related descriptions of the first service parameter condition. The second traffic feature condition is similar to the first traffic feature condition. For details, refer to the foregoing related descriptions of the first traffic feature condition. Details are not described herein.

3. Second duty cycle, where the second duty cycle indicates that the apparatus using the sub-resource corresponding to the third configuration information reports a local parameter of the first model once when the apparatus using the sub-resource corresponding to the third configuration information receives a global parameter of second model from the second apparatus for P times. P is an integer greater than or equal to 1. For the second duty cycle, refer to the foregoing related descriptions of the first duty cycle. Details are not described herein again.

In an embodiment, the first transmission resource and a second transmission resource that are configured based on the M^{th} piece of first configuration information constitute a transmission resource pair. Each piece of third configuration information further includes an index of the transmission resource pair. In this way, the network device indicates, to the terminal device, third configuration information respectively corresponding to one or more sub-resources included in the first transmission resource in the transmission resource pair.

It should be noted that the foregoing embodiment operation 404 merely shows a process in which the network device configures, for the terminal device, the third configuration information respectively corresponding to the one or more sub-resources of the first transmission resource in the M^{th} piece of first configuration information. Actually, the network device may configure corresponding sub-resource configuration information for a sub-resource included in a first transmission resource in each of the one or more pieces of first configuration information.

It should be noted that operation 404 shows a process in which the second apparatus configures the one or more pieces of third configuration information for the first apparatus. The second apparatus further sends the one or more pieces of third configuration information to another apparatus. That is, the second apparatus configures same sub-resource configuration information for different apparatuses. For example, the second apparatus may broadcast or multicast the one or more pieces of third configuration information, to reduce signaling configuration overheads.

It should be noted that operation 404 is an embodiment. During actual application, the second apparatus may configure sub-resource configuration information for the first apparatus in a personalized manner. For example, the second apparatus may configure sub-resource configuration information for the first apparatus with reference to capability information of the first apparatus, to implement differentiated configuration.

It should be noted that there is no fixed execution sequence between operation 404 and operations 401 and 402. For example, operation 404 may be performed before operation 401 and operation 402; or operation 401 and operation 402 may be performed before operation 404; or operation 401, operation 402, and operation 404 may be simultaneously performed based on a situation. This is not specifically limited in this application.

In an embodiment, the embodiment shown in FIG. 4 further includes operation 405.

405: The second apparatus sends one or more pieces of fourth configuration information to the first apparatus. Each piece of fourth configuration information indicates a compute resource. Correspondingly, the first apparatus receives the one or more pieces of fourth configuration information from the second apparatus.

In an embodiment, the compute resource includes at least one of the following: a processor, a processor core, a process, a thread, a storage, occupied time, or a computing instance. In an embodiment, the computing instance is described based on at least one of the processor, the processor core, the process, the thread, the storage, and the occupied time.

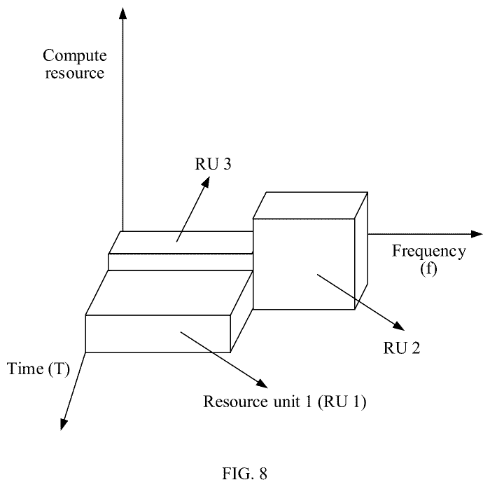

In an embodiment, the one or more pieces of fourth configuration information correspond to the one or more first transmission resources and the one or more second transmission resources that are configured based on the one or more pieces of first configuration information. That is, one piece of fourth configuration information corresponds to a first transmission resource and a second transmission resource that are configured based on one piece of first configuration information, or a compute resource indicated by the fourth configuration information corresponds to the first transmission resource and the second transmission resource that are configured based on the first configuration information. In an embodiment, the first transmission resource and the second transmission resource that are configured based on the first configuration information constitute a transmission resource pair. The compute resource indicated by the fourth configuration information corresponds to the transmission resource pair. In this case, an apparatus participating in model training of a task corresponding to the first configuration information performs model training through the compute resource indicated by the fourth configuration information. For example, as shown in FIG. 8, the second apparatus may form an RU through a compute resource and a time-frequency resource (a first transmission resource and a second transmission resource) corresponding to the compute resource. In this way, the compute resource is quantized by using the RU. Each piece of fourth configuration information may include a quantity of RUs. The quantity of RUs is a quantity of RUs required by the first apparatus to perform model training of a task corresponding to first configuration information corresponding to the fourth configuration information. Therefore, each piece of fourth configuration information includes a size of a compute resource required by the first apparatus to perform model training of the task corresponding to the first configuration information corresponding to the fourth configuration information. A compute resource of the first apparatus is not limited, and is scheduled by the first apparatus.

In an embodiment, each piece of fourth configuration information includes a validation time of the compute resource indicated by the fourth configuration information. For example, the validation time of the compute resource may be an x^{th} slot after a slot in which the first transmission resource configured based on the first configuration information corresponding to the fourth configuration information is located.

In an embodiment, operation 405 shows a process in which the second apparatus configures the one or more pieces of fourth configuration information for the first apparatus. During actual application, the second apparatus further configures the one or more pieces of fourth configuration information for another apparatus. The another apparatus is an apparatus that participates in model training of a task corresponding to the one or more pieces of first configuration information. For example, the second apparatus may broadcast or multicast the one or more pieces of fourth configuration information.

It should be noted that operation 405 is an embodiment. During actual application, the second apparatus may configure compute resource configuration information for the first apparatus in a personalized manner. That is, the second apparatus configures the compute resource configuration information for the first apparatus based on the capability information of the first apparatus, to implement differentiated configuration.

It should be noted that there is no fixed execution sequence between operation 405 and operations 401 and 402. Operation 405 may be performed before operation 401 and operation 402; or operation 401 and operation 402 may be performed before operation 405; or operation 401, operation 402, and operation 405 may be simultaneously performed based on a situation. This is not specifically limited in this application. If the embodiment shown in FIG. 4 further includes operation 403 or operation 404, there is no fixed execution sequence between operation 405 and operation 403 or 404. Operation 403 or operation 404 may be performed before operation 405; or operation 405 may be performed before operation 403 or operation 404; operation 403 and operation 405 or operation 404 and operation 405 are simultaneously performed based on a situation. This is not limited in this application.

In this embodiment of this application, the first apparatus receives the one or more pieces of first configuration information from the second apparatus. Each piece of first configuration information includes the first transmission resource and the second transmission resource. The part or all of the first transmission resource is used by the first apparatus to report the local parameter of the first model to the second apparatus. The second transmission resource is used by the first apparatus to receive the global parameter of the second model from the second apparatus. The first model is the model that is in the first apparatus and that is used to perform a task corresponding to the first configuration information. The second model is the model that is in the second apparatus and that is used to perform the task corresponding to the first configuration information. The first apparatus determines the transmission resources configured based on the one or more pieces of first configuration information. In this way, the second apparatus configures the first transmission resource and the second transmission resource for the first apparatus, so that the first apparatus reports the local parameter through the first transmission resource, and receives the global parameter through the second transmission resource.

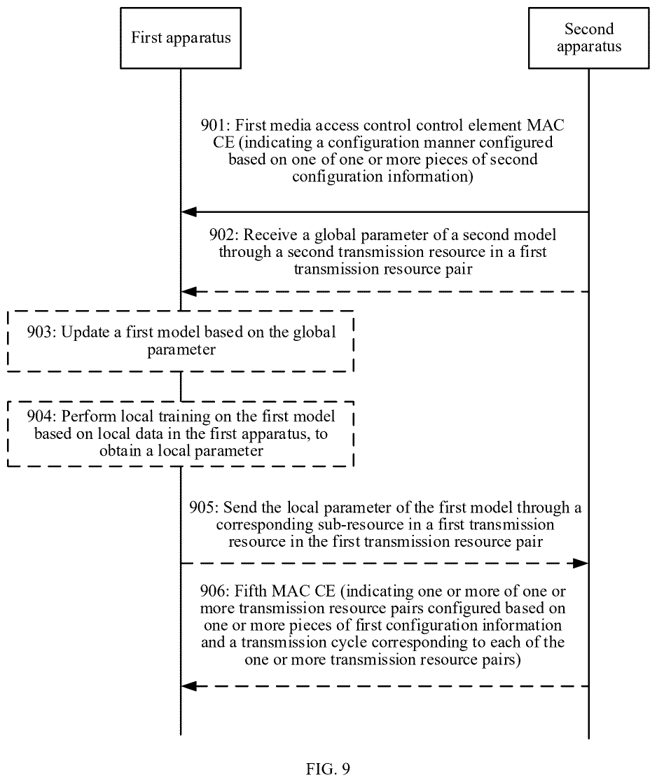

Based on the configuration mode 1 shown in operation 403 in the embodiment shown in FIG. 4, the second apparatus may indicate the configuration manner to the first apparatus in a manner shown in FIG. 9. Descriptions are provided below with reference to the embodiment shown in FIG. 9.

FIG. 9 is a diagram of another embodiment of a resource configuration method according to an embodiment of this application. Refer to FIG. 9. The method includes the following operations.

901: A second apparatus sends a first MAC CE to a first apparatus. The first MAC CE indicates a configuration manner configured based on one of one or more pieces of second configuration information. Correspondingly, the first apparatus receives the first MAC CE from the second apparatus.

In an embodiment, a value of a logical channel identity (LCID) field in the first MAC CE may be a reserved value. As shown in Table 1, it can be learned from a communication protocol that meanings indicated by various values of the LCID field in the MAC CE are shown in Table 1.

TABLE 1

| LCID value | Meaning of the LCID value |
|---|---|
| 0 | Common control channel (CCCH) |
| 1 to 32 | Identity of the logical channel |
| 33 to 46 | Reserved |
| 47 | Recommended bit rate |
| 63 | Padding |

It can be learned from Table 1 that values 33 to 46 of the LCID field are not used and are used as reserved values. Therefore, the value of the LCID field in the first MAC CE may be a reserved value. For example, the value of the LCID field is 46.

For example, as shown in Table 2, the first MAC CE includes a configuration manner identity (configuration Identity) field, and the configuration manner identity field indicates the configuration manner configured based on the second configuration information.

TABLE 2

| | |
|---|---|
| Reserved bit | Logical channel identity (LCID) |
| (R) (1 bit) | (for example, 46) |

Configuration manner identity (configuration Identity) field (8 bits)
. . .

In this embodiment, the first apparatus performs, by default, model training of a task corresponding to a first transmission resource pair. In an embodiment, the configuration manner indicated by the first MAC CE is a configuration manner in which a first transmission resource in the first transmission resource pair is configured as one or more sub-resources.

In an embodiment, a first transmission resource and a second transmission resource that are configured based on each piece of first configuration information constitute a transmission resource pair. The first MAC CE further indicates the first transmission resource pair. The first transmission resource pair is a transmission resource pair configured based on one of one or more pieces of first configuration information. For example, as shown in Table 3, the first MAC CE further includes a transmission resource pair index (ResourcePair_index) field. The transmission resource pair index field indicates an index of the first transmission resource pair.

TABLE 3

| Reserved bit | Logical channel identity |
|---|---|
| (R) (1 bit) | (LCID) (for example, 46) |
| Configuration manner identity | Transmission resource pair index |
| (configuration Identity) field (2 bits) | (ResourcePair_index) (6 bits) |
| . . . | |

It should be noted that the foregoing is described by using an example in which the first MAC CE indicates the index of the first transmission resource pair. During actual application, the first MAC CE may alternatively indicate a first transmission resource and a second transmission resource that are configured based on corresponding first configuration information, instead of indicating the first transmission resource and the second transmission resource based on the transmission resource pair.

In an embodiment, the first MAC CE further includes an FL-RNTI. The FL-RNTI uniquely identifies the task corresponding to the first transmission resource pair. For example, as shown in Table 4, the first MAC CE further includes an FL-RNTI of the task corresponding to the first transmission resource pair.

TABLE 4

| Reserved bit | Logical channel identity |
|---|---|
| (R) (1 bit) | (LCID) (for example, 46) |
| Configuration manner identity | Transmission resource pair index |
| (configuration Identity) (2 bits) | (ResourcePair_index) (5 bits) |

Federated learning radio network temporary identifier (FL-RNTI) (8 bits)
. . .

It should be noted that, based on operation 405 in the embodiment shown in FIG. 4, the first MAC CE further indicates a compute resource indicated by one of the one or more pieces of fourth configuration information. For example, the first MAC CE further includes an identifier of the compute resource. That is, the second apparatus indicates the first apparatus to perform, based on the fourth configuration information, the task corresponding to the first transmission resource pair indicated by the first MAC CE.

In an embodiment, the embodiment shown in FIG. 9 further includes operation 902 to operation 905. Operation 902 to operation 905 may be performed after operation 901.

902: The second apparatus sends a global parameter of a second model to the first apparatus. Correspondingly, the first apparatus receives the global parameter of the second model from the second apparatus through the second transmission resource in the first transmission resource pair.

The first apparatus determines the first transmission resource pair indicated by the first MAC CE. Then, the first apparatus receives the global parameter of the second model from the second apparatus through the second transmission resource in the first transmission resource pair.

903: The first apparatus updates a first model based on the global parameter.

For example, the global parameter is a global weight parameter. The first apparatus updates a weight parameter in the first model based on the global weight parameter.

For another example, the global parameter is a global weight gradient. The first apparatus determines a global weight parameter based on the global weight gradient, and updates the weight parameter in the first model based on the global weight parameter.

904: The first apparatus performs local training on the first model based on local data in the first apparatus, to obtain a local parameter of the first model.

905: The first apparatus sends the local parameter of the first model to the second apparatus through a corresponding sub-resource in the first transmission resource in the first transmission resource pair.

For example, the first apparatus determines the first transmission resource pair indicated by the first MAC CE. The first apparatus determines, based on the second configuration information corresponding to the configuration manner indicated by the first MAC CE, that the first apparatus uses the corresponding sub-resource in the first transmission resource in the first transmission resource pair. For example, the first transmission resource in the first transmission resource pair includes a sub-resource 1 and a sub-resource 2. The second configuration information includes two pieces of first group configuration information, a 1^{st} piece of first allocation configuration information corresponds to the sub-resource 1, and the 1^{st} piece of first group configuration information includes an environment parameter condition 1. The environment parameter condition 1 means that a similarity between a reference environment parameter 1 and an environment parameter of an apparatus using the sub-resource 1 is greater than or equal to a threshold 1. A 2^{nd} piece of first configuration information corresponds to the sub-resource 2, and the 2^{nd} piece of first group configuration information includes an environment parameter condition 2. The environment parameter condition 2 means that a similarity between a reference environment parameter 2 and an environment parameter of an apparatus using the sub-resource 2 is greater than or equal to a threshold 2. When the similarity between the reference environment parameter 1 and an environment parameter of the first apparatus is greater than or equal to the threshold 1, it indicates that the first apparatus uses the sub-resource 1. Therefore, the first apparatus may send the local parameter of the first model to the second apparatus through the sub-resource 1.

In an embodiment, the embodiment shown in FIG. 9 further includes operation 906.

906: The second apparatus sends a fifth MAC CE to the first apparatus. The fifth MAC CE indicates one or more of one or more transmission resource pairs configured based on the one or more pieces of first configuration information and a transmission cycle corresponding to each of the one or more transmission resource pairs. Correspondingly, the first apparatus receives the fifth MAC CE from the second apparatus.

The transmission cycle corresponding to each of the one or more transmission resource pairs is an updated transmission cycle of each of the one or more transmission resource pairs indicated by the second apparatus to the first apparatus. For example, as shown in Table 5, the fifth MAC CE includes a transmission resource pair index and an updated cycle field. The transmission resource pair index indicates a corresponding transmission resource pair, and the updated cycle field indicates an updated transmission cycle of the transmission resource pair. In this way, the second apparatus updates a configuration of the one or more transmission resource pairs.

TABLE 5

| Reserved bit | Logical channel identity |
|---|---|
| (R) (1 bit) | (LCID) (for example, 46) |
| Transmission resource pair index | Update cycle |
| (ResourcePair_index) (3 bits) | (Updated_Cycles) (5 bits) |

It should be noted that operation 906 is described by using an example in which the second apparatus updates the transmission cycle corresponding to the one or more transmission resource pairs. The second apparatus may further update another configuration of the one or more transmission resource pairs based on the fifth MAC CE. This is not specifically limited in this application.

It should be noted that the foregoing is described by using an example in which the fifth MAC CE indicates an index of a transmission resource pair and a transmission cycle of the transmission resource pair. During actual application, the fifth MAC CE may alternatively indicate a first transmission resource and a second transmission resource that are configured based on corresponding first configuration information, a transmission cycle of the first transmission resource, and a transmission cycle of the second transmission resource, instead of indicating the first transmission resource and the second transmission resource by indicating a transmission resource pair.

There is no fixed execution sequence between operation 906 and operation 901 to operation 905. Operation 901 to operation 905 may be performed before operation 906; operation 906 may be performed before operation 901 to operation 905; or operation 901 to operation 905 and operation 906 are simultaneously performed based on a situation. This is not specifically limited in this application.

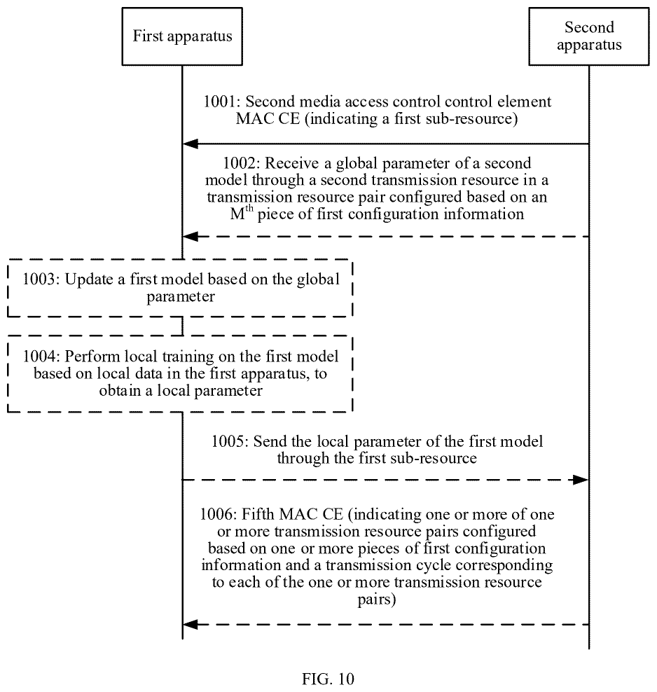

Based on the configuration mode 2 shown in operation 404 in the embodiment shown in FIG. 4, the second apparatus may indicate the sub-resource to the first apparatus in a manner shown in FIG. 10. Descriptions are provided below with reference to the embodiment shown in FIG. 10.

FIG. 10 is a diagram of another embodiment of a resource configuration method according to an embodiment of this application. Refer to FIG. 10. The method includes the following operations.

1001: A second apparatus sends a second MAC CE to a first apparatus. The second MAC CE indicates a first sub-resource. Correspondingly, the first apparatus receives the second MAC CE from the second apparatus.

The first sub-resource is one of one or more sub-resources included in a first transmission resource in an M^{th} piece of first configuration information. For example, as shown in Table 6, the second MAC CE includes an LCID field and a sub-resource identifier field. A value of an LCID value is 46. The sub-resource identifier field indicates an identifier of the first sub-resource.

TABLE 6

| | |
|---|---|
| Reserved bit | Logical channel identity |
| (R) (1 bit) | (LCID) (for example, 46) |

Sub-resource identifier (SubResourceID) (8 bits)

In an embodiment, the first transmission resource and the second transmission resource that are configured based on the M^{th} piece of first configuration information constitute a transmission resource pair. The second MAC CE further indicates the transmission resource pair. For example, as shown in Table 7, the second MAC CE includes the LCID field, the sub-resource identifier field, and a transmission resource pair index field. The value of the LCID field is 46. The sub-resource identifier field indicates an identifier of the first sub-resource. The transmission resource pair index field indicates an index of the transmission resource pair including the first transmission resource and the second transmission resource that are configured based on the M^{th} piece of first configuration information.

TABLE 7

| Reserved bit | Logical channel identity |
|---|---|
| (R) (1 bit) | (LCID) (for example, 46) |
| Sub-resource identifier | Transmission resource pair index |
| (SubResourceID) (2 bits) | (ResourcePair_index) (6 bits) |

It should be noted that the foregoing is described by using an example in which the second MAC CE indicates the transmission resource pair. During actual application, the second MAC CE may alternatively indicate the first transmission resource and the second transmission resource that are configured based on the M^{th} piece of first configuration information, instead of indicating the first transmission resource and the second transmission resource by indicating the transmission resource pair.

In an embodiment, the second MAC CE further includes an FL-RNTI. The FL-RNTI uniquely identifies a task corresponding to the M^{th} piece of first configuration information. For example, as shown in Table 8, the second MAC CE further includes an FL-RNTI of the task corresponding to the M^{th} piece of first configuration information.

TABLE 8

| Reserved bit | Logical channel identity (LCID) |
|---|---|
| (R) (1 bit) | (for example, 46) |
| Sub-resource identifier | Transmission resource pair index |
| (SubResourceID) (2 bits) | (ResourcePair_index) (5 bits) |

Federated learning radio network temporary identifier (FL-RNTI) (8 bits)
. . .

It should be noted that, based on operation 405 in the embodiment shown in FIG. 4, the second MAC CE further indicates a compute resource indicated by one of the one or more pieces of fourth configuration information. For example, the second MAC CE further includes an identifier of the compute resource. That is, the second apparatus indicates the first apparatus to perform, based on the compute resource indicated by the fourth configuration information, model training of the task corresponding to the transmission resource pair indicated by the second MAC CE.

In an embodiment, the embodiment shown in FIG. 10 further includes operation 1002 to operation 1005. Operation 1002 to operation 1005 may be performed after operation 1001.

1002: The second apparatus sends a global parameter of a second model to the first apparatus. Correspondingly, the first apparatus receives the global parameter of the second model from the second apparatus through the second transmission resource in the transmission resource pair configured based on the M^{th} piece of first configuration information.

The first apparatus determines the transmission resource pair indicated by the second MAC CE. Then, the first apparatus receives the global parameter of the second model from the second apparatus through the second transmission resource in the transmission resource pair.

1003: The first apparatus updates a first model based on the global parameter.

1004: The first apparatus performs local training on the first model based on local data in the first apparatus, to obtain a local parameter.

Operation 1003 and operation 1004 are similar to operation 904 and operation 905 in the embodiment shown in FIG. 9. For details, refer to the related descriptions of operation 904 and operation 905 in the embodiment shown in FIG. 9. Details are not described herein again.

1005: The first apparatus sends the local parameter of the first model to the second apparatus through the first sub-resource. Correspondingly, the second apparatus receives the local parameter of the first model from the first apparatus.

In an embodiment, the first apparatus determines the first sub-resource based on the second MAC CE. Then, the first apparatus sends the local parameter of the first model to the second apparatus through the first sub-resource.

In an embodiment, the embodiment shown in FIG. 10 further includes operation 1006.

1006: The second apparatus sends a fifth MAC CE to the first apparatus. The fifth MAC CE indicates one or more of one or more transmission resource pairs configured based on one or more pieces of first configuration information and a transmission cycle corresponding to each of the one or more transmission resource pairs. Correspondingly, the first apparatus receives the fifth MAC CE from the second apparatus.

Operation 1006 is similar to operation 906 in the embodiment shown in FIG. 9. For details, refer to the related descriptions of operation 906 in the embodiment shown in FIG. 9. Details are not described herein again.

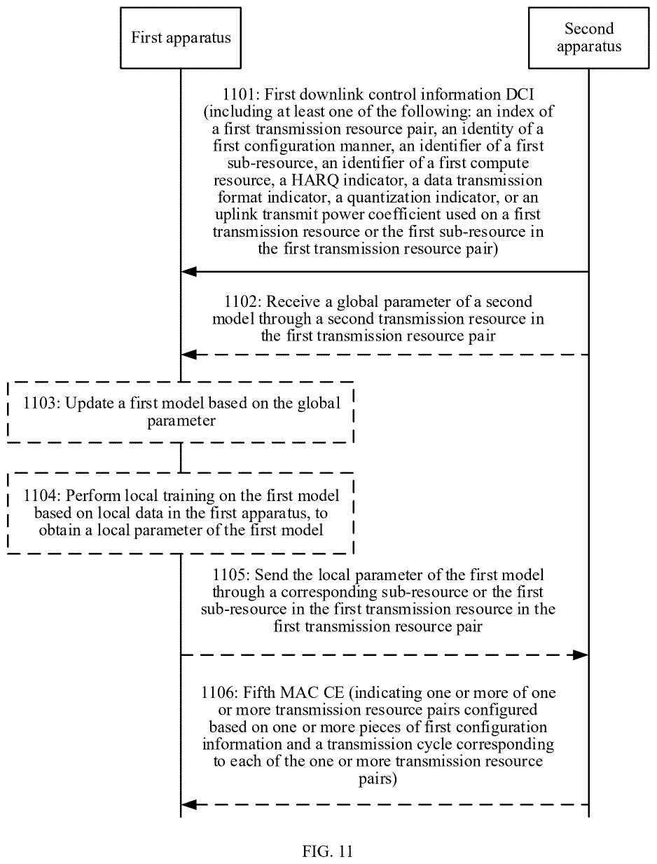

FIG. 11 is a diagram of another embodiment of a resource configuration method according to an embodiment of this application. Refer to FIG. 11. The method includes the following operations.

1101: A second apparatus sends first DCI to a first apparatus. The first DCI includes at least one of the following: an index of a first transmission resource pair, an identity of a first configuration manner, an identifier of a first sub-resource, an identifier of a first compute resource, a HARQ indicator, a data transmission format indicator, a quantization indicator, or an uplink transmit power coefficient used on a first transmission resource or the first sub-resource in the first transmission resource pair. Correspondingly, the first apparatus receives the first DCI from the second apparatus.

A first transmission resource and a second transmission resource that are configured based on each piece of first configuration information constitute a transmission resource pair. The first transmission resource pair is a transmission resource pair configured based on one of the one or more pieces of first configuration information. The first configuration manner is a configuration manner configured based on one of one or more pieces of second configuration information. The first sub-resource is a sub-resource configured based on one of one or more pieces of third configuration information. The first compute resource is a compute resource configured based on one of one or more pieces of fourth configuration information. The HARQ indicator indicates whether a local parameter transmitted on the first transmission resource included in the first transmission resource pair supports a HARQ and whether a global parameter transmitted on a second transmission resource included in the first transmission resource pair supports the HARQ. The quantization indicator indicates quantization precision of the local parameter transmitted on the first transmission resource included in the first transmission resource pair and quantization precision of the global parameter transmitted on the second transmission resource included in the first transmission resource pair.

The following describes some embodiments of the first DCI.

Embodiment 1: Based on operation 401 and operation 402, the first DCI includes at least one of the following: the index of the first transmission resource pair, the HARQ indicator, the data transmission format indicator, the quantization indicator, or the uplink transmit power coefficient used on the first transmission resource in the first transmission resource pair.

Embodiment 2: Based on operation 401 to operation 403, the first DCI includes at least one of the following: the index of the first transmission resource pair, the identity of the first configuration manner, the HARQ indicator, the data transmission format indicator, the quantization indicator, or the uplink transmit power coefficient used on the first transmission resource in the first transmission resource pair.

In this embodiment, the uplink transmit power coefficient used on the first transmission resource in the first transmission resource pair is an uplink transmit power coefficient used by the first apparatus on a corresponding sub-resource in the first transmission resource in the first transmission resource pair. In an embodiment, the first apparatus may determine, with reference to the second configuration information for configuring the first configuration manner, the sub-resource used by the first apparatus.

Embodiment 3: Based on operation 401, operation 402, and operation 404, the first DCI includes at least one of the following: the index of the first transmission resource pair, the identifier of the first sub-resource, the HARQ indicator, the data transmission format indicator, the quantization indicator, or the uplink transmit power coefficient used on the first sub-resource in the first transmission resource in the first transmission resource pair.

In this embodiment, the first sub-resource is one or more sub-resources included in the first transmission resource in the first transmission resource pair.

In the foregoing embodiments, based on operation 403, In an embodiment, the first DCI further includes the identifier of the first compute resource. The first compute resource corresponds to one of the one or more pieces of fourth configuration information. In this way, the second apparatus indicates the first apparatus to perform, based on the first compute resource indicated by the fourth configuration information, model training of a task corresponding to the first transmission resource pair.

In the foregoing embodiments, In an embodiment, the first DCI is generated through scrambling with a common RNTI. In this embodiment, the first DCI includes the index of the first transmission resource pair, so that the first apparatus determines that the second apparatus indicates the first apparatus to perform model training of a task corresponding to the first transmission resource pair.

In the foregoing embodiments, In an embodiment, the first DCI is generated through scrambling with an FL-RNTI. The FL-RNTI identifies the task corresponding to the first transmission resource pair. In this embodiment, the first DCI may not include the index of the first transmission resource pair. The first apparatus may identify, based on the FL-RNTI, the task corresponding to the first transmission resource pair, so that the first apparatus determines that the second apparatus indicates the first apparatus to perform model training of the task corresponding to the first transmission resource pair.

It should be noted that the foregoing is described by using an example in which the first DCI indicates the index of the first transmission resource pair. During actual application, the first DCI may alternatively indicate the first transmission resource and the second transmission resource, instead of indicating the first transmission resource and the second transmission resource based on the transmission resource pair.

In an embodiment, the embodiment shown in FIG. 11 further includes operation 1102 to operation 1105. Operation 1102 to operation 1105 may be performed after operation 1101.

1102: The second apparatus sends a global parameter of a second model to the first apparatus. Correspondingly, the first apparatus receives the global parameter of the second model from the second apparatus through the second transmission resource in the first transmission resource pair.

1103: The first apparatus updates a first model based on the global parameter.

1104: The first apparatus performs local training on the first model based on local data in the first apparatus, to obtain a local parameter of the first model.

Operation 1103 and operation 1104 are similar to operation 904 and operation 905 in the embodiment shown in FIG. 9. For details, refer to the related descriptions of operation 904 and operation 905 in the embodiment shown in FIG. 9. Details are not described herein again.

1105: The first apparatus sends the local parameter of the first model to the second apparatus through the first transmission resource in the first transmission resource pair or through the corresponding sub-resource or the first sub-resource in the first transmission resource in the first transmission resource pair. Correspondingly, the second apparatus receives the local parameter of the first model from the first apparatus.

For example, based on Embodiment 1 of the first DCI, the first apparatus determines the first transmission resource pair based on the first DCI. Then, the first apparatus sends the local parameter of the first model to the second apparatus through the first transmission resource in the first transmission resource pair. In an embodiment, the first apparatus determines the first compute resource based on the first DCI. The first apparatus trains the first model through the first compute resource, to obtain the local parameter of the first model.

For another example, based on Embodiment 2 of the first DCI, the first apparatus determines the first transmission resource pair and the first configuration manner based on the first DCI. Then, the first apparatus determines, based on the second configuration information for configuring the first configuration manner, that the first apparatus uses the corresponding sub-resource in the first transmission resource. The first apparatus sends the local parameter of the first model to the second apparatus through the corresponding sub-resource in the first transmission resource pair. In an embodiment, the first apparatus determines the first compute resource based on the first DCI. The first apparatus trains the first model through the first compute resource, to obtain the local parameter of the first model.

For another example, based on Embodiment 3 of the first DCI, the first apparatus determines, based on the first DCI, the first transmission resource pair and the first sub-resource in the first transmission resource in the first transmission resource pair. Then, the first apparatus sends the local parameter of the first model to the second apparatus through the first sub-resource. In an embodiment, the first apparatus determines the first compute resource based on the first DCI. The first apparatus trains the first model through the first compute resource, to obtain the local parameter of the first model.

In an embodiment, the embodiment shown in FIG. 11 further includes operation 1106.

1106: The second apparatus sends a fifth MAC CE to the first apparatus. The fifth MAC CE indicates one or more of one or more transmission resource pairs configured based on one or more pieces of first configuration information and a transmission cycle corresponding to each of the one or more transmission resource pairs. Correspondingly, the first apparatus receives the fifth MAC CE from the second apparatus.

Operation 1106 is similar to operation 906 in the embodiment shown in FIG. 9. For details, refer to the related descriptions of operation 906 in the embodiment shown in FIG. 9. Details are not described herein again.

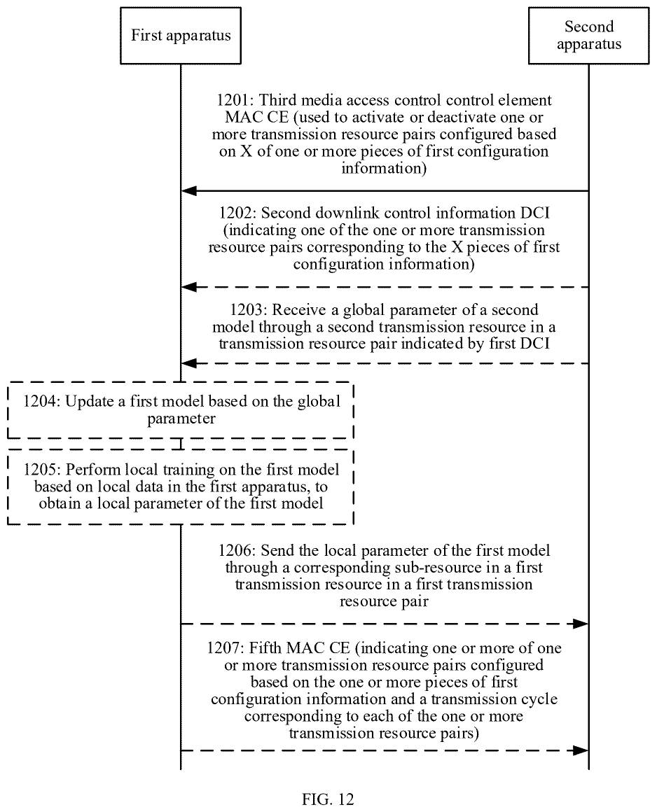

FIG. 12 is a diagram of another embodiment of a resource configuration method according to an embodiment of this application. Refer to FIG. 12. The method includes the following operations.

1201: A second apparatus sends a third MAC CE to a first apparatus. The third MAC CE is used to activate or deactivate one or more transmission resource pairs configured based on X of one or more pieces of first configuration information. Correspondingly, the first apparatus receives the third MAC CE from the second apparatus.

X is an integer greater than or equal to 1.

In an embodiment, the third MAC CE further includes activation time or deactivation time. The activation time is activation time of the one or more transmission resource pairs configured based on the X pieces of first configuration information. The deactivation time is deactivation time of the one or more transmission resource pairs configured based on the X pieces of first configuration information.

In an embodiment, the third MAC CE further indicates a configuration manner corresponding to each of the one or more transmission resource pairs configured based on the X pieces of first configuration information. For example, as shown in Table 9, an example in which the third MAC CE is used to activate the one or more transmission resource pairs configured based on the X pieces of first configuration information is used. The third MAC CE may be represented as:

TABLE 9

| | | |
|---|---|---|
| Reserved bit | F (0, indicating a | Logical channel identity |
| (R) (1 bit) | length of 8 bits) | (LCID) (for example, 46) |

L (8 bits)

| | |
|---|---|
| Transmission resource | Configuration manner 1 |
| pair index 1 | (configuration |
| (ResourcePair_index 1) | Identity 1) (5 bits) |
| (3 bits) | |

Activation time 1 (activation-timer1) (8 bits)

| | |
|---|---|
| Transmission resource | Configuration manner 2 |
| pair index 2 | (configuration |
| (ResourcePair_index 2) | Identity 2) (5 bits) |
| (3 bits) | |

Activation time 2 (activation-timer2) (8 bits)
. . .

The F field in the third MAC CE indicates the length of the L field. For example, a value of the F field is 0, indicating that the length of the L field is 8 bits. The value of the F field is 1, indicating that the length of the L field is 16 bits. The L field indicates a total length of a field after the L field.

In an embodiment, the third MAC CE further indicates the first apparatus to use a sub-resource in a first transmission resource in each of the one or more transmission resource pairs configured based on the X pieces of first configuration information. For example, as shown in Table 10, an example in which the third MAC CE is used to activate the one or more transmission resource pairs configured based on the X pieces of first configuration information is used. The third MAC CE may be represented as:

TABLE 10

| | | |
|---|---|---|
| | F (0, indicating | |
| Reserved bit (R) | a length of 8 | Logical channel identity |
| (1 bit) | bits) | (LCID) (for example, 46) |

L (8 bits)

| | |
|---|---|
| Transmission resource | Sub-resource identifier 1 |
| pair index 1 | (SubResourceID1) (5 bits) |
| (ResourcePair_index 1) (3 bits) | |

Activation time 1 (activation-timer1) (8 bits)

| | |
|---|---|
| Transmission resource | Sub-resource identifier 2 |
| pair index 2 | (SubResourceID2) (5 bits) |
| (ResourcePair_index 2) (3 bits) | |

Activation time 2 (activation-timer2) (8 bits)
. . .

In an embodiment, the third MAC CE is further configured to activate or deactivate a compute resource corresponding to each of the one or more transmission resource pairs configured based on the X pieces of first configuration information. For example, the third MAC CE further includes an identifier of the compute resource corresponding to each of the one or more transmission resource pairs configured based on the X pieces of first configuration information.

In an embodiment, the embodiment shown in FIG. 12 further includes operation 1202. Operation 1202 may be performed after operation 1201.

1202: The second apparatus sends second DCI to the first apparatus. The second DCI indicates one of the one or more transmission resource pairs corresponding to the X pieces of first configuration information.

In an embodiment, the second DCI includes an index of the transmission resource pair indicated by the second apparatus to the first apparatus. In this embodiment, the second DCI may be generated through scrambling with a common RNTI.

In an embodiment, the second DCI is scrambled with an FL-RNTI. The FL-RNTI identifies a task corresponding to the transmission resource pair. In this embodiment, the second DCI may not include the index of the transmission resource pair, but indicate the transmission resource pair through the FL-RNTI.

In an embodiment, the embodiment shown in FIG. 12 further includes operation 1203 to operation 1206. Operation 1203 to operation 1206 may be performed after operation 1202.

1203: The second apparatus sends a global parameter of a second model to the first apparatus. Correspondingly, the first apparatus receives the global parameter of the second model from the second apparatus through a second transmission resource in the transmission resource pair indicated by the first DCI.

1204: The first apparatus updates a first model based on the global parameter.

1205: The first apparatus performs local training on the first model based on local data in the first apparatus, to obtain a local parameter of the first model.

Operation 1204 and operation 1205 are similar to operation 904 and operation 905 in the embodiment shown in FIG. 9. For details, refer to the related descriptions of operation 904 and operation 905 in the embodiment shown in FIG. 9. Details are not described herein again.

1206: The first apparatus sends the local parameter of the first model to the second apparatus through a first transmission resource in a first transmission resource pair or through a corresponding sub-resource in the first transmission resource in the first transmission resource pair. Correspondingly, the second apparatus receives the local parameter of the first model from the first apparatus.

In an embodiment, the first apparatus performs, through a compute resource corresponding to the first transmission resource pair activated by a first MAC CE, model training of a task corresponding to the first transmission resource pair. That is, the first apparatus trains the first model.

In an embodiment, the embodiment shown in FIG. 12 further includes operation 1207.

1207: The second apparatus sends a fifth MAC CE to the first apparatus. The fifth MAC CE indicates one or more of one or more transmission resource pairs configured based on the one or more pieces of first configuration information and a transmission cycle corresponding to each of the one or more transmission resource pairs. Correspondingly, the first apparatus receives the fifth MAC CE from the second apparatus.

Operation 1207 is similar to operation 906 in the embodiment shown in FIG. 9. For details, refer to the related descriptions of operation 906 in the embodiment shown in FIG. 9. Details are not described herein again.

It should be noted that there is no fixed execution sequence between operation 1207 and operation 1201 to operation 1206. Operation 1207 may be performed before operation 1201 to operation 1206; or operation 1201 to operation 1206 may be performed before operation 1207; or operation 1201 to operation 1206 and operation 1207 may be simultaneously performed based on a situation. This is not specifically limited in this application.

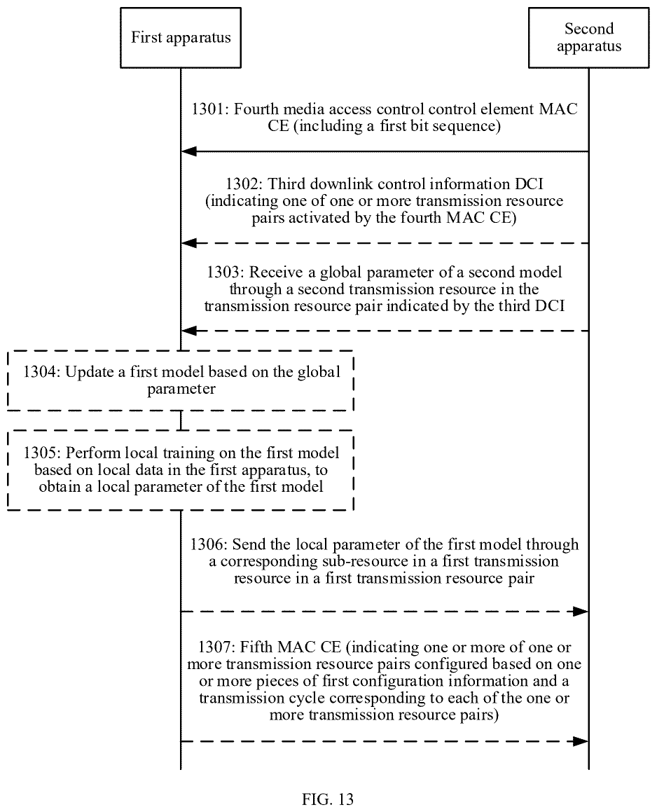

FIG. 13 is a diagram of still another embodiment of a resource configuration method according to an embodiment of this application. Refer to FIG. 13. The method includes the following operations.

1301: A second apparatus sends a fourth MAC CE to a first apparatus. The fourth MAC CE includes a first bit sequence. Correspondingly, the first apparatus receives the fourth MAC CE from the second apparatus.

In an embodiment, a bit in the first bit sequence corresponds to a transmission resource pair configured based on one or more pieces of first configuration information. The first bit sequence indicates whether to activate a transmission resource pair corresponding to the bit.

For example, one bit in the first bit sequence corresponds to one transmission resource pair, and different bits correspond to different transmission resource pairs. For example, if a value of one bit in the first bit sequence is 1, it indicates to activate a transmission resource pair corresponding to the bit; and if the value of the bit in the first bit sequence is 0, it indicates not to activate a transmission resource pair corresponding to the bit. For another example, if a value of one bit in the first bit sequence is 0, it indicates to activate a transmission resource pair corresponding to the bit; and if the value of the bit in the first bit sequence is 1, it indicates not to activate a transmission resource pair corresponding to the bit.

The following shows a format of the fourth MAC CE, as shown in Table 11.

TABLE 11

| Reserved | | | | | | | |
|---|---|---|---|---|---|---|---|
| bit | | | | | | | |
| (R) | Logical channel identity (LCID) | | | | | | |
| (1 bit) | (for example, 46) | | | | | | |
| Index 1 | In- | In- | In- | In- | In- | In- | In- |
| | dex 2 | dex 3 | dex 4 | dex 5 | dex 6 | dex 7 | dex 8 |

The fourth MAC CE corresponds to an index of the transmission resource pair by using a bit. As shown in Table 11, a 1^{st} bit in a second byte in a fourth MAC CE corresponds to a transmission resource pair with the index 1, a 2^{nd} bit in the second byte corresponds to a transmission resource pair with the index 2, a 3^{rd} bit in the second byte corresponds to a transmission resource pair with the index 3, a 4^{th} bit in the second byte corresponds to a transmission resource pair with the index 4, a 5^{th} bit in the second byte corresponds to a transmission resource pair with the index 5, a 6^{th} bit in the second byte corresponds to a transmission resource pair with the index 6, a 7^{th} bit in the second byte corresponds to a transmission resource pair with the index 7, and an 8^{th} bit in the second byte corresponds to a transmission resource pair with the index 8.

In an embodiment, based on the foregoing operation 403, the fourth MAC CE further indicates a configuration manner in which each first transmission resource in the transmission resource pair activated by the fourth MAC CE is configured as one or more sub-resources. For example, the fourth MAC CE includes an identity of a configuration manner in which a first transmission resource in each activated transmission resource pair is configured as one or more sub-resources.

In another embodiment, based on the foregoing operation 404, the fourth MAC CE further indicates the first apparatus to use a corresponding sub-resource in the first transmission resource in each activated transmission resource pair. For example, the fourth MAC CE includes an identifier of one or more sub-resources in the first transmission resource in each activated transmission resource pair.

In an embodiment, the fourth MAC CE is further used to activate or deactivate a compute resource corresponding to each of the one or more transmission resource pairs configured based on the one or more pieces of first configuration information. For example, the fourth MAC CE further includes a second bit sequence. A bit in the second bit sequence corresponds to the compute resource corresponding to each of the one or more transmission resource pairs configured based on the one or more pieces of first configuration information. The first bit sequence indicates whether to activate a compute resource corresponding to the bit. The second bit sequence is similar to the first bit sequence. For details, refer to the foregoing related descriptions of the first bit sequence.

In an embodiment, the embodiment shown in FIG. 13 further includes operation 1302. Operation 1302 may be performed after operation 1301.

1302: The second apparatus sends third DCI to the first apparatus. The third DCI indicates one of one or more transmission resource pairs activated by the fourth MAC CE. Correspondingly, the first apparatus receives the third DCI from the second apparatus.

In an embodiment, the third DCI includes an index of the transmission resource pair indicated by the second apparatus to the first apparatus. In this embodiment, the third DCI may be generated through scrambling with a common RNTI.

In an embodiment, the third DCI is scrambled with an FL-RNTI. The FL-RNTI identifies a task corresponding to the transmission resource pair. In this embodiment, the third DCI may not include the index of the transmission resource pair, but identify the transmission resource pair through the FL-RNTI.

In an embodiment, the third DCI further includes an identifier of the compute resource corresponding to the transmission resource pair.

In an embodiment, the embodiment shown in FIG. 13 further includes operation 1303 to operation 1306. Operation 1303 to operation 1306 may be performed after operation 1302.

1303: The second apparatus sends a global parameter of a second model to the first apparatus. Correspondingly, the first apparatus receives the global parameter of the second model from the second apparatus through a second transmission resource in the transmission resource pair indicated by the third DCI.

1304: The first apparatus updates a first model based on the global parameter.

1305: The first apparatus performs local training on the first model based on local data in the first apparatus, to obtain a local parameter of the first model.

Operation 1304 and operation 1305 are similar to operation 904 and operation 905 in the embodiment shown in FIG. 9. For details, refer to the related descriptions of operation 904 and operation 905 in the embodiment shown in FIG. 9. Details are not described herein again.

1306: The first apparatus sends the local parameter of the first model to the second apparatus through a first transmission resource in a first transmission resource pair or through a corresponding sub-resource in the first transmission resource. Correspondingly, the second apparatus receives the local parameter of the first model from the first apparatus.

In an embodiment, the first apparatus performs, through a compute resource corresponding to the first transmission resource pair activated by a first MAC CE, model training of a task corresponding to the first transmission resource pair. That is, the first apparatus trains the first model.

In an embodiment, the embodiment shown in FIG. 13 further includes operation 1307.

1307: The second apparatus sends a fifth MAC CE to the first apparatus. The fifth MAC CE indicates one or more of one or more transmission resource pairs configured based on one or more pieces of first configuration information and a transmission cycle corresponding to each of the one or more transmission resource pairs. Correspondingly, the first apparatus receives the fifth MAC CE from the second apparatus.

Operation 1307 is similar to operation 906 in the embodiment shown in FIG. 9. For details, refer to the related descriptions of operation 906 in the embodiment shown in FIG. 9. Details are not described herein again.

There is no fixed execution sequence between operation 1307 and operation 1301 to operation 1306. Operation 1307 may be performed before operation 1301 to operation 1306; or operation 1301 to operation 1306 may be performed before operation 1307; or operation 1301 to operation 1306 and operation 1307 may be simultaneously performed based on a situation. This is not specifically limited in this application.

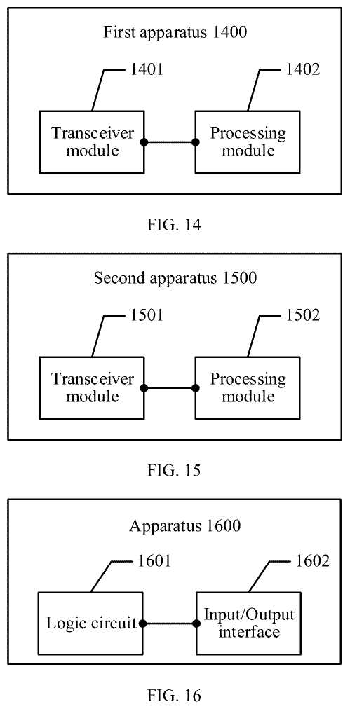

The first apparatus provided in embodiments of this application is described below. FIG. 14 is a diagram of a structure of a first apparatus according to an embodiment of this application. The first apparatus 1400 may be configured to perform operations performed by the first apparatus in any one of the embodiments shown in FIG. 4 and FIG. 9 to FIG. 13. For details, refer to the related descriptions of the foregoing method embodiments. The first apparatus 1400 includes a transceiver module 1401 and a processing module 1402.

The transceiver module 1401 is configured to receive one or more pieces of first configuration information from a second apparatus. Each piece of first configuration information is used to configure a first transmission resource and a second transmission resource. A part or all of the first transmission resource is used by the first apparatus 1400 to report a local parameter of a first model to the second apparatus. The second transmission resource is used by the first apparatus 1400 to receive a global parameter of a second model from the second apparatus. The first model is a model that is in the first apparatus 1400 and that is used to perform a task corresponding to the first configuration information. The second model is a model that is in the second apparatus and that is used to perform the task corresponding to the first configuration information.

The processing module 1402 is configured to determine transmission resources configured based on the one or more pieces of first configuration information.

In an embodiment, each piece of first configuration information includes at least one of the following: a frequency domain position, a time domain position, or a time domain periodicity that is occupied by the second transmission resource; a data transmission format of the global parameter; a switching condition of the data transmission format of the global parameter; whether a HARQ is supported for transmission of the global parameter; a start condition for enabling the HARQ for the transmission of the global parameter; a frequency domain position, a time domain position, or a time domain periodicity that is occupied by the first transmission resource; a data transmission format of the local parameter; a switching condition of the data transmission format of the local parameter; whether the HARQ is supported for transmission of the local parameter; a start condition for enabling the HARQ for the transmission of the local parameter; an offset of the first transmission resource relative to the second transmission resource in time domain and/or frequency domain; or activation duration. The activation duration indicates that the first apparatus 1400 completes receiving of the global parameter and reporting of the local parameter within the activation duration.

In another embodiment, the switching condition of the data transmission format of the global parameter includes: a quantity of rounds of training performed by the second apparatus on the second model is greater than or equal to a first threshold, or inference precision of a second model obtained by the second apparatus by performing an i^{th} round of training on the second model based on an i^{th} round of local parameter that is of the first model and that is reported by the first apparatus 1400 is greater than or equal to a second threshold, where i is an integer greater than or equal to 1.

In another embodiment, the switching condition of the data transmission format of the local parameter includes: a quantity of rounds of training performed by the first apparatus 1400 on the first model is greater than or equal to a third threshold, or inference precision of a first model obtained by the first apparatus 1400 by performing an i^{th} round of training on the first model based on an i^{th} round of global parameter that is of the second model and that is sent by the second apparatus to the first apparatus 1400 is greater than or equal to a fourth threshold, where i is an integer greater than or equal to 1.

In another embodiment, the start condition for enabling the HARQ for the transmission of the global parameter includes: the quantity of rounds of training performed by the second apparatus on the second model is greater than or equal to the first threshold; or the inference precision of the second model obtained by the second apparatus by performing the i^{th} round of training on the second model based on the i^{th} round of local parameter that is of the first model and that is reported by the first apparatus 1400 is greater than or equal to the second threshold, where i is an integer greater than or equal to 1; or a correlation coefficient between the i^{th} round of global parameter and an (i+1)^{th} round of global parameter is greater than or equal to a fifth threshold, the i^{th} round of global parameter is a global parameter obtained by the second apparatus by performing the i^{th} round of training on the second model, and the (i+1)^{th} round of global parameter is a global parameter obtained by the second apparatus by performing an (i+1)^{th} round of training on the second model.

In another embodiment, the start condition for enabling the HARQ for the transmission of the local parameter includes: the quantity of rounds of training performed by the first apparatus 1400 on the first model is greater than or equal to the third threshold; or the inference precision of the first model obtained by the first apparatus 1400 by performing the i^{th} round of training on the first model based on the i^{th} round of global parameter that is of the second model and that is reported by the second apparatus is greater than or equal to the third threshold, where i is an integer greater than or equal to 1; or a correlation coefficient between an i^{th} round of local parameter and an (i+1)^{th} round of local parameter is greater than or equal to a sixth threshold, the i^{th} round of local parameter is a local parameter obtained by the first apparatus 1400 by performing the i^{th} round of training on the first model, and the (i+1)^{th} round of local parameter is a local parameter obtained by the first apparatus 1400 by performing an (i+1)^{th} round of training on the first model.

In another embodiment, the first transmission resource includes one or more sub-resources. The transceiver module 1401 is configured to receive one or more pieces of second configuration information from the second apparatus. Each piece of second configuration information is used to configure a configuration manner in which the first transmission resource is configured as the one or more sub-resources.

In another embodiment, each piece of second configuration information includes at least one of the following: an identity of the configuration manner; first indication information, where the first indication information indicates a time-frequency position of each of the one or more sub-resources; one or more pieces of first group configuration information, where the one or more pieces of first group configuration information correspond to the one or more sub-resources, and each piece of first group configuration information includes a condition that is satisfied by an apparatus using a sub-resource corresponding to the first group configuration information; or one or more first duty cycles, where the one or more first duty cycles correspond to the one or more sub-resources, and each first duty cycle indicates that an apparatus using a sub-resource corresponding to the first duty cycle reports a local parameter of the first model once when the apparatus using the sub-resource corresponding to the first duty cycle receives a global parameter of the second model from the second apparatus for N times, where N is an integer greater than or equal to 1.

In another embodiment, the first transmission resource and the second transmission resource that are configured based on each piece of first configuration information constitute a transmission resource pair. Each piece of second configuration information further includes an index of a transmission resource pair associated with the second configuration information.

In another embodiment, a condition that is satisfied by the apparatus of the sub-resource corresponding to each piece of first group configuration information includes at least one of the following: a first environment parameter condition, a first dataset parameter condition, a first service parameter condition, or a first traffic feature condition. The first environment parameter condition means that a similarity between a reference environment parameter and an environment parameter of the apparatus using the sub-resource corresponding to the first group configuration information is greater than or equal to a seventh threshold. The first dataset parameter condition means that a similarity between a reference dataset parameter and a dataset parameter of the apparatus using the sub-resource corresponding to the first group configuration information is greater than or equal to an eighth threshold. The first service parameter condition means that a similarity between a reference service parameter and a service parameter of the apparatus using the sub-resource corresponding to the first group configuration information is greater than or equal to a ninth threshold. The first traffic feature condition means that a similarity between a reference traffic feature and a traffic feature of the apparatus using the sub-resource corresponding to the first group configuration information is greater than or equal to a tenth threshold.

In another embodiment, a first transmission resource in an M^{th} piece of first configuration information in the one or more pieces of first configuration information includes one or more sub-resources, and Mis an integer greater than or equal to 1. The transceiver module 1401 is further configured to receive one or more pieces of third configuration information from the second apparatus. The one or more pieces of third configuration information correspond to the one or more sub-resources, and each of the one or more pieces of third configuration information includes configuration information of a sub-resource corresponding to the third configuration information.

In another embodiment, each piece of third configuration information includes at least one of the following: second indication information, where the second indication information indicates a time-frequency position of the sub-resource corresponding to the third configuration information; second group configuration information, where the second allocation configuration information includes a condition that is satisfied by an apparatus using the sub-resource corresponding to the third configuration information; or a second duty cycle, where the second duty cycle indicates that an apparatus using the sub-resource corresponding to the third configuration information reports a local parameter of the first model once when the apparatus using the sub-resource corresponding to the third configuration information receives a global parameter of the second model from the second apparatus for P times, where P is an integer greater than or equal to 1.

In another embodiment, the first transmission resource and a second transmission resource that are configured based on the M^{th} piece of first configuration information constitute a transmission resource pair. Each piece of third configuration information further includes an index of the transmission resource pair.

In another embodiment, the transceiver module 1401 is further configured to receive one or more pieces of fourth configuration information from the second apparatus. Each piece of fourth configuration information indicates a compute resource. The one or more pieces of fourth configuration information correspond to the one or more first transmission resources and the one or more second transmission resources that are configured based on the one or more pieces of first configuration information.

In another embodiment, the transceiver module 1401 is further configured to receive a first MAC CE from the second apparatus. The first MAC CE indicates a configuration manner configured based on one of the one or more pieces of second configuration information.

In another embodiment, the first transmission resource and the second transmission resource that are configured based on each piece of first configuration information constitute the transmission resource pair. The first MAC CE further indicates a first transmission resource pair. The first transmission resource pair is a transmission resource pair configured based on one of the one or more pieces of first configuration information.

In another embodiment, the first MAC CE further includes an FL-RNTI used to configure a task corresponding to the first transmission resource pair.

In another embodiment, the transceiver module 1401 is further configured to receive a second MAC CE from the second apparatus. The second MAC CE indicates a first sub-resource, and the first sub-resource is one of the one or more sub-resources.

In another embodiment, the first transmission resource and the second transmission resource that are configured based on the M^{th} piece of first configuration information constitute the transmission resource pair. The second MAC CE further indicates the transmission resource pair.

In another embodiment, the second MAC CE further includes an FL-RNTI of a task corresponding to the transmission resource pair.

In another embodiment, the first transmission resource and the second transmission resource that are configured based on each piece of first configuration information constitute the transmission resource pair. The transceiver module 1401 is further configured to receive first DCI from the second apparatus. The first DCI includes at least one of the following: an index of a first transmission resource pair, an identity of a first configuration manner, an identifier of a first sub-resource, an identifier of a first compute resource, a HARQ indicator, a data transmission format indicator, a quantization indicator, or an uplink transmit power coefficient used on a first transmission resource or the first sub-resource in the first transmission resource pair. The first transmission resource pair is a transmission resource pair configured based on one of the one or more pieces of first configuration information. The first configuration manner is a configuration manner configured based on one of the one or more pieces of second configuration information. The first sub-resource is a sub-resource configured based on one of the one or more pieces of third configuration information. The first compute resource is a compute resource configured based on one of the one or more pieces of fourth configuration information. The HARQ indicator indicates whether a local parameter transmitted on the first transmission resource included in the first transmission resource pair supports the HARQ and whether a global parameter transmitted on a second transmission resource included in the first transmission resource pair supports the HARQ. The quantization indicator indicates quantization precision of the local parameter transmitted on the first transmission resource included in the first transmission resource pair and quantization precision of the global parameter transmitted on the second transmission resource included in the first transmission resource pair.

In another embodiment, the first DCI is generated through scrambling with a common RNTI.

In another embodiment, the first DCI is generated through scrambling with an FL-RNTI. The FN-RNTI identifies a task corresponding to the first transmission resource pair.

In another embodiment, the first transmission resource and the second transmission resource that are configured based on each piece of first configuration information constitute the transmission resource pair. The transceiver module 1401 is further configured to receive a third MAC CE from the second apparatus. The third MAC CE is used to activate or deactivate one or more transmission resource pairs configured based on X of the one or more pieces of first configuration information, and X is an integer greater than or equal to 1.

In another embodiment, the second MAC CE further includes activation time or deactivation time. The activation time is activation time of the one or more transmission resource pairs configured based on the X pieces of first configuration information. The deactivation time is deactivation time of the one or more transmission resource pairs configured based on the X pieces of first configuration information.

In another embodiment, the transceiver module 1401 is further configured to receive second DCI from the second apparatus. The second DCI indicates one of the one or more transmission resource pairs corresponding to the X pieces of first configuration information.

In another embodiment, the first transmission resource and the second transmission resource that are configured based on each piece of first configuration information constitute the transmission resource pair. The transceiver module 1401 is further configured to receive a fourth MAC CE from the second apparatus. The fourth MAC CE includes a first bit sequence. A bit in the first bit sequence corresponds to the one or more transmission resource pairs configured based on the one or more pieces of first configuration information. The bit in the first bit sequence indicates whether to activate the transmission resource pair corresponding to the bit.

In another embodiment, the transceiver module 1401 is further configured to receive third DCI from the second apparatus. The third DCI indicates one of one or more transmission resource pairs activated by the fourth MAC CE.

In another embodiment, the first transmission resource and the second transmission resource that are configured based on each piece of first configuration information constitute the transmission resource pair. The transceiver module 1401 is further configured to receive a fifth MAC CE from the second apparatus. The fifth MAC CE indicates one or more of the one or more transmission resource pairs configured based on the one or more pieces of first configuration information and a transmission cycle corresponding to each of the one or more transmission resource pairs. The transmission cycle corresponding to each of the one or more transmission resource pairs is an updated transmission cycle corresponding to each of the one or more transmission resource pairs indicated by the second apparatus to the first apparatus 1400.

The second apparatus provided in embodiments of this application is described below. FIG. 15 is a diagram of a structure of a second apparatus according to an embodiment of this application. The second apparatus 1500 may be configured to perform operations performed by the second apparatus in any one of the embodiments shown in FIG. 4 and FIG. 9 to FIG. 13. For details, refer to the related descriptions of the foregoing method embodiments. The second apparatus 1500 includes a transceiver module 1501 and a processing module 1502.

The processing module 1502 is configured to determine one or more pieces of first configuration information. Each piece of first configuration information is used to configure a first transmission resource and a second transmission resource. A part or all of the first transmission resource is used by a first apparatus to report a local parameter of a first model to the second apparatus 1500. The second transmission resource is used by the first apparatus to receive a global parameter of a second model from the second apparatus 1500. The first model is a model that is in the first apparatus and that is used to perform a task corresponding to the first configuration information. The second model is a model that is in the second apparatus 1500 and that is used to perform the task corresponding to the first configuration information.

The transceiver module 1501 is configured to send the one or more pieces of first configuration information to the first apparatus.

In an embodiment, each piece of first configuration information includes at least one of the following: a frequency domain position, a time domain position, or a time domain periodicity that is occupied by the second transmission resource; a data transmission format of the global parameter; a switching condition of the data transmission format of the global parameter; whether a HARQ is supported for transmission of the global parameter; a start condition for enabling the HARQ for the transmission of the global parameter; a frequency domain position, a time domain position, or a time domain periodicity that is occupied by the first transmission resource; a data transmission format of the local parameter; a switching condition of the data transmission format of the local parameter; whether the HARQ is supported for transmission of the local parameter; a start condition for enabling the HARQ for the transmission of the local parameter; an offset of the first transmission resource relative to the second transmission resource in time domain and/or frequency domain; or activation duration. The activation duration indicates that the first apparatus completes receiving of the global parameter and reporting of the local parameter within the activation duration.

In another embodiment, the switching condition of the data transmission format of the global parameter includes: a quantity of rounds of training performed by the second apparatus 1500 on the second model is greater than or equal to a first threshold, or inference precision of a second model obtained by the second apparatus 1500 by performing an i^{th} round of training on the second model based on an i^{th} round of local parameter that is of the first model and that is reported by the first apparatus is greater than or equal to a second threshold, where i is an integer greater than or equal to 1.

In another embodiment, the switching condition of the data transmission format of the local parameter includes: a quantity of rounds of training performed by the first apparatus on the first model is greater than or equal to a third threshold, or inference precision of a first model obtained by the first apparatus by performing an i^{th} round of training on the first model based on an i^{th} round of global parameter that is of the second model and that is sent by the second apparatus 1500 to the first apparatus is greater than or equal to a fourth threshold, where i is an integer greater than or equal to 1.

In another embodiment, the start condition for enabling the HARQ for the transmission of the global parameter includes: the quantity of rounds of training performed by the second apparatus 1500 on the second model is greater than or equal to the first threshold; or the inference precision of the second model obtained by the second apparatus 1500 by performing the i^{th} round of training on the second model based on the i^{th} round of local parameter that is of the first model and that is reported by the first apparatus is greater than or equal to the second threshold, where i is an integer greater than or equal to 1; or a correlation coefficient between an i^{th} round of global parameter and an (i+1)^{th} round of global parameter is greater than or equal to a fifth threshold, the i^{th} round of global parameter is a global parameter obtained by the second apparatus 1500 by performing the i^{th} round of training on the second model, and the (i+1)^{th} round of global parameter is a global parameter obtained by the second apparatus 1500 by performing an (i+1)^{th} round of training on the second model.

In another embodiment, the start condition for enabling the HARQ for the transmission of the local parameter includes: the quantity of rounds of training performed by the first apparatus on the first model is greater than or equal to the third threshold; or the inference precision of the first model obtained by the first apparatus by performing the i^{th} round of training on the first model based on the i^{th} round of global parameter that is of the second model and that is reported by the second apparatus 1500 is greater than or equal to the third threshold, where i is an integer greater than or equal to 1; or a correlation coefficient between the i^{th} round of local parameter and an (i+1)^{th} round of local parameter is greater than or equal to a sixth threshold, the i^{th} round of local parameter is a local parameter obtained by the first apparatus by performing the i^{th} round of training on the first model, and the (i+1)^{th} round of local parameter is a local parameter obtained by the first apparatus by performing an (i+1)^{th} round of training on the first model.

In another embodiment, the first transmission resource includes one or more sub-resources. The transceiver module 1501 is configured to send one or more pieces of second configuration information to the first apparatus. Each piece of second configuration information is used to configure a configuration manner in which the first transmission resource is configured as the one or more sub-resources.

In another embodiment, each piece of second configuration information includes at least one of the following: an identity of the configuration manner; first indication information, where the first indication information indicates a time-frequency position of each of the one or more sub-resources; one or more pieces of first group configuration information, where the one or more pieces of first group configuration information correspond to the one or more sub-resources, and each piece of first group configuration information includes a condition that is satisfied by an apparatus using a sub-resource corresponding to the first group configuration information; or one or more first duty cycles, where the one or more first duty cycles correspond to the one or more sub-resources, and each first duty cycle indicates that an apparatus using a sub-resource corresponding to the first duty cycle reports a local parameter of the first model once when the apparatus using the sub-resource corresponding to the first duty cycle receives a global parameter of the second model from the second apparatus 1500 for N times, where N is an integer greater than or equal to 1.

In another embodiment, the first transmission resource and the second transmission resource that are configured based on each piece of first configuration information constitute a transmission resource pair. Each piece of second configuration information further includes an index of a transmission resource pair associated with the second configuration information.

In another embodiment, a condition that is satisfied by the apparatus of the sub-resource corresponding to each piece of first group configuration information includes at least one of the following: a first environment parameter condition, a first dataset parameter condition, a first service parameter condition, or a first traffic feature condition. The first environment parameter condition means that a similarity between a reference environment parameter and an environment parameter of the apparatus using the sub-resource corresponding to the first group configuration information is greater than or equal to a seventh threshold. The first dataset parameter condition means that a similarity between a reference dataset parameter and a dataset parameter of the apparatus using the sub-resource corresponding to the first group configuration information is greater than or equal to an eighth threshold. The first service parameter condition means that a similarity between a reference service parameter and a service parameter of the apparatus using the sub-resource corresponding to the first group configuration information is greater than or equal to a ninth threshold. The first traffic feature condition means that a similarity between a reference traffic feature and a traffic feature of the apparatus using the sub-resource corresponding to the first group configuration information is greater than or equal to a tenth threshold.

In another embodiment, a first transmission resource in an M^{th} piece of first configuration information in the one or more pieces of first configuration information includes one or more sub-resources, and M is an integer greater than or equal to 1. The transceiver module 1501 is further configured to send one or more pieces of third configuration information to the first apparatus. The one or more pieces of third configuration information correspond to the one or more sub-resources, and each of the one or more pieces of third configuration information includes configuration information of a sub-resource corresponding to the third configuration information.

In another embodiment, each piece of third configuration information includes at least one of the following: second indication information, where the second indication information indicates a time-frequency position of the sub-resource corresponding to the third configuration information; second group configuration information, where the second allocation configuration information includes a condition that is satisfied by an apparatus using the sub-resource corresponding to the third configuration information; or a second duty cycle, where the second duty cycle indicates that an apparatus using the sub-resource corresponding to the third configuration information reports a local parameter of the first model once when the apparatus using the sub-resource corresponding to the third configuration information receives a global parameter of the second model from the second apparatus 1500 for P times, where P is an integer greater than or equal to 1.

In another embodiment, the first transmission resource and a second transmission resource that are configured based on the M^{th} piece of first configuration information constitute a transmission resource pair. Each piece of third configuration information further includes an index of the transmission resource pair.

In another embodiment, the transceiver module 1501 is further configured to send one or more pieces of fourth configuration information to the first apparatus. Each of the one or more pieces of fourth configuration information indicates a compute resource. The one or more pieces of fourth configuration information correspond to the one or more first transmission resources and the one or more second transmission resources that are configured based on the one or more pieces of first configuration information.

In another embodiment, the transceiver module 1501 is further configured to send a first MAC CE to the first apparatus. The one or more pieces of fourth configuration information correspond to the one or more first transmission resources and the one or more second transmission resources that are configured based on the one or more pieces of first configuration information.

In another embodiment, the first transmission resource and the second transmission resource that are configured based on each piece of first configuration information constitute the transmission resource pair. The first MAC CE further indicates a first transmission resource pair. The first transmission resource pair is a transmission resource pair configured based on one of the one or more pieces of first configuration information.

In another embodiment, the first MAC CE further includes an FL-RNTI used to configure a task corresponding to the first transmission resource pair.

In another embodiment, the transceiver module 1501 is further configured to send a second MAC CE to the first apparatus. The second MAC CE indicates a first sub-resource, and the first sub-resource is one of the one or more sub-resources.

In another embodiment, the first transmission resource and the second transmission resource that are configured based on the M^{th} piece of first configuration information constitute the transmission resource pair. The second MAC CE further indicates the transmission resource pair.

In another embodiment, the second MAC CE further includes an FL-RNTI of a task corresponding to the transmission resource pair.

In another embodiment, the first transmission resource and the second transmission resource that are configured based on each piece of first configuration information constitute the transmission resource pair. The transceiver module 1501 is further configured to send first DCI to the first apparatus. The first DCI includes at least one of the following: an index of a first transmission resource pair, an identity of a first configuration manner, an identifier of a first sub-resource, an identifier of a first compute resource, a HARQ indicator, a data transmission format indicator, a quantization indicator, or an uplink transmit power coefficient used on a first transmission resource or the first sub-resource in the first transmission resource pair. The first transmission resource pair is a transmission resource pair configured based on one of the one or more pieces of first configuration information. The first configuration manner is a configuration manner configured based on one of the one or more pieces of second configuration information. The first sub-resource is a sub-resource configured based on one of the one or more pieces of third configuration information. The first compute resource is a compute resource configured based on one of the one or more pieces of fourth configuration information. The HARQ indicator indicates whether a local parameter transmitted on the first transmission resource included in the first transmission resource pair supports the HARQ and whether a global parameter transmitted on a second transmission resource included in the first transmission resource pair supports the HARQ. The quantization indicator indicates quantization precision of the local parameter transmitted on the first transmission resource included in the first transmission resource pair and quantization precision of the global parameter transmitted on the second transmission resource included in the first transmission resource pair.

In another embodiment, the first DCI is generated through scrambling with a common RNTI.

In another embodiment, the first DCI is generated through scrambling with an FL-RNTI. The FN-RNTI identifies a task corresponding to the first transmission resource pair.

In another embodiment, the first transmission resource and the second transmission resource that are configured based on each piece of first configuration information constitute the transmission resource pair. The transceiver module 1501 is further configured to send a third MAC CE to the first apparatus. The third MAC CE is used to activate or deactivate one or more transmission resource pairs configured based on X of the one or more pieces of first configuration information, and X is an integer greater than or equal to 1.

In another embodiment, the second MAC CE further includes activation time or deactivation time. The activation time is activation time of the one or more transmission resource pairs configured based on the X pieces of first configuration information. The deactivation time is deactivation time of the one or more transmission resource pairs configured based on the X pieces of first configuration information.

In another embodiment, the transceiver module 1501 is further configured to send second DCI to the first apparatus. The second DCI indicates one of the one or more transmission resource pairs corresponding to the X pieces of first configuration information.

In another embodiment, the first transmission resource and the second transmission resource that are configured based on each piece of first configuration information constitute the transmission resource pair. The transceiver module 1501 is further configured to send a fourth MAC CE to the first apparatus. The fourth MAC CE includes a first bit sequence. A bit in the first bit sequence corresponds to the one or more transmission resource pairs configured based on the one or more pieces of first configuration information. The bit in the first bit sequence indicates whether to activate the transmission resource pair corresponding to the bit.

In another embodiment, the transceiver module 1501 is further configured to send third DCI to the first apparatus. The third DCI indicates one of one or more transmission resource pairs activated by the fourth MAC CE.

In another embodiment, the first transmission resource and the second transmission resource that are configured based on each piece of first configuration information constitute the transmission resource pair. The transceiver module 1501 is further configured to send a fifth MAC CE from the first apparatus. The fifth MAC CE indicates one or more of the one or more transmission resource pairs configured based on the one or more pieces of first configuration information and a transmission cycle corresponding to each of the one or more transmission resource pairs. The transmission cycle corresponding to each of the one or more transmission resource pairs is an updated transmission cycle corresponding to each of the one or more transmission resource pairs indicated by the second apparatus 1500 to the first apparatus.

FIG. 16 is a diagram of a structure of another apparatus according to an embodiment of this application. The apparatus 1600 includes at least an input/output interface 1602. The apparatus 1600 may be a chip or an integrated circuit. In an embodiment, the apparatus 1600 further includes a logic circuit 1601.

In an embodiment, the transceiver module 1401 shown in FIG. 14 may be a communication interface. The communication interface may be the input/output interface 1602 shown in FIG. 16. The input/output interface 1602 may include an input interface and an output interface. Alternatively, the communication interface may be a transceiver circuit, and the transceiver circuit may include an input interface and an output interface. In an embodiment, the processing module 1402 shown in FIG. 14 may be the logic circuit 1601 shown in FIG. 16.

The logic circuit 1601 and the input/output interface 1602 may perform other operations performed by a first apparatus in any embodiment, and implement corresponding beneficial effects. Details are not described herein again.

In another embodiment, the transceiver module 1501 shown in FIG. 15 may be a communication interface. The communication interface may be the input/output interface 1602 shown in FIG. 16. The input/output interface 1602 may include an input interface and an output interface. Alternatively, the communication interface may be a transceiver circuit, and the transceiver circuit may include an input interface and an output interface. In an embodiment, the processing module 1502 shown in FIG. 15 may be the logic circuit 1601 shown in FIG. 16.

The logic circuit 1601 and the input/output interface 1602 may perform other operations performed by a second apparatus in any embodiment, and implement corresponding beneficial effects. Details are not described herein again.

In an embodiment, the logic circuit 1601 may be a processing apparatus, and a part or all of functions of the processing apparatus may be implemented by software.

In an embodiment, the processing apparatus may include a memory and a processor. The memory is configured to store a computer program, and the processor reads and executes the computer program stored in the memory, to perform corresponding processing and/or operations in the foregoing method embodiments.

In an embodiment, the processing apparatus may include only a processor. A memory configured to store a computer program is located outside the processing apparatus. The processor is connected to the memory through a circuit or a wire, to read and execute the computer program stored in the memory. The memory and the processor may be integrated together, or may be physically independent of each other.

In an embodiment, the processing apparatus may be one or more chips or one or more integrated circuits. For example, the processing apparatus may be one or more field-programmable gate arrays (FPGAs), application-specific integrated circuits (ASICs), systems on chips (SoCs), central processing units (CPUs), network processors (NPs), digital signal processors (DSPs), microcontroller units (MCUs), programmable logic devices (PLDs), or other integrated chips, or any combination of the foregoing chips or processors.

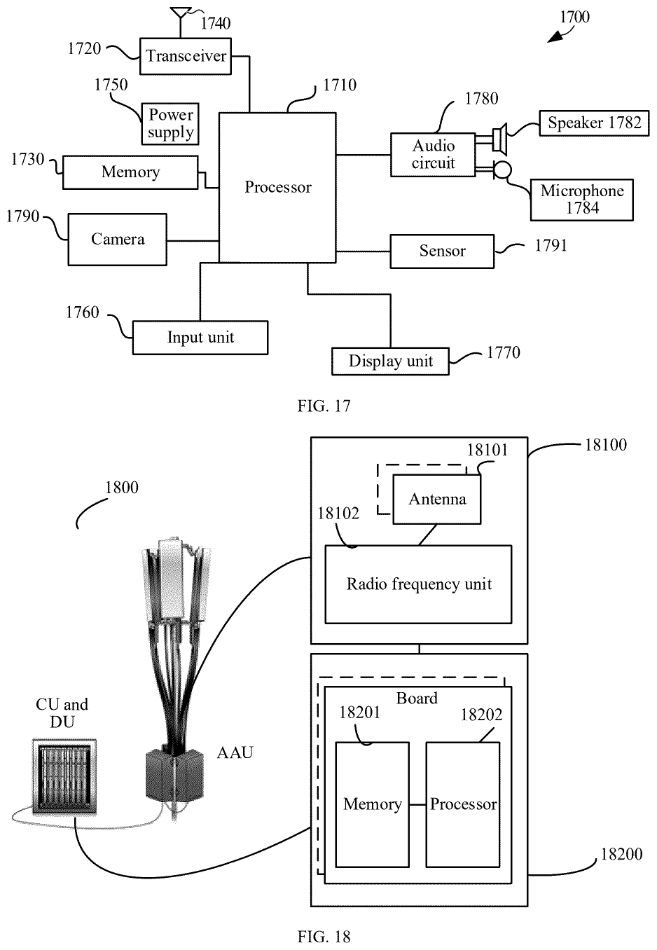

An embodiment of this application further provides a terminal device. FIG. 17 is a diagram of a structure of a terminal device according to an embodiment of this application. The terminal device 1700 may be used in the system shown in FIG. 1 or FIG. 2. For example, the terminal device 1700 may be the terminal device in the system shown in FIG. 1 or FIG. 2, and is configured to perform a function of the first apparatus or the second apparatus in the foregoing method embodiment.

As shown in FIG. 17, the terminal device 1700 includes a processor 1710 and a transceiver 1720.

In an embodiment, the terminal device 1700 further includes a memory 1730. The processor 1710, the transceiver 1720, and the memory 1730 may communicate with each other through an internal connection path, to transfer a control signal and/or a data signal. The memory 1730 is configured to store a computer program. The processor 1710 is configured to invoke the computer program from the memory 1730 and run the computer program, to control the transceiver 1720 to receive and send a signal. In an embodiment, the terminal device 1700 may further include an antenna 1740, configured to send, over a radio signal, uplink data or uplink control signaling output by the transceiver 1720.

The processor 1710 and the memory 1730 may be integrated into a processing apparatus. The processor 1710 is configured to execute program code stored in the memory 1730, to implement the foregoing function. In an embodiment, the memory 1730 may alternatively be integrated into the processor 1710, or may be independent of the processor 1710.

In an embodiment, the processor 1710 may correspond to the processing module 1402 shown in FIG. 14. The transceiver 1720 may correspond to the transceiver module 1401 shown in FIG. 14.

In another embodiment, the processor 1710 may correspond to the processing module 1502 shown in FIG. 15. The transceiver 1720 may correspond to the transceiver module 1501 shown in FIG. 15.

The transceiver 1720 may also be referred to as a transceiver unit. The transceiver 1720 may include a receiver (or referred to as a receiver machine or a receiver circuit) and a transmitter (or referred to as a transmitter machine or a transmitter circuit). The receiver is configured to receive a signal, and the transmitter is configured to transmit a signal.

It should be understood that the terminal device 1700 shown in FIG. 17 can implement processes related to the first apparatus or the second apparatus in any one of the embodiments shown in FIG. 4 and FIG. 9 to FIG. 13. Operations and/or functions of modules in the terminal device 1700 are separately intended to implement corresponding procedures in the foregoing apparatus embodiment. For details, refer to the descriptions in the foregoing apparatus embodiments. To avoid repetition, detailed descriptions are appropriately omitted herein.

The processor 1710 may be configured to perform an action implemented inside the first apparatus or the second apparatus described in the foregoing apparatus embodiment, and the transceiver 1720 may be configured to perform a receiving or sending action of the first apparatus or the second apparatus described in the foregoing apparatus embodiment. For details, refer to the descriptions in the foregoing apparatus embodiments. Details are not described herein again.

In an embodiment, the terminal device 1700 may further include a power supply 1750, configured to supply power to parts or circuits in the terminal device.

In addition, to improve functions of the terminal device, the terminal device 1700 may further include one or more of an input unit 1760, a display unit 1770, an audio circuit 1780, a camera 1790, a sensor 1791, and the like. The audio circuit 1780 may further include a speaker 1782, a microphone 1784, and the like.

This application further provides a network device. FIG. 18 is a diagram of a structure of a network device according to an embodiment of this application. The network device 1800 may be used in the system shown in FIG. 1 or FIG. 2. For example, the network device 1800 may be the access network device in the system shown in FIG. 1 or FIG. 2, and is configured to perform a function of the first apparatus or the second apparatus in the foregoing method embodiment. It should be understood that the following is merely an example. In a future communication system, the network device may have another form and composition.

For example, in a 5G communication system, the network device 1800 may include a CU, a DU, and an AAU. In comparison with a network device that is in an LTE communication system and that includes one or more radio frequency units such as remote radio units (RRUs) and one or more baseband units (BBUs):

A non-real-time part of an original BBU is obtained through division, and redefined as the CU, which is responsible for processing a non-real-time protocol and service. A part of physical layer processing functions of the BBU are combined with an original RRU and a passive antenna into the AAU. Remaining functions of the BBU are redefined as the DU, which is responsible for processing a physical layer protocol and a real-time service. In short, the CU and the DU are distinguished based on real-time performance of processed content, and the AAU is a combination of the RRU and the antenna.

The CU, the DU, and the AAU may be deployed separately or together. Therefore, there are a plurality of network deployment forms. A deployment form, as shown in FIG. 18, is consistent with that of a conventional 4G network device. The CU and the DU are deployed on same hardware. It should be understood that FIG. 18 is merely an example, and does not limit the protection scope of this application. For example, the deployment form may alternatively be that the DU is deployed in a BBU equipment room, the CU is deployed in a centralized manner or the DU is deployed in a centralized manner, the CU is centralized at a higher level, or the like.

The AAU 18100 may implement a transceiver function, which is referred to as a transceiver unit 18100, and corresponds to the transceiver module 1401 shown in FIG. 14. Alternatively, the AAU 18100 may implement a transceiver function, which is referred to as a transceiver unit 18100, and corresponds to the transceiver module 1501 shown in FIG. 15.

In an embodiment, the transceiver unit 18100 may also be referred to as a transceiver machine, a transceiver circuit, a transceiver, or the like, and may include at least one antenna 18101 and a radio frequency unit 18102. In an embodiment, the transceiver unit 18100 may include a receiving unit and a sending unit. The receiving unit may correspond to a receiver (or referred to as a receiver machine or a receiver circuit), and the sending unit may correspond to a transmitter (or referred to as a transmitter machine or a transmitter circuit).

The CU and the DU 18200 may implement an internal processing function, which is referred to as a processing unit 18200, and corresponds to the processing module 1402 shown in FIG. 14. Alternatively, the CU and the DU 18200 may implement an internal processing function, which is referred to as a processing unit 18200, and corresponds to the processing module 1502 shown in FIG. 15.

In an embodiment, the processing unit 18200 may control the network device or the like, and may be referred to as a controller. The AAU, the CU, and the DU may be physically disposed together, or may be physically disposed separately.

In addition, the network device is not limited to the form shown in FIG. 18, and may alternatively be in another form. For example, the network device includes a BBU and an adaptive radio unit (ARU), or includes a BBU and an AAU; or may be customer premises equipment (CPE), or may be in another form. This is not limited in this application.

In an example, the processing unit 18200 may include one or more boards. A plurality of boards may jointly support a radio access network (for example, an LTE network) of a single access standard, or may separately support radio access networks (such as an LTE network, a 5G network, a future network, or another network) of different access standards. The CU and the DU 18200 further include a memory 18201 and a processor 18202. The memory 18201 is configured to store instructions and data. The processor 18202 is configured to control the network device to perform an action, for example, configured to control the network device to perform an operation procedure related to the first apparatus or the second apparatus in the foregoing method embodiment. The memory 18201 and the processor 18202 may serve the one or more boards. In other words, a memory and a processor may be disposed on each board. Alternatively, a plurality of boards may share a same memory and a same processor. In addition, a circuit may be further disposed on each board.

It should be understood that the network device 1800 shown in FIG. 18 can implement functions of the first apparatus or the second apparatus in any one of the method embodiments shown in FIG. 4 and FIG. 9 to FIG. 13. Operations and/or functions of the units in the network device 1800 are used to implement corresponding procedures performed by the network device in the foregoing method embodiment of this application. To avoid repetition, detailed descriptions are appropriately omitted herein. The structure of the network device shown in FIG. 18 is an embodiment, but should not constitute any limitation on embodiments of this application. In this application, a possibility that there may be a network device structure in another form in the future is not excluded.

The CU and DU 18200 may be configured to perform an action implemented inside the first apparatus or the second apparatus described in the foregoing method embodiment, and the AAU 18100 may be configured to perform a receiving or sending action of the first apparatus or the second apparatus described in the foregoing method embodiment. For details, refer to the descriptions in the foregoing method embodiments. Details are not described herein again.

This application further provides a computer program product. The computer program product includes computer program code. When the computer program code is run on a computer, the computer is caused to perform the methods in the embodiments shown in FIG. 4 and FIG. 9 to FIG. 13.

This application further provides a computer-readable medium. The computer-readable medium stores program code. When the program code is run on a computer, the computer is caused to perform the methods in the embodiments shown in FIG. 4 and FIG. 9 to FIG. 13.

This application further provides a communication system. The communication system includes a first apparatus and a second apparatus. The first apparatus is configured to perform a part or all of the operations performed by the first apparatus in the embodiments shown in FIG. 4 and FIG. 9 to FIG. 13, and the second apparatus is configured to perform a part or all of the operations performed by the second apparatus in the embodiments shown in FIG. 4 and FIG. 9 to FIG. 13.

An embodiment of this application further provides a chip apparatus, including a processor, configured to invoke a computer program or computer instructions stored in a memory, so that the processor performs the methods in the embodiments shown in FIG. 4 and FIG. 9 to FIG. 13.

In an embodiment, an input of the chip apparatus corresponds to the receiving operation in the embodiments shown in FIG. 4 and FIG. 9 to FIG. 13, and an output of the chip apparatus corresponds to the sending operation in the embodiments shown in FIG. 4 and FIG. 9 to FIG. 13.

In an embodiment, the processor is coupled to the memory through an interface.

In an embodiment, the chip apparatus further includes the memory, and the memory stores the computer program or the computer instructions.

The processor mentioned anywhere above may be a general-purpose central processing unit, a microprocessor, an ASIC, or one or more integrated circuits configured to control program execution of the methods in the embodiments shown in FIG. 4 and FIG. 9 to FIG. 13. The memory mentioned anywhere above may be a read-only memory (ROM), another type of static storage device that can store static information and instructions, a random access memory (RAM), or the like.

It may be clearly understood by persons skilled in the art that, for convenient and brief description, for explanations and beneficial effects of related content in any one of the communication apparatuses provided above, refer to the corresponding method embodiment provided above. Details are not described herein again.

In the several embodiments provided in this application, it should be understood that the disclosed system, apparatus, and method may be implemented in other manners. For example, the described apparatus embodiments are merely examples. For example, the unit division is merely logical function division and may be other division during actual embodiment. For example, a plurality of units or parts may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected based on actual requirements to achieve the objectives of the solutions of embodiments.

In addition, the functional units in embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to the current technology, or all or a part of the technical solutions may be implemented in the form of a software product. The computer software product is stored in a storage medium and includes several instructions for instructing a computer device (which may be a personal computer, a server, or a network device) to perform all or a part of the operations of the methods described in embodiments of this application. The foregoing storage medium includes any medium that can store program code, for example, a USB flash drive, a removable hard disk, a ROM, a RAM, a magnetic disk, or an optical disc.

In conclusion, the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application.

1. A resource configuration method, wherein the method comprises:
receiving, by a first apparatus, one or more pieces of first configuration information from a second apparatus, wherein
each piece of the one or more pieces of first configuration information is used to configure a first transmission resource and a second transmission resource,
at least a part of the first transmission resource is used by the first apparatus to report a local parameter of a first model to the second apparatus,
the second transmission resource is used by the first apparatus to receive a global parameter of a second model from the second apparatus,
the first model is in the first apparatus and is used to perform a task corresponding to the first configuration information, and
the second model is in the second apparatus and is used to perform the task corresponding to the first configuration information; and
determining, by the first apparatus, transmission resources configured based on the one or more pieces of first configuration information.

2. The method according to claim 1, wherein each piece of the one or more pieces of first configuration information comprises at least one of the following:
a frequency domain position, a time domain position, or a time domain periodicity that is occupied by the first transmission resource;
a data transmission format of the local parameter;
a switching condition of the data transmission format of the local parameter;
whether a hybrid automatic repeat request (HARQ) is supported for transmission of the local parameter;
a start condition for enabling the HARQ for the transmission of the local parameter;
a frequency domain position, a time domain position, or a time domain periodicity that is occupied by the second transmission resource;
a data transmission format of the global parameter;
a switching condition of the data transmission format of the global parameter;
whether the hybrid automatic repeat request HARQ is supported for transmission of the global parameter;
a start condition for enabling the HARQ for the transmission of the global parameter;
an offset of the first transmission resource relative to the second transmission resource in at least one of a time domain or a frequency domain; or
activation duration that indicates that the first apparatus completes receiving of the global parameter and reporting of the local parameter within the activation duration.

3. The method according to claim 2, wherein the switching condition of the data transmission format of the global parameter comprises at least one of:
a quantity of rounds of training performed by the second apparatus on the second model is greater than or equal to a first threshold; or
inference precision of a second model obtained by the second apparatus by performing an i^{th} round of training on the second model based on an i^{th} round of a local parameter that is of the first model, is reported by the first apparatus, and is greater than or equal to a second threshold, wherein i is an integer greater than or equal to 1.

4. The method according to claim 2, wherein the switching condition of the data transmission format of the local parameter comprises at least one of:
a quantity of rounds of training performed by the first apparatus on the first model is greater than or equal to a third threshold; or
inference precision of a first model obtained by the first apparatus by performing an i^{th} round of training on the first model based on an i^{th} round of a global parameter that is of the second model, is sent by the second apparatus to the first apparatus, and is greater than or equal to a fourth threshold, wherein i is an integer greater than or equal to 1.

5. The method according to claim 2, wherein the start condition for enabling the HARQ for the transmission of the global parameter comprises at least one of:
the quantity of rounds of training performed by the second apparatus on the second model is greater than or equal to the first threshold;
the inference precision of the second model obtained by the second apparatus by performing the i^{th} round of training on the second model based on the i^{th} round of local parameter that is of the first model and that is reported by the first apparatus is greater than or equal to the second threshold, wherein i is an integer greater than or equal to 1; or
a correlation coefficient between the i^{th} round of global parameter and an (i+1)^{th} round of global parameter is greater than or equal to a fifth threshold, the i^{th} round of global parameter is a global parameter obtained by the second apparatus by performing the i^{th} round of training on the second model, and the (i+1)^{th} round of global parameter is a global parameter obtained by the second apparatus by performing an (i+1)^{th} round of training on the second model.

6. The method according to claim 2, wherein the start condition for enabling the HARQ for the transmission of the local parameter comprises at least one of:
the quantity of rounds of training performed by the first apparatus on the first model is greater than or equal to the third threshold;
the inference precision of the first model obtained by the first apparatus by performing the i^{th} round of training on the first model based on the i^{th} round of global parameter that is of the second model and that is reported by the second apparatus is greater than or equal to the fourth threshold, wherein i is an integer greater than or equal to 1; or
a correlation coefficient between the i^{th} round of local parameter and an (i+1)^{th} round of local parameter is greater than or equal to a sixth threshold, the i^{th} round of local parameter is a local parameter obtained by the first apparatus by performing the i^{th} round of training on the first model, and the (i+1)^{th} round of local parameter is a local parameter obtained by the first apparatus by performing an (i+1)^{th} round of training on the first model.

7. The method according to claim 1, wherein the first transmission resource comprises one or more sub-resources, and the method further comprises:
receiving, by the first apparatus, one or more pieces of second configuration information from the second apparatus, wherein each piece of second configuration information is used to configure a configuration manner in which the first transmission resource is configured as the one or more sub-resources.

8. A resource configuration method, wherein the method comprises:
determining, by a second apparatus, one or more pieces of first configuration information, wherein
each piece of the one or more pieces of first configuration information is used to configure a first transmission resource and a second transmission resource,
at least part of the first transmission resource is used by a first apparatus to report a local parameter of a first model to the second apparatus,
the second transmission resource is used by the first apparatus to receive a global parameter of a second model from the second apparatus,
the first model is in the first apparatus and is used to perform a task corresponding to the first configuration information, and
the second model is in the second apparatus and is used to perform the task corresponding to the first configuration information; and
sending, by the second apparatus, the one or more pieces of first configuration information to the first apparatus.

9. The method according to claim 8, wherein each piece of the one or more pieces of first configuration information comprises at least one of the following:
a frequency domain position, a time domain position, or a time domain periodicity that is occupied by the first transmission resource;
a data transmission format of the local parameter;
a switching condition of the data transmission format of the local parameter;
whether a hybrid automatic repeat request (HARQ) is supported for transmission of the local parameter;
a start condition for enabling the HARQ for the transmission of the local parameter;
a frequency domain position, a time domain position, or a time domain periodicity that is occupied by the second transmission resource;
a data transmission format of the global parameter;
a switching condition of the data transmission format of the global parameter;
whether the hybrid automatic repeat request HARQ is supported for transmission of the global parameter;
a start condition for enabling the HARQ for the transmission of the global parameter;
an offset of the first transmission resource relative to the second transmission resource in at least one of a time domain or a frequency domain; or
activation duration that indicates that the first apparatus completes receiving of the global parameter and reporting of the local parameter within the activation duration.

10. The method according to claim 9, wherein the switching condition of the data transmission format of the global parameter comprises at least one of:
a quantity of rounds of training performed by the second apparatus on the second model is greater than or equal to a first threshold; or
inference precision of a second model obtained by the second apparatus by performing an i^{th} round of training on the second model based on an i^{th} round of a local parameter that is of the first model, is reported by the first apparatus, and is greater than or equal to a second threshold, wherein i is an integer greater than or equal to 1.

11. The method according to claim 9, wherein the switching condition of the data transmission format of the local parameter comprises at least one of:
a quantity of rounds of training performed by the first apparatus on the first model is greater than or equal to a third threshold; or
inference precision of a first model obtained by the first apparatus by performing an i^{th} round of training on the first model based on an i^{th} round of a global parameter that is of the second model, is sent by the second apparatus to the first apparatus, and is greater than or equal to a fourth threshold, wherein i is an integer greater than or equal to 1.

12. The method according to claim 9, wherein the start condition for enabling the HARQ for the transmission of the global parameter comprises at least one of:
the quantity of rounds of training performed by the second apparatus on the second model is greater than or equal to the first threshold;
the inference precision of the second model obtained by the second apparatus by performing the i^{th} round of training on the second model based on the i^{th} round of local parameter that is of the first model and that is reported by the first apparatus is greater than or equal to the second threshold, wherein i is an integer greater than or equal to 1; or
a correlation coefficient between the i^{th} round of global parameter and an (i+1)^{th} round of global parameter is greater than or equal to a fifth threshold, the i^{th} round of global parameter is a global parameter obtained by the second apparatus by performing the i^{th} round of training on the second model, and the (i+1)^{th} round of global parameter is a global parameter obtained by the second apparatus by performing an (i+1)^{th} round of training on the second model.

13. The method according to claim 9, wherein the start condition for enabling the HARQ for the transmission of the local parameter comprises at least one of:
the quantity of rounds of training performed by the first apparatus on the first model is greater than or equal to the third threshold;
the inference precision of the first model obtained by the first apparatus by performing the i^{th} round of training on the first model based on the i^{th} round of global parameter that is of the second model and that is reported by the second apparatus is greater than or equal to the fourth threshold, wherein i is an integer greater than or equal to 1; or
a correlation coefficient between the i^{th} round of local parameter and an (i+1)^{th} round of local parameter is greater than or equal to a sixth threshold, the i^{th} round of local parameter is a local parameter obtained by the first apparatus by performing the i^{th} round of training on the first model, and the (i+1)^{th} round of local parameter is a local parameter obtained by the first apparatus by performing an (i+1)^{th} round of training on the first model.

14. The method according to claim 8, wherein the first transmission resource comprises one or more sub-resources, and the method further comprises:
receiving, by the first apparatus, one or more pieces of second configuration information from the second apparatus, wherein each piece of second configuration information is used to configure a configuration manner in which the first transmission resource is configured as the one or more sub-resources.

15. An apparatus, wherein the apparatus comprises:
at least one processor; and
one or more memories coupled to the at least one processor and storing programming instructions for execution by the at least one processor, to enable the communication apparatus to:
receive one or more pieces of first configuration information from a second apparatus, wherein
each piece of the one or more pieces of first configuration information is used to configure a first transmission resource and a second transmission resource,
at least a part of the first transmission resource is used by the first apparatus to report a local parameter of a first model to the second apparatus,
the second transmission resource is used by the first apparatus to receive a global parameter of a second model from the second apparatus,
the first model is in the first apparatus and is used to perform a task corresponding to the first configuration information, and
the second model is in the second apparatus and is used to perform the task corresponding to the first configuration information; and
determine transmission resources configured based on the one or more pieces of first configuration information.

16. The apparatus according to claim 15, wherein each piece of the one or more pieces of first configuration information comprises at least one of the following:
a frequency domain position, a time domain position, or a time domain periodicity that is occupied by the first transmission resource;
a data transmission format of the local parameter; a switching condition of the data transmission format of the local parameter;
whether a hybrid automatic repeat request (HARQ) is supported for transmission of the local parameter;
a start condition for enabling the HARQ for the transmission of the local parameter;
a frequency domain position, a time domain position, or a time domain periodicity that is occupied by the second transmission resource; a data transmission format of the global parameter;
a switching condition of the data transmission format of the global parameter;
whether the hybrid automatic repeat request HARQ is supported for transmission of the global parameter;
a start condition for enabling the HARQ for the transmission of the global parameter;
an offset of the first transmission resource relative to the second transmission resource in at least one of a time domain or a frequency domain;
or activation duration that indicates that the first apparatus completes receiving of the global parameter and reporting of the local parameter within the activation duration.

17. The apparatus according to claim 16, wherein the switching condition of the data transmission format of the global parameter comprises at least one of:
a quantity of rounds of training performed by the second apparatus on the second model is greater than or equal to a first threshold; or
inference precision of a second model obtained by the second apparatus by performing an i^{th} round of training on the second model based on an i^{th} round of a local parameter that is of the first model, is reported by the first apparatus, and is greater than or equal to a second threshold, wherein i is an integer greater than or equal to 1.

18. The apparatus according to claim 16, wherein the switching condition of the data transmission format of the local parameter comprises at least one of:
a quantity of rounds of training performed by the first apparatus on the first model is greater than or equal to a third threshold; or
inference precision of a first model obtained by the first apparatus by performing an i^{th} round of training on the first model based on an i^{th} round of a global parameter that is of the second model, is sent by the second apparatus to the first apparatus, and is greater than or equal to a fourth threshold, wherein i is an integer greater than or equal to 1.

19. The apparatus according to claim 16, wherein the start condition for enabling the HARQ for the transmission of the global parameter comprises at least one of:
the quantity of rounds of training performed by the second apparatus on the second model is greater than or equal to the first threshold;
the inference precision of the second model obtained by the second apparatus by performing the i^{th} round of training on the second model based on the i^{th} round of local parameter that is of the first model and that is reported by the first apparatus is greater than or equal to the second threshold, wherein i is an integer greater than or equal to 1; or
a correlation coefficient between the i^{th} round of global parameter and an (i+1)^{th} round of global parameter is greater than or equal to a fifth threshold, the i^{th} round of global parameter is a global parameter obtained by the second apparatus by performing the i^{th} round of training on the second model, and the (i+1)^{th} round of global parameter is a global parameter obtained by the second apparatus by performing an (i+1)^{th} round of training on the second model.

20. The apparatus according to claim 16, wherein the start condition for enabling the HARQ for the transmission of the local parameter comprises at least one of:
the quantity of rounds of training performed by the first apparatus on the first model is greater than or equal to the third threshold;
the inference precision of the first model obtained by the first apparatus by performing the i^{th} round of training on the first model based on the i^{th} round of global parameter that is of the second model and that is reported by the second apparatus is greater than or equal to the fourth threshold, wherein i is an integer greater than or equal to 1; or
a correlation coefficient between the i^{th} round of local parameter and an (i+1)^{th} round of local parameter is greater than or equal to a sixth threshold, the i^{th} round of local parameter is a local parameter obtained by the first apparatus by performing the i^{th} round of training on the first model, and the (i+1)^{th} round of local parameter is a local parameter obtained by the first apparatus by performing an (i+1)^{th} round of training on the first model.
